(19) United States
(12) Patent Application Publication
(10) Pub. No.: US 2025/0280171 A1
(43) Pub. Date: Sep. 4, 2025

(54) MULTIMEDIA CONTENT MANAGEMENT AND PACKAGING DISTRIBUTED LEDGER SYSTEM AND METHOD OF OPERATION THEREOF

(71) Applicant: EDGE VIDEO B.V., Den Haag (NL)

(72) Inventors: Joseph Ward, San Francisco, CA (US); Charles Myers, Everett, WA (US); Sam Bergstrom, Merritt Island, FL (US)

(73) Assignee: EDGE VIDEO B.V., Den Haag (NL)

(21) Appl. No.: 18/849,257

(22) PCT Filed: Mar. 29, 2023
(86) PCT No.: PCT/US2023/064803

§ 371 Date: Sep. 20, 2024

Related U.S. Application Data
(60) Provisional application No. 63/269,726, filed on Mar. 22, 2022.

(51) Int. Cl. H04N 21/442; H04N 21/431; H04N 21/44; H04N 21/81

(52) U.S. Cl. CPC H04N 21/44204; H04N 21/4316; H04N 21/44008; H04N 21/8146

(57) ABSTRACT

A system and method of operation of a multimedia content management and packaging system includes an ingest unit for receiving a content object; a content data storage unit, coupled to the ingest unit, for storing the content object; a usage unit, coupled to the content data storage unit, for updating the content object based on the detection of a media reference; a scoring and aggregation unit, coupled to the content data storage unit, for updating the usage score of the content object in the content data storage unit; and a display module, coupled to the scoring and aggregation unit, for displaying the content object having the usage score above a usage score threshold.

### RELATED APPLICATIONS

This application is a national phase application of and claims priority under 35 U.S.C. § 371 of PCT Patent Application Serial No. PCT/US23/64803 (Attorney Docket No. 6590.00006) filed on Mar. 29, 2023 and titled Multimedia Content Management and Packaging Distributed Ledger System and Method of Operation Thereof, which in turn claims priority under 35 U.S.C. § 119(e) of U.S. Provisional Patent Application Ser. No. 63/269,726 (Attorney Docket No. 6590.00002) filed on Mar. 22, 2022 and titled MULTIMEDIA CONTENT MANAGEMENT AND PACKAGING DISTRIBUTED LEDGER SYSTEM AND METHOD OF OPERATION THEREOF. The contents of these applications are incorporated herein by reference.

### FIELD OF THE INVENTION

The present invention relates generally to a multimedia content management and packaging system, media guides, and more particularly, among other things, to a multimedia content management and packaging systems and media guides with distributed ledger (e.g., a blockchain system) capability.

### BACKGROUND ART

Modern consumer and industrial electronics, especially devices with an image and video display capability, such as televisions, projectors, smart phones, and combination devices, are providing increasing levels of functionality to support modern life which require the display of managing multimedia information. The expansion of different display types coupled with larger display format sizes and resolutions require ever larger amounts of information to be stored on digital media to capture images and video recordings. Research and development in the existing technologies can take a myriad of different directions.

As users become more empowered with the growth of media and multi-media display options, new and old paradigms begin to take advantage of this new device space. There are many technological solutions to take advantage of this new multimedia content display opportunity. One existing approach is to display multimedia content on consumer, industrial, and mobile electronics, such as digital televisions, smart phones, tablet computers, digital projectors, monitors, gaming systems, or a combination devices, based on fixed schedules or according to manually selected schedules, such as on cable television systems.

Image and video display systems have been incorporated in televisions, smart phones, projectors, notebooks, and other portable products. Today, these systems aid users by providing viewing opportunities for available relevant information, such as images, graphics, text, or videos in a variety of conditions. The display of digital images provides invaluable relevant information for the user.

However, displaying multimedia content has become a paramount concern for the consumer. Mobile display systems, fixed display system, and other modern display systems must access ever increasing amounts of multimedia content with limited physical storage and screen spaces. Larger multimedia content can consume more communication bandwidth during transmission, reducing the utility of remote display systems. The sheer volume of available multimedia content decreases the benefit of using the tools.

Thus, a need still remains for better multimedia content management and packaging systems to capture, package, and manage multimedia content. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

The present invention embodiments provide a method of operation of a multimedia content management and packaging system, including: receiving a content object; detecting a media reference to the content object from an external media feed; calculating a usage score for the content object based on the media reference; and displaying the content object having the usage score greater than a usage score threshold.

The present invention embodiments provide a multimedia content management and packaging system, including: an ingest unit for receiving a content object; a content data storage unit, coupled to the ingest unit, for storing the content object; a usage unit, coupled to the content data storage unit, for updating the content object based on the detection of a media reference; a scoring and aggregation unit, coupled to the content data storage unit, for updating the usage score of the content object in the content data storage unit; and a display module, coupled to the scoring and aggregation unit, for displaying the content object having the usage score above a usage score threshold.

Certain embodiments of the invention have other steps or elements in addition to or in place of those mentioned above or are directed to other concepts such as a media guides for a plurality of programs, and a blockchain-based or other distributed-ledger media player. The steps or element will become apparent to those skilled in the art from a reading of the following appended claims and detailed description when taken with reference to the accompanying drawings.

### BRIEF DESCRIPTION OF THE DRAWINGS

FIG. 1 is a block diagram of a multimedia content management and packaging system in an embodiment of the present invention.

FIG. 2 is an example of a media guide.

FIG. 3 is an example of an ingest unit.

FIG. 4 is an example of a usage unit.

FIG. 5 is an example of a scoring and aggregation unit.

FIG. 6 is an example of a content data storage unit.

FIG. 7 is an example of a process flow for the multimedia content management and packaging system.

FIG. 8 is an example of a functional block diagram of the multimedia content management and packaging system.

FIG. 9 is a flow chart of a method of operation of the multimedia content management and packaging system in a further embodiment of the present invention.

FIG. 10 is a schematic diagram of a conventional multichannel streaming session between a streaming media server and a client media receiver.

FIGS. 11 to 16 are schematic diagrams of multiprogram streaming sessions.

FIGS. 17 to 20 show media guide examples.

FIG. 21 shows a display unit example.

FIGS. 22 to 33 show media guide examples.

FIG. 34 is a schematic diagram of a multiprogram streaming session.

FIGS. 35 and 36 show media guide examples.

FIG. 37 is a flow chart of a method for displaying a plurality of programs.

FIG. 38 is a flow chart of a method for a multimedia blockchain system.

FIG. 39 is a flow chart of a method of operating a media guide system.

FIG. 40 shows a media guide example.

FIG. 41 shows an NFT marketplace presentation.

FIG. 42 shows a multimedia distributed ledger system.

FIG. 43 shows a media guide example.

FIG. 44 shows a multimedia distributed ledger system.

FIG. 45 is a flowchart of a method for determining a relative usage score.

FIG. 46 is a flowchart of a method for determining an occurrence of a pre-identified content object in a digital video.

FIGS. 47, 48, and 49 are flowcharts of methods for generating NFTs.

FIG. 50 is a schematic diagram of a descriptor module.

FIG. 51 is a schematic diagram of an image engine.

FIG. 52 is a flow chart of a method for generating an NFT.

FIGS. 53.1, 53.2, and 53.3 show image examples.

FIGS. 54, 55, 56, and 57 show media guide examples.

FIGS. 58A and 58B are a flowchart of a method for determining facial descriptor cluster values.

FIGS. 59A and 59B are a flowchart of a method for facial recognition.

FIG. 60 is a schematic diagram of a facial descriptor database.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation.

The same numbers are used in all the drawing FIGs. to relate to the same elements. The embodiments have been numbered first embodiment, second embodiment, etc. as a matter of descriptive convenience and are not intended to have any other significance or provide limitations for the present invention.

The term “image” is defined as a pictorial representation of an object. An image can include a two-dimensional image, three-dimensional image, video frame, a calculated file representation, an image from a camera, a video frame, or a combination thereof. For example, the image can be a machine-readable digital file, a physical photograph, a digital photograph, a motion picture frame, a video frame, an x-ray image, a scanned image, or a combination thereof. The image can be formed by pixels arranged in a rectangular array. The image can include an x-axis along the direction of the rows and a y-axis along the direction of the columns.

The term “content” is defined as a media object. Content can include video, images, audio, text, graphics, a social feed, RSS data, news, other digital information, or a combination thereof. The term “multimedia content” is defined as a media object that can include multiple types of media. For example, the multimedia content can include video and audio, video with graphics, graphics with audio, text with audio, a social feed, RSS data, news, other digital information, or a similar combination.

The horizontal direction is the direction parallel to the x-axis of an image. The vertical direction is the direction parallel to the y-axis of an image. The diagonal direction is the direction non-parallel to the x-axis and non-parallel to the y-axis.

The term “module” referred to herein can include software, hardware, or a combination thereof. For example, the software can be machine code, firmware, embedded code, and application software. Also for example, the hardware can be circuitry, processor, a graphical processing unit, digital signal processor, calculator, integrated circuit, integrated circuit cores, or a combination thereof.

The term “digital asset” may refer to a blockchain asset such as a cryptocurrency or other blockchain currency, non-fungible tokens, and other unique or limited-edition digital assets that may be transferred and associated with a wallet. “Wallet” refers to a digital wallet or digital wallet application interface. Wallets may include hardware and software implementations or combinations thereof (e.g., a Metamask web browser plug-in as an interface between a web3 application and a hardware wallet). A unique digital asset may have a unique ID to represent a particular digital asset. In some embodiments, a unique digital asset may also be unique in the sense that a unique ID represents a (unique) class of digital assets (e.g., a particular set of functional NFTs) and may offer semi-fungibility.

“Video content analysis” (VCA) includes the capability of automatically analyzing video to detect and determine temporal and spatial events via one or more algorithms. Example VCA techniques include object detection, face recognition, and alphanumeric recognition of digital images and/or videos. “Object detection” detects, in digital images and/or videos, instances of semantic objects of a certain class (e.g., humans, buildings, or cars).

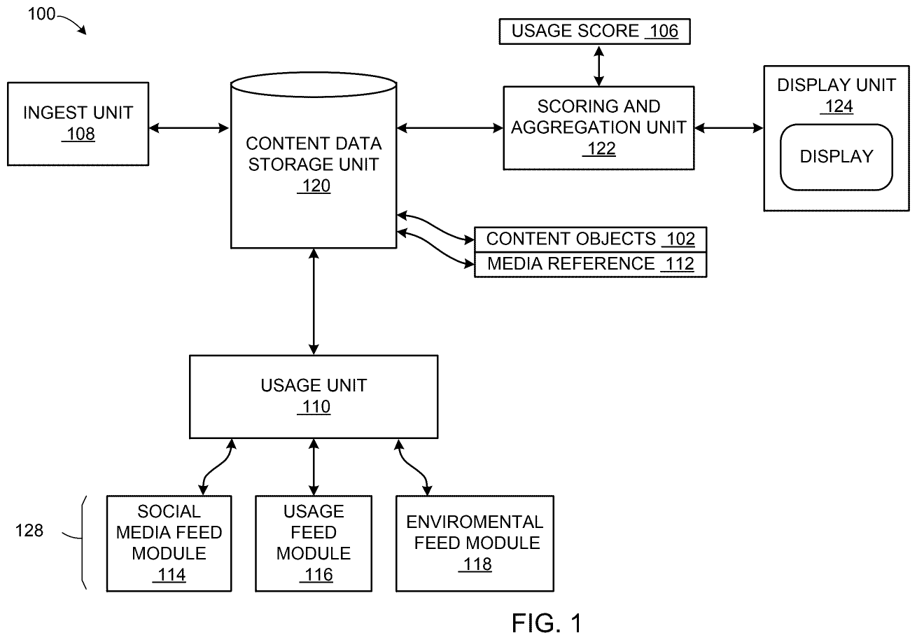

Referring now to FIG. 1, therein is shown a block diagram of a multimedia content management and packaging system 100 in an embodiment of the present invention. The multimedia content management and packaging system 100 can ingest a set of content objects 102, monitor usage and references to content objects 102 in the real world, and dynamically update a usage score 106 for the content objects 102 in real time. Ingesting a set of content objects 102 is receiving and registering the content objects 102 so they can be recognized. Each of the content objects 102 can represent a portion of a multimedia item such as a song, a video, text, a document, a commercial, graphics (e.g., sport scores and time), a three-dimensional video, an audio track, a social feed, Real Simple Syndication (RSS) data, news, other digital information, or a combination thereof.

Alternatively or additionally, content objects 102 can represent a particular phrase (e.g., “My way or the highway.”; “Forget about it!”), particular animal or person (e.g., actor, streamer, journalist, politician, podcaster, reporter, host, and/or other media-exposed individuals), particular place (e.g., Austin, Texas downtown skyline; Zugsptize, the Royal Concertgebouw (e.g., the exterior (or some portion thereof) and/or interior (e.g., individual halls) of the building), or a particular thing.

In some embodiments, a content object 102 comprises or represents facial feature set and/or other data (e.g., audio spectrogram) that is typically unique to an individual and for detection via similar data being generated as a media reference 112 (e.g., facial and/or voice data matching a facial and/or voice data within a set of content objects 102, thus identifying a reference for the usage score 106). In some embodiments, content objects 102 may be hierarchically tagged such that, for example, an entire video program is a content object along with a plurality of identified content objects (e.g., objects identified by VCA) within said video program.

The multimedia content management and packaging system 100 can include an ingest unit 108, a content data storage unit 120, a usage unit 110, a scoring and aggregation unit 122, and a display unit 124. The usage unit 110 can receive a media reference 112 from external media feeds 128, such as a social media feed module 114, a usage feed module 116, and an environmental feed module 118.

The media reference 112 is an indicator that the media item associated with one of the content objects 102 has been used, referred to, played, or cited, either directly or indirectly in an internet web context (e.g., said actions occurring via a browser or other application of a network-connected device). For example, the media reference 112 can indicate that a movie or video associated with one of the content objects 102 has been played on Hulu® or YouTube®. In another example, the media reference 112 can indicate that a review of a television program associated with one of the content objects 102 has been published on Twitter™. In yet another example, the media reference 112 can indicate that a song associated with one of the content objects 102 has been played on the radio in a particular geographical area.

The ingest unit 108 is a module to enter, identify, and register the content objects 102. The ingest unit 108 can receive the content objects 102 and store a reference to each of the content objects 102 in the content data storage unit 120.

The content objects 102 are multimedia content elements. For example, the content objects 102 can be videos, audio recordings, web pages, movies, images, a social feed, RSS data, news, other digital information, electronic data from databases, or a combination thereof. Additionally or alternatively, content objects 102 may comprise or represent (e.g., pointers; hashed parameters) identification information that is sufficiently unique to an individual (e.g., facial and/or facial-feature recognition data; voice identification data). Each of the content objects 102 can have associated information that describes and defines the content.

Each of the content objects 102 can have the usage score 106. The usage score 106 is associated with the degree of usage or external references to the content objects 102. The usage score 106 is described in greater detail below.

The content data storage unit 120 is a module for storing information about the content objects 102. The content data storage unit 120 is described in further detail below. The content data storage unit 120 can include an entry for each of the content objects 102. Information associated with each of the content objects 102 can be stored in the content data storage unit 120.

The content data storage unit 120 can be coupled to the ingest unit 108, the scoring and aggregation unit 122, and the usage unit 110 in a variety of ways. For example, the content data storage unit 120 can be coupled to the ingest unit 108, the scoring and aggregation unit 122, and the usage unit 110 using a web sockets link, networking link, web real time communications, network sockets, or other communication technique.

The usage unit 110 is a module for associating the one of the content objects 102 with information about the external use of one of the content objects 102. The usage unit 110 can determine the usage or reference to one of the content objects 102 and update the information about one of the content objects 102. The usage unit 110 can receive and process information from the external media feeds 128. The external media feeds 128 are sources of media information. The external media feeds 128 can be a variety of sources including social media feeds, usage feeds, and environmental feeds.

The scoring and aggregation unit 122 is a module for updating and maintaining the current status of the usage score 106. The scoring and aggregation unit 122 can create and modify the usage score 106 for one of the content objects 102 using a variety of techniques. For example, the scoring and aggregation unit 122 can update the usage score 106 based on usage, time, duration, quality, location, last use, type of usage, or a combination thereof. The scoring and aggregation unit 122 can update the usage score 106 based on information about an aggregation of the content object 102. The scoring and aggregation unit 122 is described in greater detail below.

It has been discovered that updating the usage score 106 of each of the content objects 102 based on external usage or reference provides an efficient way to identify the content objects 102 that are trending or important. The usage score 106 can be used to rank and rate the content objects 102.

The multimedia content management and packaging system 100 can be implemented using hardware, software, or a combination thereof. For example, the ingest unit 108, the usage unit 110, and the scoring and aggregation unit 122 can be implemented with custom circuitry, a digital signal processor, microprocessor, or a combination thereof. The content data storage unit 120 can be implemented with magnetic media, electronic media, cloud media, optical media, magnetoresistive media, or a combination thereof.

In another example, the ingest unit 108, the content data storage unit 120, the usage unit 110 and the scoring and aggregation unit 122 can be implemented in software, in programmable hardware such as a field programmable gate array, or a combination thereof. The multimedia content management and packaging system 100 is a particular machine having hardware for calculating information regarding media content received from a variety of sources.

It has been discovered that scoring the usage of the content objects 102 improves the technical field of usage monitoring by measuring the real-world usage of the content objects 102 to return actual information on live and/or streaming use. Measuring the actual usage of the content objects 102 that have been registered within the content data storage unit 120 provides a more accurate method of determining the interest in one of the content objects 102 over time.

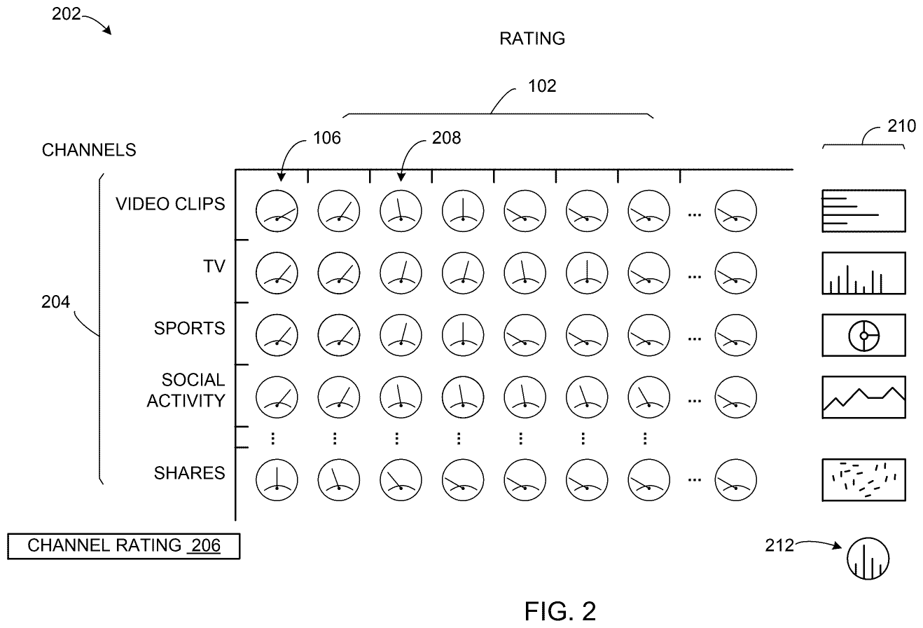

Referring now to FIG. 2, therein is shown an example of a media guide 202. The media guide 202 is a representation of the usage score 106 associated with each of the content objects 102.

The media guide 202 is a dynamic data structure that is updated as the usage score 106 of the content objects 102 is updated by the scoring and aggregation unit 122 of FIG. 1. The media guide 202 can have a variety of configurations. For example, the media guide 202 can be configured with channels 204 along the y-axis and the content objects 102 along the x-axis. The content objects 102 can be arranged from the highest value of the usage score 106 to the lowest.

The channels 204 represent a category of the content objects 102. For example, the channels 204 can represent different categories such as movies, videos, sports, news, financial reports, or a combination thereof. The channels 204 can also represent different media sources such as broadcast television channels, cable television channels, satellite television channels, or a combination thereof. Yet further, the channels 204 can represent different Internet sources of media such as Hulu®, YouTube®, Crackle®, or other internet media sources. The channels 204 can be arranged according to user preference.

In another example, the channels 204 can be assigned a channel rating 206. The media guide 202 can be configured to arrange the highest value for the channel rating 206 to the top of the media guide 202.

Each of the content objects 102 in the media guide 202 can be associated with an activity meter 208 (e.g., a content object graphic) to show the current value of the usage score 106. The activity meter 208 is an abstraction of the level of the usage score 106. One example of the media guide 202 is a rectangular array comprising the activity meter 208 for each of the content objects 102, with the content objects 102 with the highest value of the usage score 106 sorted from left to right. The left most entry in one of one of the channels 204 of the media guide 202 has the highest value of the usage score 106.

The media guide 202 is dynamically updated based on the information from the usage unit 110 of FIG. 1. As the usage score 106 of one of the content objects 102 changes, the activity meter 208 can be updated and the location of the activity meter 208 is updated based on the relative values of the usage score 106 of the other ones of the content objects 102.

In an illustrative example, the media guide 202 is constantly updating based on the incoming information from the usage unit 110 and the scoring and aggregation unit 122. As the usage score 106 of the content objects 102 changes, the configuration of the media guide 202 updates in real-time.

The activity meter 208 can be represented in a variety of ways. For example, the activity meter 208 can be represented as different graph types 210 such as a horizontal bar chart, a vertical bar chart, a pie chart, a line chart, a vector distribution, a grid, or a combination thereof.

The activity meter 208 can also be displayed using badging to form an intelligent graphical element, such as badges 212. The badges 212 can be displayed in conjunction with representations of the channels 204. The badges 212 can be a dynamic measurement of the popularity of each of the channels 204. The badges 212 can vary over time.

The media guide 202 can represent an underlying multi-dimensional array of the usage score 106 for each of the content objects 102. For example, the media guide 202 can be a representation based on big data analysis of the usage score 106 for the content objects 102. In another example, the media guide 202 can include a time-varying representation that can show the change in the usage score 106 for each of the content objects 102 over a period of time or a contextual relevance to each other, such as other dimensions beyond time. The other dimensions can include location, subject matter, media type, source, format, size, quality, preferences, external factors, or a combination thereof. The period of time can be hourly, daily, weekly, monthly, or any useful time period or dimension. In yet another example, the media guide 202 can represent the usage score 106 for each of the content object 102 in the content data storage unit 120 of FIG. 1.

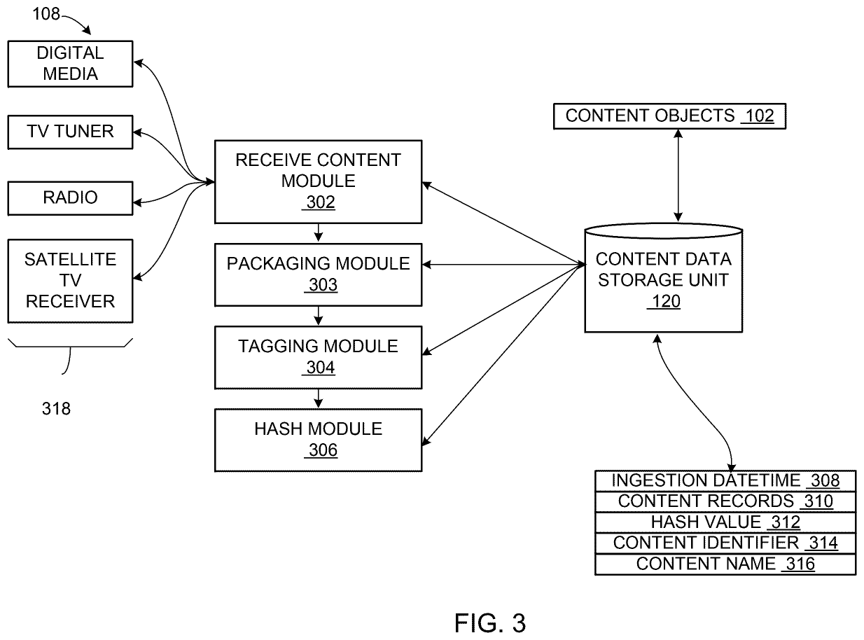

Referring now to FIG. 3, therein is shown an example of an ingest unit, such as the ingest unit 108 of FIG. 1. The ingest unit 108 can receive the content objects 102 and create entries in the content data storage unit 120. The ingest unit 108 can include a receive content module 302, a tagging module 304, a hash module 306, and a packaging module 307. The receive content module 302 is a module to allow the entry of the content objects 102. The receive content module 302 can receive the content objects 102 and allow the entry of additional information associated with each of the content objects 102.

The receive content module 302 can receive one of the content objects 102 as entered by a user or operator or from a scheduling application. For example, the user can provide a set or list of the content objects 102 that can be read by the receive content module 302. In another example, the user can input the set of the content objects 102 individually. The list of the content objects 102 can be metadata describing the content objects 102 or the content objects 102 themselves.

Metadata from the content can be extracted in the packaging module 307 as described below. The packaging module 307 can transcode various versions of the content and then package the content into object with tagging indicating the next processing steps. In a further example, the receive content module 302 can automatically receive the content objects 102 by processing information directly from broadcast, cable, and satellite sources including digital and analog sources. The receive content module 302 can be coupled to a variety of the external media feeds 128 of FIG. 1, such as analog television tuners, digital television tuners, analog radio, digital radio, satellite television, satellite audio, internet television sources, streaming media sources, digital media feed, a social feed, RSS data, news, other digital information, network connected devices, mobile phones, cameras, tablet computers, external feeds, cloud sources, private networks, public networks, or a combination thereof. Each of the external media feeds 128 can be sourced from a media device 318 that can provide a content stream having a combination of the content objects, voice, other audio, graphics, commercials, a social feed, RSS data, news, other digital information, or a combination thereof.

The media device 318 is a device for receiving media broadcasts, digital media streams, external feeds, or a combination thereof. For example, the media device 318 can be a television tuner, a radio receiver, a satellite receiver, a network interface, or a combination thereof. The media device 318 can receive broadcast or internet media and provide the external media feeds 128 to the receive content module 302.

It has been discovered that automatically receiving the content objects 102 from the external media feeds improves the technology (e.g., big data analysis) for identifying said content objects 102. By receiving local and remote media broadcasts and parsing the external media feeds to extract the content objects 102, the receive content module 302 registers the content objects 102 more efficiently.

It has been discovered that automatically receiving the content objects 102 from the network media feeds improves the technology (e.g., big data analysis) for identifying said content objects 102. By receiving local and remote internet media feeds and parsing the feeds to extract the content objects 102, the receive content module 302 registers the content objects 102 to provide a near real-time feedback system.

The receive content module 302 can receive and parse the content objects 102 from the external media feeds 128 in a variety of ways. For example, the receive content module 302 can parse a continuous television stream from one of the external media feeds 128 based on available television schedule information, such as a programming guide. The receive content module 302 can parse one of the external media feeds 128, such as a radio broadcast from a radio receiver, based on the detection of pauses between songs and the volume intensity profile of songs. In another example, the receive content module 302 can parse the content objects 102 from a digital radio broadcast from the internet based on the data in the related packaged content.

In another example, receive content module 302 can detect individuals in a video feed or audio feed. For example, a content object 102 may include or be associated with a non-fungible token (NFT) or other unique digital asset (e.g., an audio NFT; facial-related NFTs) of a digital wallet (e.g., a hardware wallet and/or a Metamask browser extension or plug-in (i.e., a software wallet)).

The receive content module 302 can detect the occurrence of the content objects 102 by matching portions of the incoming content stream to pre-defined hash values identifying known songs, images, or other media or individuals. The receive content module 302 can also detect the content objects 102 using pre-defined signals within the content stream to mark the beginning and end of the content objects 102.

Receiving the content objects 102 can include receiving information about the content objects 102. For example, the receive content module 302 can receive the content objects 102 and associated data such as name, date, size, resolution, language, version, aspect ratio, or a combination thereof.

The receive content module 302 can receive one or more of the content objects 102 at a time. After receiving the content objects 102, the receive content module 302 can pass the control flow to the packaging module 303.

The packaging module 303 can transcode the content objects 102 into an array of formats based on predefined formulas. The packaging module 303 can be used to represent the content objects 102 in different forms for different usages. Once the packaging module 303 completes, then the control flow can pass to the tagging module 304.

The tagging module 304 is a module for identifying and assigning additional information to the content objects 102. The tagging module 304 can tag each of the content objects 102 and create a content record 310 in the content data storage unit 120 having a content identifier 314, a content name 316, and an ingestion datetime 308. Tagging is the process of associating one of the content objects 102 with an identification and other information.

The content records 310 are data structure for representing the content objects 102. The content identifier 314 is a unique identifier assigned to identify one of the content objects 102. The content name 316 is a text string used to identify one of the content objects 102. The ingestion datetime 308 is a timestamp indicating when one of the content objects 102 was received.

The tagging module 304 can detect the reception of one of the content objects 102 where a record already exists for that one of the content objects 102. For example, if an identical copy of one of the content objects 102 is detected in the tagging module 304, then the reference to that one of the content objects 102 can point to the existing entry for one of the content objects 102. However, the tagging module 304 can detect and maintain separate records for different versions of one of the content objects 102, such as the same video, but different language versions of the same video, lower resolution or quality of one of the content objects 102, different aspect ratios, different editions, or a combination thereof.

The tagging module 304 can also attach workflow information to the content objects 102. For example, the tagging module 304 can indicate that one of the content objects 102 can require additional processing, such as closed captioning processing, video refinement, text capture, format changing, size changing, audio formatting, or a combination thereof.

The tagging module 304 can tag one or more of the content objects 102 at a time. Once the tagging module 304 has created the content record 310 in the content data storage unit 120, the control flow can pass to the hash module 306.

The hash module 306 is a module for calculating a unique, deterministic, numerical value, a hash value 312, to identify the data of one of the content objects 102. Deterministic is defined as meaning that for a given input value, the same value for the hash value 312 must be generated. The hash value 312 is a representation the content objects 102. The hash value 312 is separate from the content identifier 314, which is not necessarily deterministic. The hash value 312 can be used to determine if two of the content objects 102 represent an identical piece of media. The hash value 312 can be calculated over the entirety of one of the content objects 102 of over smaller portions of the content objects 102.

Although the hash value 312 is described as a single value, multiple hash values can be associated with one of the content objects 102. For example, the content objects 102 can have individual hash values for different portions of the content objects 102. In another example, the content objects 102 can use different types of hash calculations for redundancy and efficiency.

The packaging module 303 can transcode the content into an array of predefined formulas. Once the packaging module 307 completes, then the control flow can pass to the tagging module 304.

It has been discovered that calculating the hash value 312 for one of the content objects 102 can increase the performance by enabling the detection of duplications of the content objects 102 by comparing the hash value 312 of one of the content objects 102 to the hash value 312 of others of the content objects 102. Comparing the numerical values is less compute intensive than comparing the entirety of the content objects 102.

It has been discovered that calculating the hash value 312 for each of the content objects 102 improves the technology of content object identification by assigning each of the content objects a unique instance of the hash value 312. The hash value 312 enables the detection of duplications of the content objects 102 by comparing the hash value 312 of one of the content objects 102 to the hash value 312 of others of the content objects 102. Comparing the numerical values is less compute intensive than comparing the entirety of the content objects 102.

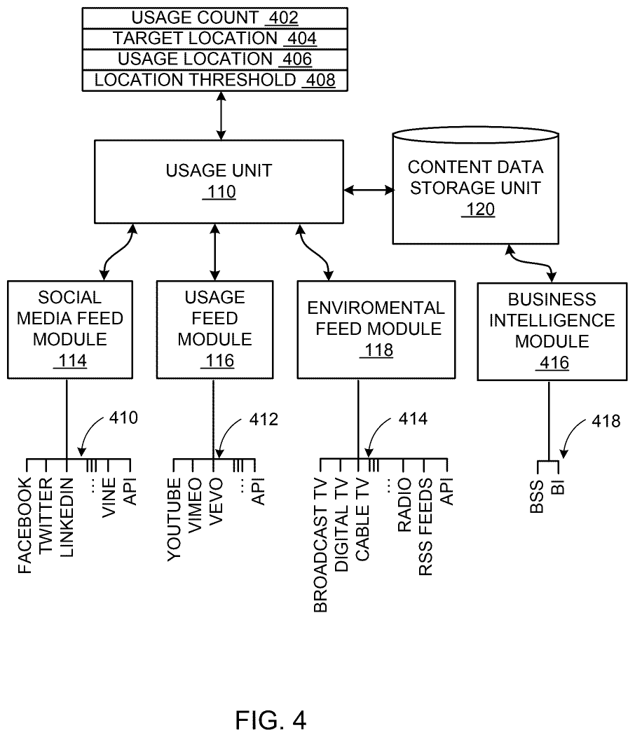

Referring now to FIG. 4, therein is shown an example of a usage unit, such as the usage unit 110 of FIG. 1. The usage unit 110 is for detecting and registering the usage of the content objects 102 of FIG. 1 in the multimedia content management and packaging system 100 of FIG. 1. The usage unit 110 can include the social media feed module 114, the usage feed module 116, and the environmental feed module 118.

The social media feed module 114 can detect the usage and reference to one of the content objects 102 over social media channels, such as a social media feed 410. The social media channels can include Facebook®, Twitter®, Linkedin®, YouTube®, 3^{rd} party application programming interfaces (APIs), or other similar social media channels.

The social media feed module 114 can monitor usage and references to the content objects 102 in a variety of ways. For example, public uses of the content objects 102 can be detected by monitoring one or more accounts on a social media site, by receiving a data feed describing the usage of the content objects 102 on the social media site, detecting a social media reference to stored copies of the content objects 102 available elsewhere on the Internet, processing data consolidation feeds summarizing references to the content objects 102 on the social media site, or a combination thereof. In another example, the public uses of the content objects 102 and their equivalents can be detected using an API of a social media site, aggregating and comparing the content objects 102 with active and archived usage data, or detecting the content objects 102 on a public network, cloud, or other data source.

The social media feed module 114 can detect usage and reference to the content objects 102 in a variety of ways. For example, the references to the content objects 102 can be exact by comparing a hash value from the social media reference to the hash value 312 of FIG. 3 of one of the content objects 102 in the content data storage unit 120. In another example, the reference to the content objects 102 can be approximate, such as when only the name or another identifier of one of the content objects 102 is detected on a social media site. In yet another example, the reference to the content objects 102 can be inferred when an indirect reference such as a partial name, abbreviation, time or date reference, slang reference, or other reference is used in a social media context. The social media feed module 114 can compare the indirect reference to a list or database correlating the indirect reference with the content objects 102.

The usage feed module 116 is a module for detecting the direct usage and reference to the media of the content objects 102. This can include websites such as video websites, movie websites, streaming media sites, video aggregators, APIs, or similar media sources. The usage feed module 116 can monitor a variety of usage feeds including a usage feed 412 such as YouTube®, Hulu®, CNN®, Crackle®, Vimeo®, Vevo®, API feeds, or other similar websites for viewing online media.

The usage feed module 116 can monitor usage and references to the content objects 102 in a variety of ways. For example, uses of the content objects 102 can be detected by directly monitoring one or more accounts on a media usage site, by using an API interface to a website, by receiving a data feed describing the usage of the content objects 102 on the media usage site, detecting a reference to stored copies of the content objects 102 available elsewhere on the Internet, processing data consolidation feeds summarizing access and references to the content objects 102 on the media usage site, or a combination thereof.

The usage feed module 116 can detect usage and reference to the content objects 102 in a variety of ways. For example, the references to the content objects 102 can be exact by comparing the hash value 312 from the media usage reference to the hash value 312 of one of the content objects 102 in the content data storage unit 120. In another example, the reference to the content objects 102 can be approximate, such as when a data feed includes only the name or another identifier of one of the content objects 102. In yet another example, the reference to the content objects 102 can be inferred when an indirect reference such as a partial name, abbreviation, time or date reference, slang reference, or other reference is used in a data feed. The usage feed module 116 can compare the indirect reference to a list or database correlating the indirect reference with the content objects 102.

In yet another example, references to the content objects 102 can be determined based on an indirect reference or inference may be made between the content objects 102 or classes of the content objects 102 based on the usage patterns in real time and historically. Predictive analysis of gaps in a media stream can be made based on historical statistical data stored in a data archive. An average value for existing references to one of the content objects 102 can be established and used to interpolate the number of references during a gap or missing portion of the media feed.

The environmental feed module 118 can monitor the external usage and references to the content objects 102 in a variety of ways. Use of the content objects 102 can be detected by directly monitoring an environmental feed 414 such as television and radio signals using a television tuner, radio receiver, or other receiving device for receiving broadcast, cable, Internet, RSS, API feeds, or satellite content. The received signals can be analyzed to detect the content objects 102 using facial recognition, voice recognition, closed captioning, hash value comparison, video analysis, audio parsing, or other similar techniques.

The use of the content objects 102 can also be detected using an API from commercial providers for television, radio, Internet, or satellite content to integrate and cross-correlate usage of the content objects 102. The usage of the content objects 102 can also be analyzed using the result from the packaging module 303 of FIG. 3 correlated with data extracted from the content objects 102 such as voice recognition, closed captioning, hash value comparison, video analysis, audio parsing, text feeds, or other similar techniques.

The environmental feed module 118 can identify the content objects 102 in the incoming feed using a variety of techniques. For example, the environmental feed module 118 can parse songs or other media by detecting the pause between media items, parsing based on timing, parsing by on express signaling, parsing based on audio volume variation, parsing based on video signal variation, or a combination thereof. The content objects 102 can also be parsed using packaging delimiters, 3^{rd} party API data, feed data, or a combination thereof.

The environmental feed module 118 can detect the content objects 102 having multiple potential durations and parsing durations by calculating different values for the hash value 312 for different portions of the potential example of the content objects 102. For example, the environmental feed module 118 can calculate the hash value 312 for different potential parsing configurations and compare each of the different values of the hash value 312 to known content objects 102.

For example, radio signals in a localized market can be monitored to detect the usage of songs, audio books, lectures, or other content by monitoring the radio broadcasts using a radio receiver device. Video content and usage can be monitored by receiving broadcast television and detecting programming content. In another example, the media reference 112 of FIG. 1 to one of the content objects 102 can be performed by receiving a data feed describing the usage of the content objects 102 on the external media, such as by receiving a programming guide, or other descriptive content and scheduling feed. In another example, the data from APIs and external data feeds can identify the usage of the content objects 102.

The environmental feed module 118 can detect usage and reference to the content objects 102 in a variety of ways. For example, the references to the content objects 102 can be exact by comparing a hash value from the media usage reference to the hash value 312 of a portion of one of the content objects 102 in the content data storage unit 120. In another example, the reference to the content objects 102 can be approximate, such as when a data feed includes only the name or another identifier of one of the content objects 102. In yet another example, the reference to the content objects 102 can be inferred when an indirect reference such as a partial name, abbreviation, time or date reference, slang reference, or other reference is used. The environmental feed module 118 can compare the indirect reference to a list or database correlating the indirect reference with the content objects 102.

In an illustrative example, the environmental feed module 118 can perform speech to text analysis of a television program received from a television receiver to determine the title of a television program at a given time and geographical location. The environmental feed module 118 can compare the associated metadata or text extracted from the audio portion of the television program to known title or introductory sequences to detect the use of the content objects 102. Further, the environmental feed module 118 can use appropriate metadata to determine titles or other identifiers for the content object 102.

The usage unit 110 can receive the information about references to the content objects 102 from the social media feed module 114, the usage feed module 116, and the environmental feed module 118 and update a usage count 402 for the content objects 102. The usage count 402 can provide an indicator of the importance and popularity of the content objects 102 based on how often they are viewed, referred to, downloaded, used, or cited.

The usage count 402 can be a single element or it can be represented by a multi-valued array or other data structure. For example, the usage count 402 can represent specific channel information, feed information, date and time information, location information, language information, user demographics, user profiles, market information, or a combination thereof. The usage count 402 can be one of the contributing factors in calculating the usage score 106 of FIG. 1 for the content objects 102.

In an illustrative example, the usage score 106 can be updated based on a usage location 406 of the media reference 112 being within a location threshold 408 of a target location 404. The usage location 406 is the location associated with one of the media reference 112. The target location 404 is a location used to calculate the media guide 202 of FIG. 2. The location threshold 408 is a value representing a distance away from a location that can be considered the same location.

The content data storage unit 120 can be coupled to a business intelligence module 416. The business intelligence module 416 is a module for processing archived information from the content data storage unit 120. The business intelligence module 416 can archive data older than a business intelligence threshold and consolidate the information in an archive for processing. The archived data can be used to detect long term trends, correlations between different time periods, specific usage models, or a combination thereof. The business intelligence module 416 can receive external feeds including business support services (BSS) feeds and business intelligence (BI) feeds providing additional information related to the content objects 102, the markets, the feeds, other usages, or a combination thereof.

It has been discovered that determining the usage count 402 for the content objects 102 increases system performance by identifying the content objects 102 that are important based on use. This allows the early detection of spiking events like viral videos and other content objects 102 by measuring the level of public interest in the content objects 102 based on how they are used and accessed across a wide range of real-time data sources representing real-world usage.

It has been discovered that updating the usage count 402 based on detecting usage of the content objects 102 in broadcast (e.g., streamed) television or radio increases system performance and functionality by providing geographically sensitive usage information.

It has been discovered that calculating multiple values of the hash value 312 to detect one of the content objects 102 having different durations or representing different portions of the content objects 102 improves the technology of media parsing. Because the parsing may be inexact, calculating different values of the hash value 312 for different portions or durations of the content objects 102 improves the likelihood of finding a matching value of the hash value 312.

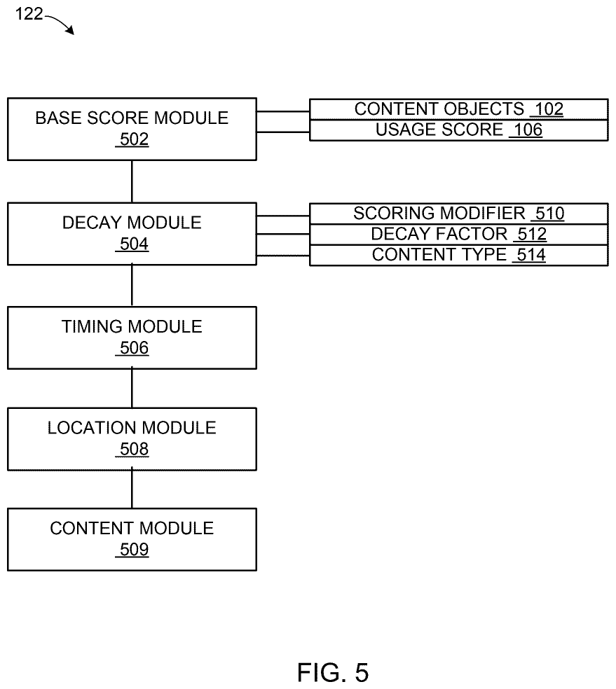

Referring now to FIG. 5, therein is shown an example of a scoring and aggregation unit, such as the scoring and aggregation unit 122 of FIG. 1. The scoring and aggregation unit 122 is for assigned and updating the usage score 106 for each of the content objects 102. The usage score 106 can rank the importance or popularity of the content objects 102 or a group of the content objects 102.

The usage score 106 is a value indicating the relative importance or popularity of the content objects 102. The content objects 102 with higher values of the usage score 106 are considered more important that those with lower values.

Although the usage score 106 is described as a value, it is understood that the usage score 106 can be a multivalued data object, such as an array, list, or structure. For example, the usage score 106 can include different values for different categories, different content types, different languages, different location, or different times.

The usage score 106 can be dynamically updated based on usage, time, type, location, quality, length, language, or other similar factors. For example, the usage score 106 can vary over time by gradually reducing in value over time to implement a time decay effect. The usage score 106 can have different values in different locations, such as for the content objects 102 representing a foreign movie in an international market, a regional television program, a commercial, a video, a regional video, a song in a foreign language, or other similar situations.

In another example, the usage score 106 can be updated based on information based on the aggregation of a set of the content objects 102. The display of multiple copies of a commercial having one of the content objects 102 can be aggregated over several different television channels to be used to update the usage score 106 because of the increased buzz over the entire advertising campaign as measured by the size of the aggregation of the content objects 102. Similarly, the aggregation of a television and radio campaign linked to a group of the content objects 102 can increase the usage score 106 based on the correlation between the usage of the content objects 102.

The usage score 106 can be updated using a scoring modifier 510. The scoring modifier 510 is a value used to modify the usage score 106. For example, the scoring modifier 510 can be used to multiply, divide, add, offset, or subtract from the usage score 106. In another example, the usage score 106 can be updated based on the quality score 614. A reference to the usage of one of the content objects 102 having a high-quality value for the quality score 614 can increase the usage score 106 more than if the quality score 614 was low to indicate a good usage of one of the content objects 102.

The scoring and aggregation unit 122 can include a base score module 502, a decay module 504, a timing module 506, a location module 508, and a content module 509. The scoring and aggregation unit 122 can integrate the results of each of the modules to update the usage score 106.

The base score module 502 is a module for initially assigning the usage score 106 for the content objects 102. The base score module 502 can create the usage score 106 entry for each of the content objects 102 and update it based on the initial parameters associated with the content objects 102.

The base score module 502 can calculate the usage score 106 in a variety of ways. For example, the base score module 502 can calculate the usage score 106 based on the length of the content objects 102. A very short video clip associated with one of the content objects 102 can result in a low value for the usage score 106, while a longer length can indicate that a higher values for the usage score 106 is appropriate. Similarly, the usage score 106 can be modified based on language, location, length, quality, type, or other similar parameters.

The base score module 502 can assign and update the usage score 106 in when the content objects 102 are first input into the multimedia content management and packaging system 100 of FIG. 1. After the base score module 502 has updated the usage score 106 for the content objects 102, the control flow can pass to the decay module 504.

The decay module 504 is a module for modifying the usage score 106 for the content objects 102. For example, the decay module 504 can be based on a time decay model that lowers the usage score 106 for one of the content objects 102 over time to represent a gradual loss on importance or interest over time.

In an illustrative example, the usage score 106 of a popular movie or video can be high when it is first released. The number of social media references and usage references can increase the usage score 106 to indicate the importance or the viral nature for one of the content objects 102. However, over time the interest of the movie or video wanes and the usage score 106 can be automatically reduced using a decay model.

The decay module 504 can update the usage score 106 in a variety of ways. For example, the decay module 504 can update the usage score 106 by calculating the time between current time and the time of the peak of the usage score 106 for one of the content objects 102 and multiply by a decay factor 512 indicating the rate of decay over time. The decay factor 512 can be a linear value, an exponential factor, an equation, a segmented value, or a combination thereof. The decay factor 512 can be the scoring modifier 510.

It has been discovered that using the decay module 504 to modify the usage score 106 of the content objects 102 increases the accuracy and usability of the usage score 106. The relative importance of the content objects 102 varies over time in the real world. The decay module 504 implements a variety of decay model to update the usage score 106 to reflect the time-based decline in importance over time, allowing the usage score 106 to more accurately reflect the importance and true popularity of the content objects 102.

The decay module 504 can determine the decay model used to calculate the decay factor 512 for the content objects 102 in a variety of ways. The decay factor 512 can be based on a content type 514, the content size, language, location, the usage count 402 of FIG. 4, date of last usage, usage frequency, or a combination thereof. For example, the decay module 504 can select the decay factor 512 for each of the content objects 102 by looking up the content objects 102 in a pre-defined decay factor lookup table showing the a preferred value for the decay factor 512 for each of the content objects 102. In another example, the decay factor 512 can be determined by applying a weighted selection criteria based on a list of parameters such as the usage count 402, the content type 514, and the date of last usage.

The decay module 504 can update the usage score 106 in a variety of ways. For example, the decay module 504 can update the usage score 106 on a time-scheduled basis, on a demand driven basis, or based on availability of computational resources either synchronously or asynchronously. After the decay module 504 has updated the usage score 106 for the content objects 102, the control flow can pass to the timing module 506.

The timing module 506 is a module for updating the usage score 106 based on time-sensitive factors. The usage score 106 may vary over time because of timing of other events, social factors, financial factors, or a combination thereof. For example, the timing module 506 can update the usage score 106 of the content objects 102 based on real-time events, the day of the week, the season, the day of the month, time of year, the proximity to pay or bonus periods, the proximity to holidays, the weather, the location, or a combination thereof.

In an illustrative example, the usage score 106 of the content objects 102 representing movies or videos that have been released within the last week in the United States can be increased on the following Friday and Saturday. Similarly, the usage score 106 of the content objects 102 representing television summer specials in the Northern Hemisphere can be increased during the months of June, July, and August. Alternatively the usage score 106 of the content objects 102 representing television summer specials in the Southern Hemisphere can be decreased during the months of June, July, and August.

It has been discovered the updating the usage score 106 of the content objects 102 due to time-dependent factors increases the accuracy of the measurement of importance or popularity. By accommodating real-world time and seasonality factors, the usage score 106 more accurately represents the importance and value of each of the content objects 102.

The timing module 506 can calculate the scoring modifier 510 for each of the time-based events. For example, the timing module 506 can perform a table lookup to determine the scoring modifier 510 for a weekend modifier. In another example, the timing module 506 can apply a pre-defined value for the scoring modifier 510 for summer months.

The timing module 506 can update the usage score 106 in a variety of ways. For example, the decay module 504 can update the usage score 106 on a time-scheduled basis, on a demand driven basis, or based on availability of computational resources. After the decay module 504 has updated the usage score 106 for the content objects 102, the control flow can pass to the location module 508.

The location module 508 is a module for updating the usage score 106 based on location. The usage score 106 may vary by location because of the popularity of local events, local newsworthiness of the content objects 102, language, location as related to the content objects 102, availability, or a combination thereof. For example, the location module 508 can update the usage score 106 of the content objects 102 based on the location associated with the content objects 102, the location of the display unit 124 of FIG. 1, location of a user, importance of a location, or a combination thereof.

The location module 508 can update the usage score 106 in a variety of ways. For example, the usage score 106 can be increased when the location associated with the content objects 102 matches the location of the user. If a French language video associated with one of the content objects 102 is displayed in France, then the usage score 106 can be higher to show more relative interest in that one of the content objects 102.

After the location module 508 has updated the location data, the control flow can pass to the content module 509. The content module 509 can update the usage score 106 in a number of ways by providing a content provider quality index score. The content module 509 can evaluate the content objects 102 in a variety of ways including the content size, content type, content resolution, content format, or other content-specific criteria.

It has been discovered that updating the usage score 106 based on a location associated with one of the content objects 102 improves the technology for media usage detection by increasing the accuracy of the measurement of importance or popularity. By accommodating real-world location factors, the usage score 106 more accurately represents the importance and value of each of the content objects 102.

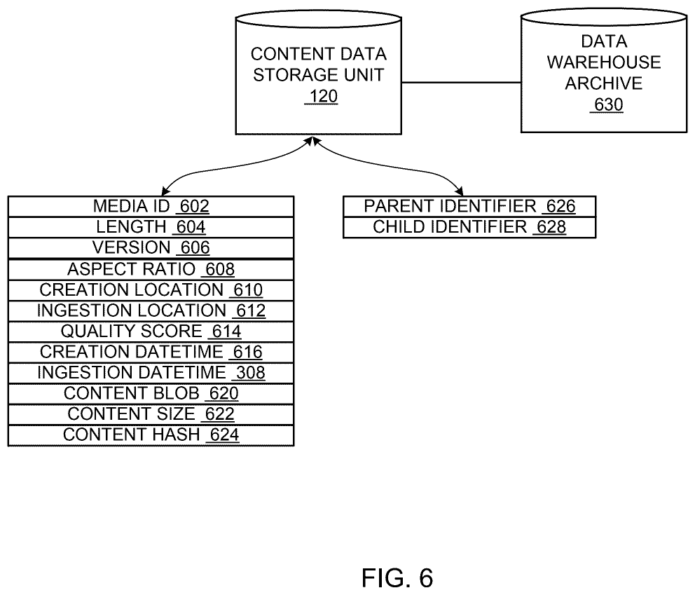

Referring now to FIG. 6, therein is shown an example of a content data storage unit, such as the content data storage unit 120 of FIG. 1. The content data storage unit 120 can store information about the multimedia content management and packaging system 100 of FIG. 1. The content data storage unit 120 can store a variety of live information about the content objects 102 of FIG. 1.

For example, the content data storage unit 120 can include a media identifier 602, a length 604, the content type 514 of FIG. 5, a version 606, and the content name 316 of FIG. 3. The media identifier 602 is a number used to uniquely identify the media associated with the content objects 102. The length 604 is a value to indicate the duration of the content objects 102. The content type 514 is a value indicating the type of the content objects 102. The content type 514 can be an enumerated value to represent types such as movies, television programs, videos, audio tracks, songs, slideshows, images, multimedia presentations, a social feed, RSS data, news, other digital information, or other similar media types. The version 606 is a value used to differentiate between multiple versions of the same media item associated with one of the content objects 102. The version 606 can be an enumerated value representing different versions such as the broadcast television version, the director's cut, the original theatric release version, or similar version variations.

The content data storage unit 120 can include an aspect ratio 608, a creation location 610, an ingestion location 612, a quality score 614, a creation datetime 616, and the ingestion datetime 308. The aspect ratio 608 is a value indicating the ratio between horizontal and vertical dimensions of the media. The creation location 610 is the location where the content objects 102 were created. The ingestion location 612 is a value indicating the location where the content objects 102 where input into the system. The quality score 614 is a value measuring of the quality of one of the content objects 102 as compared to another version of the content, such as a benchmark version. The quality score 614 can indicate the quality of the content objects 102 as a numerical value, an enumerated value, a non-numerical rating, or a combination thereof.

The creation datetime 616 is a value representing the date and time when the content objects 102 were created. The ingestion datetime 308 is a value representing the date and time when the content objects 102 was entered into the system.

The content data storage unit 120 can include data about the media item directly associated with the content objects 102 including a content blob 620, a content size 622, and a content hash 624. The content blob 620 is a database entity that can encode the media item associated with the content objects 102. The content blob 620 can also be a pointer providing a reference to the media items. For example, the content blob 620 can be a serialized digital data structure representing an entire movie, video, television episode, song, or other media item. The content blob 620 can be a database blob data type, a cloud data element, a pointer, or other similar data structure. The content size 622 is a value representing the size of data of the content objects 102. The content hash 624 is a deterministic value representing an identification of the content objects 102.

The content data storage unit 120 can include relationship information between the content objects 102. For example, the content data storage unit 120 can include the content identifier 314 of FIG. 3, a parent identifier 626, and a child identifier 628. The parent identifier 626 and the child identifier 628 are values indicating a hierarchical relationship between one of the content objects 102 having the content identifier 314. For example, one of the content objects 102, such as a standard definition movie, can have a parent that is a high-definition version of the movie, and a child that is a shortened version of the movie. The children can represent derivative editions of a parent.

The content data storage unit 120 can be coupled to a data warehouse archive 630. The data warehouse archive 630 is a data storage element for archiving and consolidating older information from the content data storage unit 120. The real-time data and operating data can be transferred from the content data storage unit 120. Aggregated information and summaries can be stored in the data warehouse archive 630 for off-line processing and business intelligence analysis. The data warehouse archive 630 can be used by business intelligence module 416 of FIG. 4 to process archived data from the content data storage unit 120 and external business feeds 418 such as BSS and BI feeds.

The data warehouse archive 630 can archive older copies of the data in the content data storage unit 120. Content older than a content threshold can be automatically moved from the content data storage unit 120 to the data warehouse archive 630. In addition, the information from the content data storage unit 120 can be analyzed and consolidated with the results stored in the data warehouse archive 630.

It has been discovered that structuring the content data storage unit 120 to represent the hierarchical structure using the content identifier 314, the parent identifier 626, and the child identifier 628 improves the technology used to identify and group the content objects 102 that are related to one another. Operating on a family of the content objects 102 can increase the efficiency of processing by performing operations on an entire related family at one time.

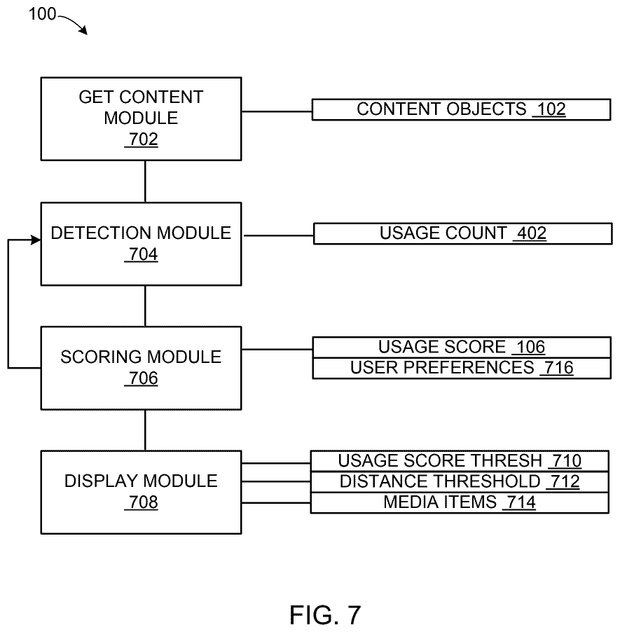

Referring now to FIG. 7, therein is shown an example of a process flow for the multimedia content management and packaging system 100. The process flow can include a get content module 702, a detection module 704, a scoring module 706, and a display module 708.

The multimedia content management and packaging system 100 can receive new media and form the content objects 102 in the get content module 702. The get content module 702 can receive content from a variety of sources and create the content objects 102 using the ingest unit 108 of FIG. 1, the receive content module 302 of FIG. 3, the packaging module 303 of FIG. 3, the tagging module 304 of FIG. 3, and the hash module 306 of FIG. 3.

The get content module 702 can receive media items 714 and create the initial records for the content objects 102. The get content module 702 can be implemented using the ingest unit 108 and other units of the multimedia content management and packaging system 100.

The media items 714 are multimedia elements that can be embodied as one of the content objects 102. The media items 714 can be portions of a media stream, such as an individual image object, a chair, soda can, person, or other element, that are part of a television broadcast. For example, media items can be pictures, sounds, words, actions, scenery, water, fire, persons, media clips, time delimited radio programs, talk shows, or similar items.

The get content module 702 can receive the content objects 102 manually by an operator entering a media item individually or as a bulk upload. Each of the media items can be used to create one or more of the content objects 102.

The get content module 702 can receive the content objects 102 automatically by receiving an external media feed, such as from an internet data feed, an API feed, a television receiver, a radio receive, a satellite receiver, or a combination thereof, and parsing the media feed to identify the media items 714.

In an illustrative example, the get content module 702 can use the ingest unit 108 to automatically detect the media items 714, such as a video, in the media feed from a television receiver using the timing information provided by a programming guide. In another example, the media items 714 can be detected along with metadata in a commercial field or internet feed or API-based feed. In yet another example, the get content module 702 can automatically detect a portion of song from a radio receiver by parsing gaps in the volume of the media feed from the radio receiver.

The get content module 702 can identify the media items 714 either by direct entry of identifying information, comparison of the media items to a database of known items, using an external service to identify, or a combination thereof. The media items 714 of the content objects 102 can be modified to assist with the identification process. For example, the media items 714 can be time-cropped to remove unnecessary content, volume adjusted, or a combination thereof.

The get content module 702 can receive the media items and form the content objects 102 in the content data storage unit 120 of FIG. 1. After the get content module 702 has completed, the control flow can pass to the detection module 704.

The detection module 704 can detect the media reference 112 of FIG. 1 to one of the content objects 102 using the usage unit 110 of FIG. 1, the social media feed module 114 of FIG. 1, the usage feed module 116 of FIG. 1, and the environmental feed module 118 of FIG. 1. When the media reference 112 is detected, the detection module 704 can increment the usage count 402 for the content objects 102.

The detection module 704 can use the social media feed module 114, the usage feed module 116, and the environmental feed module 118 to detect the media references in the real-world by monitoring network traffic, commercial media services, broadcast media channels, or a combination thereof. The detection module 704 can receive and scan the media feeds for keywords, matching hash values, specific text values, media clips, or other indicators to detect that the media reference 112 occurred in the media feed.

The degree of world-wide coverage for detecting the media reference 112 is intended to be as high and broad as possible. However, complete coverage of the entire Internet, all commercial media services, and all broadcast media around the world would require substantial resources, both technical and economic. It is understood that detecting the media reference 112 for a portion of the Internet or broadcast media would provide important information to enable the characterization of the usage of the content objects 102. Although coverage may increase over time, even a partial set of the media references can provide a valuable benefit.

The detection module 704 can detect the media reference 112 and update the information associated with the content objects 102 in a variety of ways. For example, the detection module 704 can update the usage count 402 of one of the content objects 102 when the media reference 112 is detected. In another example, the detection module 704 can associate the location of the media reference 112 to the content objects 102 to determine hot locations for one of the content objects 102.

The detection module 704 can search for the media reference 112 on a continuous basis or at scheduled intervals. The detection module 704 can operate on the live media feeds or on buffered copies of the live media feeds.

The detection module 704 is for updating the usage count 402 for the content objects 102 based on the detection of the media reference 112. After completion, the control flow can pass to the scoring module 706.

The scoring module 706 can update the usage score 106 of the content objects 102 to provide a relative ranking of the content objects 102. The scoring module 706 can be implemented using the scoring and aggregation unit 122, the base score module 502 of FIG. 5, the decay module 504 of FIG. 5, the timing module 506 of FIG. 5, and the location module 508 of FIG. 5.

The content objects 102 can be organized based on the channels 204 of FIG. 2. The channels 204 are categories used to partition the content objects 102. For example, the content objects 102 can be partitioned by categories such as content type, location, quality, media type, or a combination thereof.

Although the usage score 106 can be described as a single value, it is understood that the usage score 106 can be a complex value having multiple aspects. For example, the usage score 106 can be a multidimensional matrix or array with different values of the usage score 106 for different categories or criteria.

The scoring module 706 can update the usage score 106 based on the usage count 402 of the content objects 102, where the usage count 402 is updated when the detection module 704 detects the media reference 112. For example, if one of the content objects 102 is popular and played or referenced a large number of times on social media website, then the number of the media reference 112 will be large and the usage count 402 will be incremented accordingly. The usage count 402 can then be used by the scoring module 706 to update the usage score 106.

In another example, the scoring module 706 can update the usage score 106 based on the location associated with the media reference 112. This can allow the measurement of the usage score 106 for the content objects 102 associated with a particular location.

The scoring module 706 can continuously update the usage score 106 of the content objects 102 to provide a real-time ranking of the content objects 102. The real-time ranking is based on the comparison between the usage score 106 of all of the content objects 102. The scoring module 706 can also compare current event information from the environmental feed module 118 of FIG. 1 against historical information form the data warehouse archive 630 of FIG. 6 to modify the usage score 106.

When the scoring module 706 has finished updating the usage score 106, the control flow can pass back to the detection module 704 if there are additional updates required. If no other updates are required, then the control flow can pass to the display module 708.

The scoring module 706 can include a user preferences structure 716 to support personalization for the content objects 102 having narrow areas of interest for each user. The scoring module 706 can update the usage score 106 based on the user preferences structure 716 to influence how the information should be prioritized and displayed. The user preference structure 716 can include user-based information such as device preference, content type preferences, timing preferences, transition preferences, or other content related user preferences.

The display module 708 is a module for displaying the content objects 102 based on different criteria. For example, the display module 708 can present one of the content objects 102 on the display unit 124 of FIG. 1. In another example, the display module 708 can display a portion of the media guide 202 of FIG. 2 on the display unit 124.

The selected one of the content objects 102 to be displayed on the display unit 124 can be determined in a variety of ways. For example, the display module 708 can select one of the content objects 102 based on the usage score 106 and the creation location 610 of FIG. 6 within a distance threshold 712. In another example, the display module 708 can select one of the content objects 102 based on the usage score 106 being above a usage score threshold 710.

The usage score threshold 710 is a minimum value for the usage score 106. For example, the usage score threshold 710 can be a value indicating a minimum level of interest. In another example, the usage score threshold 710 can be a value indicating a viral phenomenon level of interest. The usage score threshold 710 can be a multi-valued data structure having a variety of associated information. For example, the usage score threshold 710 can include a geographical location component, a language component, a genre component, a media type component, a topic component, or a combination thereof. Each of the components can be applied to the usage score 106 separately to identify the properties of the content objects 102.

It has been discovered that comparing the usage score 106 to the usage score threshold 710 improves the technology for detecting the popularity of one of the content objects 102. Changing the values of the usage score threshold 710 compensates for noise levels and identifies the content objects 102 having more significance.

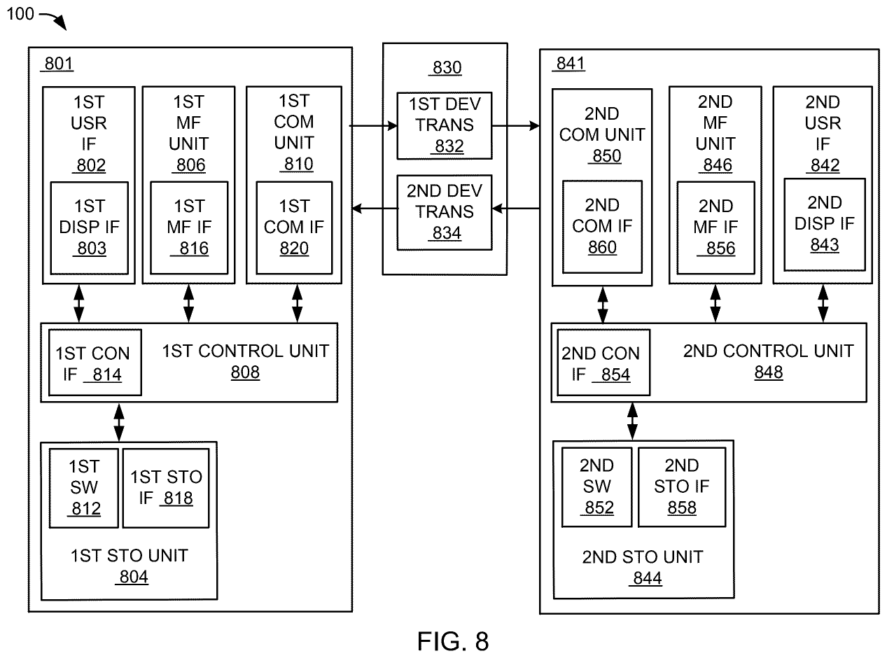

Referring now to FIG. 8, therein is shown an example of a functional block diagram of the multimedia content management and packaging system 100. The multimedia content management and packaging system 100 can include a first device 801, a second device 841 and a communication path 830.

The first device 801 can communicate with the second device 841 over the communication path 830. The first device 801 can send information in a first device transmission 832 over the communication path 830 to the second device 841. The second device 841 can send information in a second device transmission 834 over the communication path 830 to the first device 801.

For illustrative purposes, the multimedia content management and packaging system 100 is shown with the first device 801 as a client device, although it is understood that the multimedia content management and packaging system 100 can have the first device 801 as a different type of device. For example, the first device can be a server. In some examples, devices 801 and 841 may be nodes communicating over an application-defined overlay network as the communication path 830.

Also for illustrative purposes, the multimedia content management and packaging system 100 is shown with the second device 841 as a server, although it is understood that the multimedia content management and packaging system 100 can have the second device 841 as a different type of device. For example, the second device 841 can be a client device.

For brevity of description in this embodiment of the present invention, the first device 801 will be described as a client device, such as a video camera, smart phone, or a combination thereof. The present invention is not limited to this selection for the type of devices. The selection is an example of the present invention.

The first device 801 can include a first control unit 808. The first control unit 808 can include a first control interface 814. The first control unit 808 can execute a first software 812 to provide the intelligence of the multimedia content management and packaging system 100.

The first control unit 808 can be implemented in a number of different manners. For example, the first control unit 808 can be a processor, an embedded processor, a microprocessor, a graphical processing unit, a hardware control logic, a hardware finite state machine (FSM), a digital signal processor (DSP), or a combination thereof.

The first control interface 814 can be used for communication between the first control unit 808 and other functional units in the first device 801. The first control interface 814 can also be used for communication that is external to the first device 801.

The first control interface 814 can receive information from the other functional units or from external sources, or can transmit information to the other functional units or to external destinations. The external sources and the external destinations refer to sources and destinations external to the first device 801.

The first control interface 814 can be implemented in different ways and can include different implementations depending on which functional units or external units are being interfaced with the first control interface 814. For example, the first control interface 814 can be implemented with electrical circuitry, microelectromechanical systems (MEMS), optical circuitry, wireless circuitry, wireline circuitry, or a combination thereof.

The first device 801 can include a first storage unit 804. The first storage unit 804 can store the first software 812. The first storage unit 804 can also store the relevant information, such as images, syntax information, videos, profiles, display preferences, sensor data, or any combination thereof.

The first storage unit 804 can be a volatile memory, a nonvolatile memory, an internal memory, an external memory, or a combination thereof. For example, the first storage unit 804 can be a nonvolatile storage such as non-volatile random-access memory (NVRAM), Flash memory, disk storage, or a volatile storage such as static random-access memory (SRAM).

The first storage unit 804 can include a first storage interface 818. The first storage interface 818 can be used for communication between the first storage unit 804 and other functional units in the first device 801. The first storage interface 818 can also be used for communication that is external to the first device 801.

The first storage interface 818 can receive information from the other functional units or from external sources, or can transmit information to the other functional units or to external destinations. The external sources and the external destinations refer to sources and destinations external to the first device 801.

The first storage interface 818 can include different implementations depending on which functional units or external units are being interfaced with the first storage unit 804. The first storage interface 818 can be implemented with technologies and techniques similar to the implementation of the first control interface 814.

The first device 801 can include a first media feed unit 806. The first media feed unit 806 can receive the external media feeds for forming the content objects 102 of FIG. 1 and detecting the media items 714 of FIG. 7. The first media feed unit 806 can include a television receiver, a radio receiver, a satellite receive, or a combination thereof.

The first media feed unit 806 can include a first media feed interface 816. The first media feed interface 816 can be used for communication between the first media feed unit 806 and other functional units in the first device 801.

The first media feed interface 816 can receive information from the other functional units or from external sources, or can transmit information to the other functional units or to external destinations. The external sources and the external destinations refer to sources and destinations external to the first device 801.

The first media feed interface 816 can include different implementations depending on which functional units or external units are being interfaced with the first media feed unit 806. The first media feed interface 816 can be implemented with technologies and techniques similar to the implementation of the first control interface 814.

The first device 801 can include a first communication unit 810. The first communication unit 810 can be for enabling external communication to and from the first device 801. For example, the first communication unit 810 can permit the first device 801 to communicate with the second device 841, an attachment, such as a peripheral device or a computer desktop, and the communication path 830.

The first communication unit 810 can also function as a communication hub allowing the first device 801 to function as part of the communication path 830 and not limited to be an end point or terminal unit to the communication path 830. The first communication unit 810 can include active and passive components, such as microelectronics or an antenna, for interaction with the communication path 830.

The first communication unit 810 can include a first communication interface 820. The first communication interface 820 can be used for communication between the first communication unit 810 and other functional units in the first device 801. The first communication interface 820 can receive information from the other functional units or can transmit information to the other functional units.

The first communication interface 820 can include different implementations depending on which functional units are being interfaced with the first communication unit 810. The first communication interface 820 can be implemented with technologies and techniques similar to the implementation of the first control interface 814.

The first device 801 can include a first user interface 802. The first user interface 802 allows a user (not shown) to interface and interact with the first device 801. The first user interface 802 can include a first user input (not shown). The first user input can include touch screen, gestures, motion detection, buttons, slicers, knobs, virtual buttons, voice recognition controls, or any combination thereof.

The first user interface 802 can include the first display interface 803. The first display interface 803 can allow the user to interact with the first user interface 802. The first display interface 803 can include a display, a video screen, a speaker, or any combination thereof.

The first control unit 808 can operate with the first user interface 802 to display image information generated by the multimedia content management and packaging system 100 on the first display interface 803. The first control unit 808 can also execute the first software 812 for the other functions of the multimedia content management and packaging system 100, including receiving image information from the first storage unit 804 for display on the first display interface 803. The first control unit 808 can further execute the first software 812 for interaction with the communication path 830 via the first communication unit 810.

For illustrative purposes, the first device 801 can be partitioned having the first user interface 802, the first storage unit 804, the first control unit 808, and the first communication unit 810, although it is understood that the first device 801 can have a different partition. For example, the first software 812 can be partitioned differently such that some or all of its function can be in the first control unit 808 and the first communication unit 810. Also, the first device 801 can include other functional units not shown in FIG. 8 for clarity.

The multimedia content management and packaging system 100 can include the second device 841. The second device 841 can be optimized for implementing the present invention in a multiple device embodiment with the first device 801. The second device 841 can provide the additional or higher performance processing power compared to the first device 801.

The second device 841 can include a second control unit 848. The second control unit 848 can include a second control interface 854. The second control unit 848 can execute a second software 852 to provide the intelligence of the multimedia content management and packaging system 100.

The second control unit 848 can be implemented in a number of different manners. For example, the second control unit 848 can be a processor, an embedded processor, a microprocessor, a graphical processing unit, a hardware control logic, a hardware finite state machine (FSM), a digital signal processor (DSP), or a combination thereof.

The second control interface 854 can be used for communication between the second control unit 848 and other functional units in the second device 841. The second control interface 854 can also be used for communication that is external to the second device 841.

The second control interface 854 can receive information from the other functional units or from external sources, or can transmit information to the other functional units or to external destinations. The external sources and the external destinations refer to sources and destinations external to the second device 841.

The second control interface 854 can be implemented in different ways and can include different implementations depending on which functional units or external units are being interfaced with the second control interface 854. For example, the second control interface 854 can be implemented with electrical circuitry, microelectromechanical systems (MEMS), optical circuitry, wireless circuitry, wireline circuitry, or a combination thereof.

The second device 841 can include a second storage unit 844. The second storage unit 844 can store the second software 852. The second storage unit 844 can also store the relevant information, such as images, syntax information, video, profiles, display preferences, sensor data, or any combination thereof.

The second storage unit 844 can be a volatile memory, a nonvolatile memory, an internal memory, an external memory, or a combination thereof. For example, the second storage unit 844 can be a nonvolatile storage such as non-volatile random access memory (NVRAM), Flash memory, disk storage, or a volatile storage such as static random access memory (SRAM).

The second storage unit 844 can include a second storage interface 858. The second storage interface 858 can be used for communication between the second storage unit 844 and other functional units in the second device 841. The second storage interface 858 can also be used for communication that is external to the second device 841.

The second storage interface 858 can receive information from the other functional units or from external sources, or can transmit information to the other functional units or to external destinations. The external sources and the external destinations refer to sources and destinations external to the second device 841.

The second storage interface 858 can include different implementations depending on which functional units or external units are being interfaced with the second storage unit 844. The second storage interface 858 can be implemented with technologies and techniques similar to the implementation of the second control interface 854.

The second device 841 can include a second media feed unit 846. The second media feed unit 846 can receive the external media feeds for forming the content objects 102 and detecting the media reference 112 of FIG. 1. The second media feed unit 846 can include a television receiver, a radio receiver, a satellite receive, or a combination thereof.

The second media feed unit 846 can include a second media feed interface 856. The second media feed interface 856 can be used for communication between the second media feed unit 846 and other functional units in the second device 841.

The second media feed interface 856 can receive information from the other functional units or from external sources, or can transmit information to the other functional units or to external destinations. The external sources and the external destinations refer to sources and destinations external to the second device 841.

The second media feed interface 856 can include different implementations depending on which functional units or external units are being interfaced with the second media feed unit 846. The second media feed interface 856 can be implemented with technologies and techniques similar to the implementation of the first control interface 814.

The second device 841 can include a second communication unit 850. The second communication unit 850 can enable external communication to and from the second device 841. For example, the second communication unit 850 can permit the second device 841 to communicate with the first device 801, an attachment, such as a peripheral device or a computer desktop, and the communication path 830.

The second communication unit 850 can also function as a communication hub allowing the second device 841 to function as part of the communication path 830 and not limited to be an end point or terminal unit to the communication path 830. The second communication unit 850 can include active and passive components, such as microelectronics or an antenna, for interaction with the communication path 830.

The second communication unit 850 can include a second communication interface 860. The second communication interface 860 can be used for communication between the second communication unit 850 and other functional units in the second device 841. The second communication interface 860 can receive information from the other functional units or can transmit information to the other functional units.

The second communication interface 860 can include different implementations depending on which functional units are being interfaced with the second communication unit 850. The second communication interface 860 can be implemented with technologies and techniques similar to the implementation of the second control interface 854.

The second device 841 can include a second user interface 842. The second user interface 842 allows a user (not shown) to interface and interact with the second device 841. The second user interface 842 can include a second user input (not shown). The second user input can include touch screen, gestures, motion detection, buttons, slicers, knobs, virtual buttons, voice recognition controls, or any combination thereof.

The second user interface 842 can include a second display interface 843. The second display interface 843 can allow the user to interact with the second user interface 842. The second display interface 843 can include a display, a video screen, a speaker, or any combination thereof.

The second control unit 848 can operate with the second user interface 842 to display information generated by the multimedia content management and packaging system 100 on the second display interface 843. The second control unit 848 can also execute the second software 852 for the other functions of the multimedia content management and packaging system 100, including receiving display information from the second storage unit 844 for display on the second display interface 843. The second control unit 848 can further execute the second software 852 for interaction with the communication path 830 via the second communication unit 850.

For illustrative purposes, the second device 841 can be partitioned having the second user interface 842, the second storage unit 844, the second control unit 848, and the second communication unit 850, although it is understood that the second device 841 can have a different partition. For example, the second software 852 can be partitioned differently such that some or all of its function can be in the second control unit 848 and the second communication unit 850. Also, the second device 841 can include other functional units not shown in FIG. 8 for clarity.

The first communication unit 810 can couple with the communication path 830 to send information to the second device 841 in the first device transmission 832. The second device 841 can receive information in the second communication unit 850 from the first device transmission 832 of the communication path 830.

The second communication unit 850 can couple with the communication path 830 to send image information to the first device 801 in the second device transmission 834. The first device 801 can receive image information in the first communication unit 810 from the second device transmission 834 of the communication path 830. The multimedia content management and packaging system 100 can be executed by the first control unit 808, the second control unit 848, or a combination thereof.

The functional units in the first device 801 can work individually and independently of the other functional units. For illustrative purposes, the multimedia content management and packaging system 100 is described by operation of the first device 801. It is understood that the first device 801 can operate any of the modules and functions of the multimedia content management and packaging system 100. For example, the first device 801 can be described to operate the first control unit 808.

The functional units in the second device 841 can work individually and independently of the other functional units. For illustrative purposes, the multimedia content management and packaging system 100 can be described by operation of the second device 841. It is understood that the second device 841 can operate any of the modules and functions of the multimedia content management and packaging system 100. For example, the second device 841 is described to operate the second control unit 848.

For illustrative purposes, the multimedia content management and packaging system 100 is described by operation of the first device 801 and the second device 841. It is understood that the first device 801 and the second device 841 can operate any of the modules and functions of the multimedia content management and packaging system 100. For example, the first device 801 is described to operate the first control unit 808, although it is understood that the second device 841 can also operate the first control unit 808.

The multimedia content management and packaging system 100 can be partitioned between the first software 812 and the second software 852 in a variety of ways. The modules can be implemented in the first software 812, the second software 852, or a combination thereof.

For example, the first software 812 of the first device 801 can implement portions of the multimedia content management and packaging system 100. For example, the first software 812 can execute on the first control unit 808 to implement the ingest unit 108 of FIG. 1 and the usage unit 110 of FIG. 1.

The second software 852 of the second device 841 can implement portions of the multimedia content management and packaging system 100. For example, the second software 852 can execute on the second control unit 848 to implement the scoring and aggregation unit 122 of FIG. 1 and the display module 708 of FIG. 7.

The multimedia content management and packaging system 100 describes the module functions or order as an example. Each of the modules can operate individually and independently of the other modules. Furthermore, data generated in one module can be used by any other module without being directly coupled to each other.

The modules can be implemented in a variety of ways. For example, the modules can be implemented using hardware accelerators (not shown) within the first control unit 808 or the second control unit 848, or can be implemented in hardware accelerators (not shown) in the first device 801 or the second device 841 outside of the first control unit 808 or the second control unit 848.

The physical transformation of the external media feeds for forming the content objects 102 to displaying the content objects 102 on the pixel elements of the display unit results in physical changes to the pixel elements in the physical world, such as the change of electrical state the pixel imaging elements. The physical transformation is based on the operation of the multimedia content management and packaging system 100. As the changes in the physical world occurs, such as the display of the content objects 102 on the display unit 124 of FIG. 1, the operation of the multimedia content management and packaging system 100 creates additional information that are converted back into changes in the pixel elements of the display unit 124 for continued operation of the multimedia content management and packaging system 100.

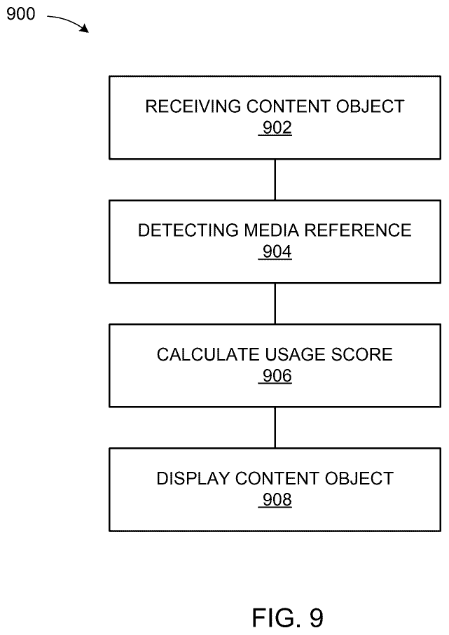

Referring now to FIG. 9, therein is shown a flow chart of a method 900 of operation of the multimedia content management and packaging system in a further embodiment of the present invention. The method 900 includes: receiving a content object in a block 902; detecting a media reference to the content object from an external media feed in a block 904; calculating a usage score for the content object based on the media reference in a block 906; and displaying the content object having the usage score greater than a usage score threshold in a block 908.

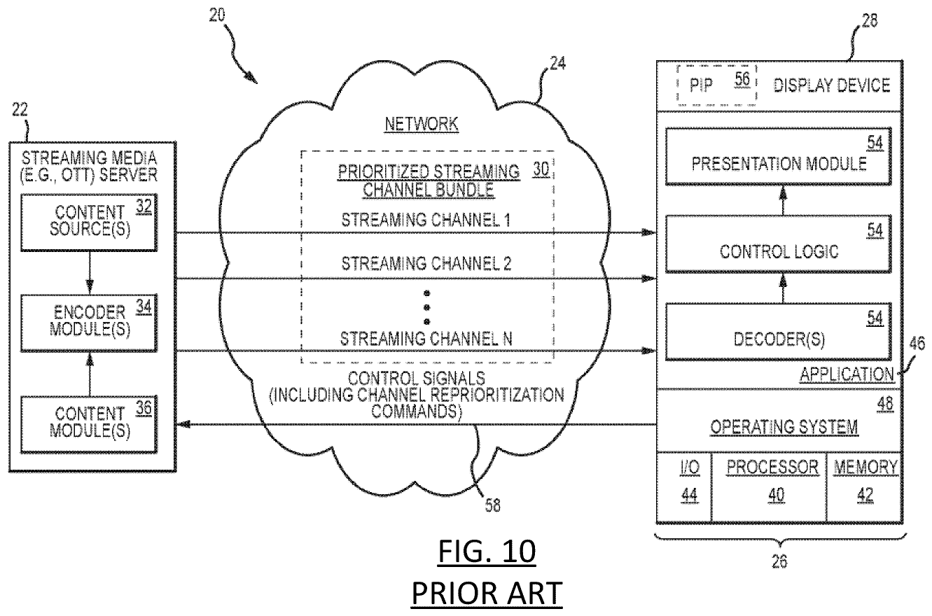

FIG. 10 schematically illustrates a conventional multichannel streaming system 20 that provides a prioritized multichannel streaming session. The multichannel streaming system 20 includes a streaming media server 22, a client media player or receiver 26, and a display device 28. During operation of multichannel streaming system 20, bidirectional communication between streaming media server 22 and client media receiver 26 occurs through a communications network 24, while client media receiver 26 outputs video (and possibly audio) signals over a wired or wireless connection to display device 28.

During a multichannel streaming session, streaming media server 22 transmits a prioritized streaming channel bundle 30 through communications network 24 to client media receiver 26. Streaming channel bundle 30 can contain Over-The-Top (OTT) linear television (TV) programing.

The streaming media server 22 can include one or more content sources 32, which feeds one or more encoder modules 34 under the command one or more control modules 36, and transmits the encoded content to client media server 22 over communications network 24.

When engaged in a multichannel streaming session, client media receiver 26 outputs visual signals for presentation on display device 28. Display device 28 can be integrated into client media receiver 26 as a unitary system or electronic device. This may be the case when receiver 26 assumes the form of a mobile phone, tablet, laptop computer, or similar electronic device having a dedicated display screen. Alternatively, display device 28 can assume the form of an independent device, such as a freestanding monitor or television set, which is connected to client media receiver 26 (e.g., a gaming console, DVR, STB, or similar peripheral device) via a wired or wireless connection.

Client media receiver 26 may contain a processor 40 configured to selectively execute software instructions, in conjunction with associated memory 42 and conventional Input/Output (I/O) features 44. I/O features 44 can include a network interface, an interface to mass storage, an interface to display device 28, and/or various types of user input interfaces. Client media receiver 26 may execute a software program or application 46 directing the various hardware features of client media receiver 26 to perform functions. Application 46 suitably interfaces with processor 40, memory 42, and I/O features 44 via any conventional operating system 48 to provide functionalities.

As schematically shown in FIG. 10, application 46 suitably includes control logic 50 adapted to process user input, obtain prioritized streaming channel bundle 30 from one or more content sources 32, decode received streams, and supply corresponding output signals to display device 28. The streaming channels contained in prioritized streaming channel bundle 30 are decoded utilizing known techniques. In implementations, each channel stream contained in bundle 30 may be simultaneously decoded by a separate decoding modules. The decoding module or modules may be implemented using specialized hardware or software executing on processor 40. Decoded programming can be provided to a presentation module 54, which then generates output signals to display device 28. In some embodiments, presentation module 54 may combine decoded programming from multiple streaming channels to create a blended or composite image; e.g., as schematically indicated in FIG. 10, one or more PIP images 56 may be superimposed (i.e., overlayed) over a main or primary image generated on a screen of display device 28.

In operation, control logic 50 of client media receiver 26 obtains programming in response to end user inputs received at I/O features 44 of receiver 26. Control logic 50 may establish a control connection with remote streaming media server 22 via communications network 24 enabling the transmission of commands from control logic 50 to control module 36. Streaming media server 22 may operate by responding to commands received from a client media receiver 26 via network 24, as indicated in FIG. 10 by arrow 58. Such commands may include information utilized to initiate a multichannel streaming session with streaming media server 22 possibly including data supporting mutual authentication of server 22 and receiver 26.

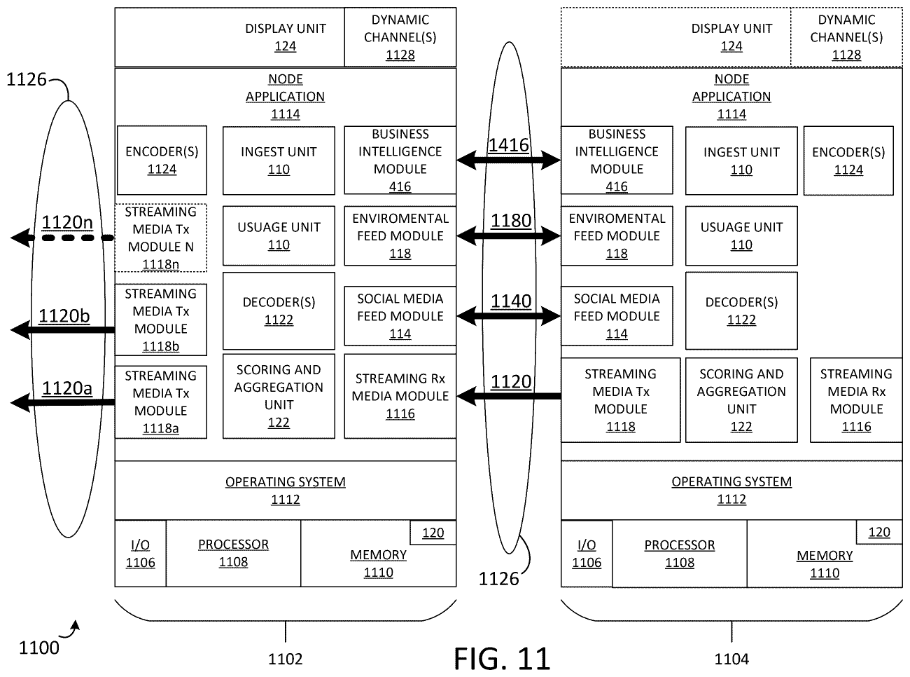

FIG. 11 shows a multimedia content management and packaging system 1100, which includes nodes 1102 and 1104. Each of the nodes 1102, 1104 may include a node application 1114 which is operably coupled with I/O 1106, processor 1108, memory 1110 (which may include content data storage unit 120), OS 1112, and display 124. Node 1102 may be a commercial server, but one or both of nodes 1102 and 1104 can instead be user devices for viewing content.

In contrast to a single commercial server providing a plurality of multichannel streams in a one-to-many configuration with user devices, as shown in FIG. 10, one embodiment implementation includes both (1) decoding by decoder(s) 1122, at least a sub-plurality of programs from a multi-program transport stream (MPTS) 1120 for local (node) viewing and (2) re-transmitting stream 1120 over a partial mesh network topology (as streams 1120a, 1120b, and 1120n) at the viewer/user application layer, although other configurations and arrangements of software, hardware, and network topologies can be implemented in other embodiments.

Node application 1114 may be operable to receive (e.g. via streaming media module 1116) and transmit a plurality of MPTSs 1120a, 1120b, and 1120n as part of an application layer overlay network 1126. The overlay network 1126 may include, among other techniques, an application layer streaming video data according to one or more small-world topologies within a self-healing and self-organizing network (e.g., a small world wide-area peer-to-peer network).

Such a network enables nodes 1102 and 1104 to enter and leave the overlay network 1126 with minimum-to-no disruption to the presentation of programs of the MPTS streams (e.g., multichannel video streams) by other nodes that remain a part of the network. More generally stated, one or more of nodes 1102 and 1104 may be part of a peer-to-peer (P2P) overlay network, typically implemented at the application layer, or a hybrid network thereof (e.g., a commercial server commutatively coupled to a P2P overlay network, with said server not being coupled as a node in the sense that it does not re-transmit and/or receive further programs that the network 1126 is sharing).

Embodiment configurations may include node-specific content delivery, feedback, and advertisement, among other things. For example, each stream 1120a, 1120b, and 1120n may include the same channels, however, it is envisioned that a particular node may “mute” particular channels such that a node is locked from decoding certain channels received from a multichannel-stream-transmitting node. Such muted content may be restricted via direct user feedback such as age restrictions or calculated based on user preferences and other user feedback.

Decoder(s) 1122 may selectively decode at least a main program (e.g., an audio and/or audio-visual presentation) and at least one dynamic channel 1128. As described in the context of FIG. 2 and elsewhere, a media guide can dynamically display other program content according to, among other possibilities, a usage score that can take into account stream-related data (e.g., detected content objects of a video stream) and interface said data with large data aggregation and analysis techniques. User “likes”, “follows”, and “shares” along with a determined number of node viewers and/or their social activity within a node application overlay network may influence usage score metrics that are updated throughout said network. Dynamic channel 1128 may “auto-surf” in the sense that channel 1128 changes programs and/or program presentations based on, in some examples, a network-updated usage score that can indicate the relative popularity of a program.

Streaming Media Tx Modules 1118, 1118a, 1118b, and 1118n respectively stream to node 1102 and further nodes (not shown). That is, node application 1114 can dynamically implement one or more a streaming media TX modules, as needed as part of a possible self-organizing and self-healing network 1126. For example, the number of streaming media Tx modules 1118a, 1118b, and 1118n may increase or reduce such that the number of MPTSs transmitted by node 1102 is correspondingly increased or reduced or said module(s) may reroute an MPTS to a respective receiving node within the network 1126.

Nodes 1102 and 1104 may further receive and (re) transmit social media feed 114, environmental feed 1180, and business intelligence feed 1416 over the same network. Encoder(s) 1124 may encode content locally captured or stored on node 1102 or 1104 to provide video programming for MPTSs 1120 and/or 1120a, 1120b, 1120n.

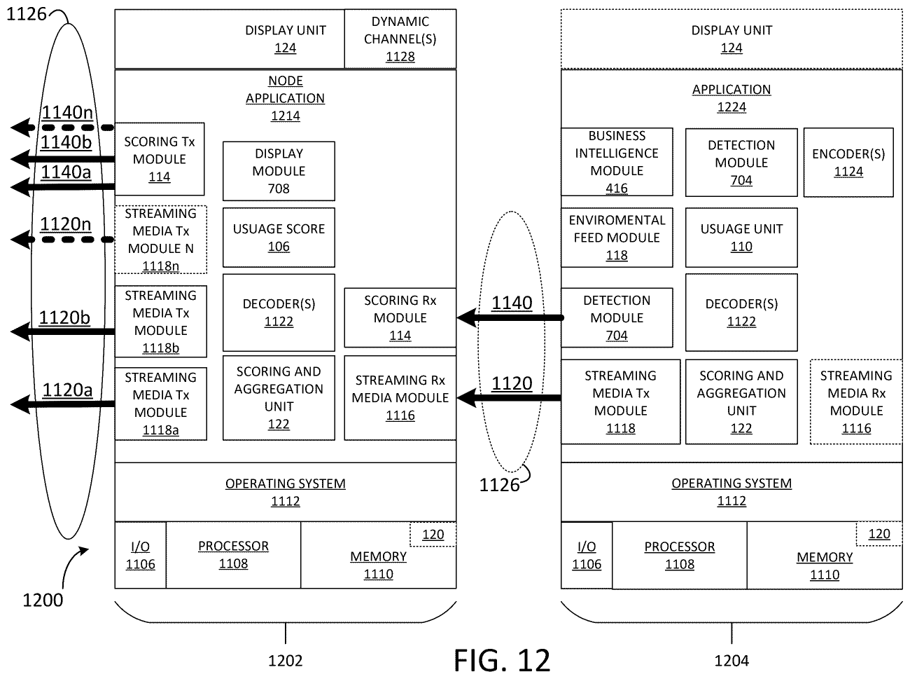

Nodes 1102 and 1104 may further include one or more of the ingest unit 110, usage unit 110, and scoring and aggregation unit 122. In some embodiments, as shown in FIG. 12, a usage score may be transmitted over network 1126 as metadata of MPTSs 1120 in metadata stream 1140. Metadata stream 1140 may be a separate stream from MPTS 1120 and/or combined (or a part of) program data (e.g., multimedia data) of the MPTS 1120.

To explain further, as seen in applications 1214 and 1224 of system 1200 of FIG. 12, a usage score may be shared over network 1126 via metadata streams 1140, 1140a, 1140b, and 1140n as separate, discrete streams or as a combined stream with respective MPTSs 1120a, 1120b, and 1120n. In some embodiments, for example, Watch-to-Earn and Tag-to-Earn embodiments, usage score data may be locally generated and/or combined with received usage score data.

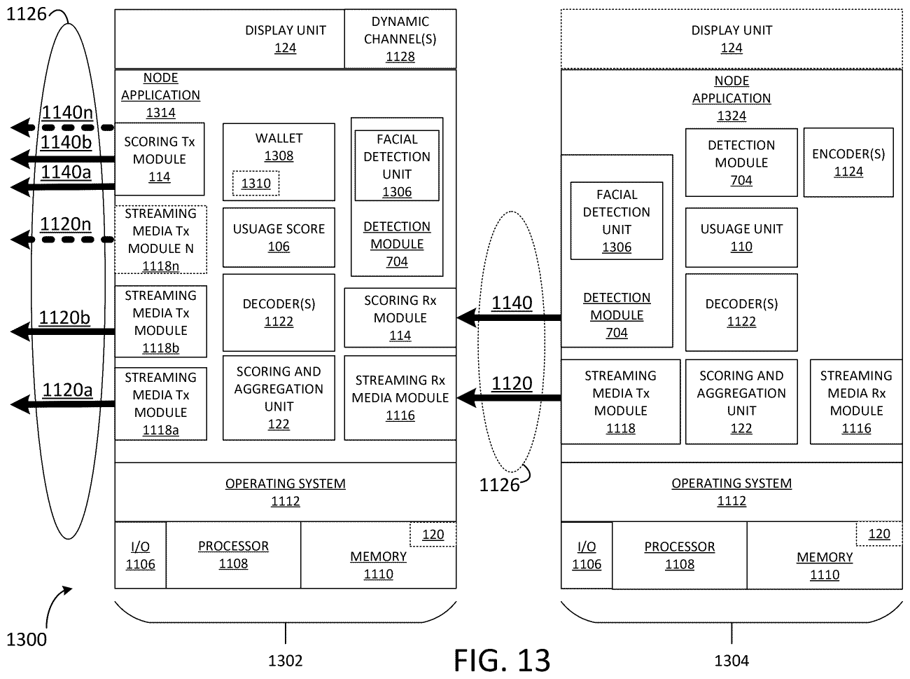

For example, as seen in system 1300 of FIG. 13, nodes 1302 and 1304 respectively include node applications 1314 and 1324, which both include facial detection unit 1306 as a sub-module of detection module 704. Wallet 1308 may be a digital wallet (e.g., a blockchain wallet) and/or a wallet module that interacts with an external hardware wallet (not shown). In some embodiments, wallet 1308 may include a non-fungible token (NFT) 1310 or other unique digital asset associated with a particular content object such as media-exposed person. In some embodiments, a digital currency (e.g., Ethereum ETH, Fantom FTM, or Polygon MATIC) is earned for each time facial detection unit 1306 detects a face associated with said NFT that is owned by or otherwise associated with wallet 1308 (e.g., wallet 1308 being the “owner” address or staking address of an NFT that is staked on a blockchain platform in order to earn digital currency from a streaming media platform).

In some embodiments, usage score 106 is used to determine the payout to wallet 1308. Said usage score 106 may be based on a single node's usage score calculation. Usage score 106 may be based on facial detection determination on a per stream basis and/or a per node basis.

For example, usage score 106 may be determined based on a program stream of MPTS 1120, independently or regardless of how many nodes are playing said program stream on display 124. In some embodiments, a usage score 106 may represent an accumulated number of facial detections by each node that is displaying a program stream of MPTS 1120. That is, such a representation of usage score 106 reflects how many times (and/or other value such as facial detection duration) a particular face has been cumulatively detected by each node of network 1126 on a decoded program stream of MPTS 1120 that is being presented on a respective display unit 124.

In some embodiments, usage score 106 may be a composite score based on the program stream itself (e.g., a base usage score), which is modified based on the number of nodes that are presenting said program stream on display unit 124 (e.g., a modified usage score). In some embodiments, said base usage score may be the modifier and said modified usage score may be the base score (e.g., determining the base score based on the number of nodes that are playing relevant content on a respective display unit 124).

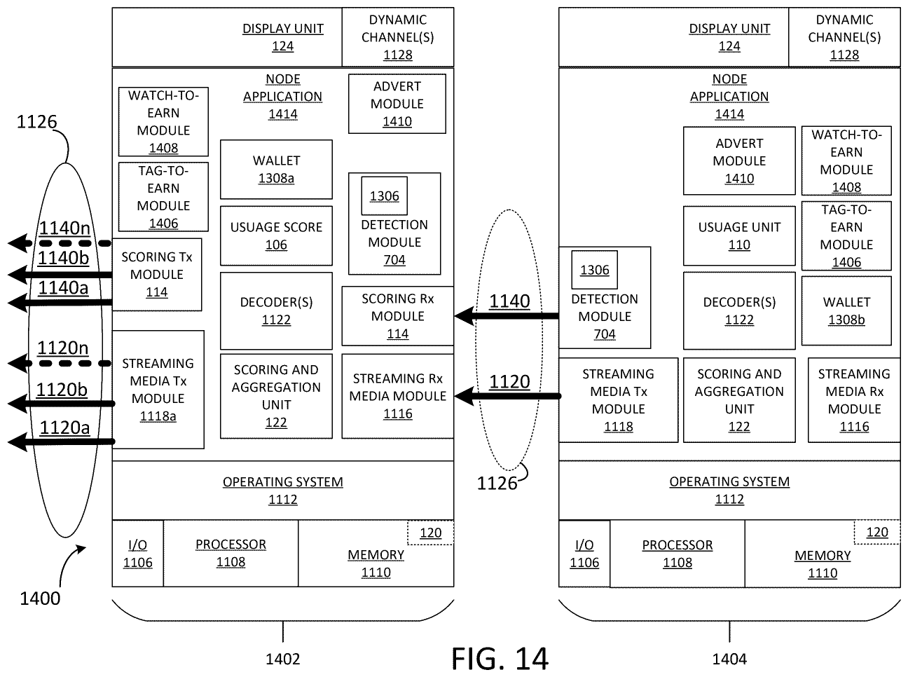

System 1400 of FIG. 14 includes nodes 1402 and 1404 with, respectively, node application 1414 with match-to-earn module 1408, tag-to-earn module, streaming media Tx modules 1118a and 1118, and wallets 1308a and 1308b. Module 1408 monetizes a user's viewing of display unit 124. A user may earn, among other things, a blockchain currency (e.g., ETH, VET, FTM, MATIC) that is send to the viewer's wallet 1308a or 1308b. A viewer may earn said currency in a multitude of ways, including the duration of watching, the number of ads watched, social media activity relevant to content objects, or a combination of thereof, among other possibilities.

Module 1406 monetizers a user's participating in data characterization for, among other reasons, categorizing content objects. For example, a user may interact with a (graphic) outlined area for tagging and/or confirming tags of individuals presenting, participating, or otherwise shown on a program. Tags may include real names and/or usernames of social media platforms such as Twitter, Facebook, Linkedin, and the like. Module 1406 may provide a drop-down menu while a user types a full names. Additionally or alternatively, the drop-down menu may provide a list of social media usernames or handles.

Advert module 1410 may provide and/or monitor advertising for billing or other accounting purposes. Advert module 1410 may be conditioned on a user engaging with the watch-to-earn module 1408 so that monetization, from both the user-watcher and advertiser perspectives, is tied together. In some embodiments, such a system enables for an efficiently use of advertising budgets and may not require any use of cookies or the like since monetization (and calculations related thereto) can occur on a per-node basis.

In some embodiments, advert module 1410 presents advertisements based on a detected plurality of content objects of a program that is being viewed. Such embodiments can present relevant advertising (with respect to said program) without the use of data, but rather utilizing, for example, video content analysis such as facial detection and other object detecting techniques.

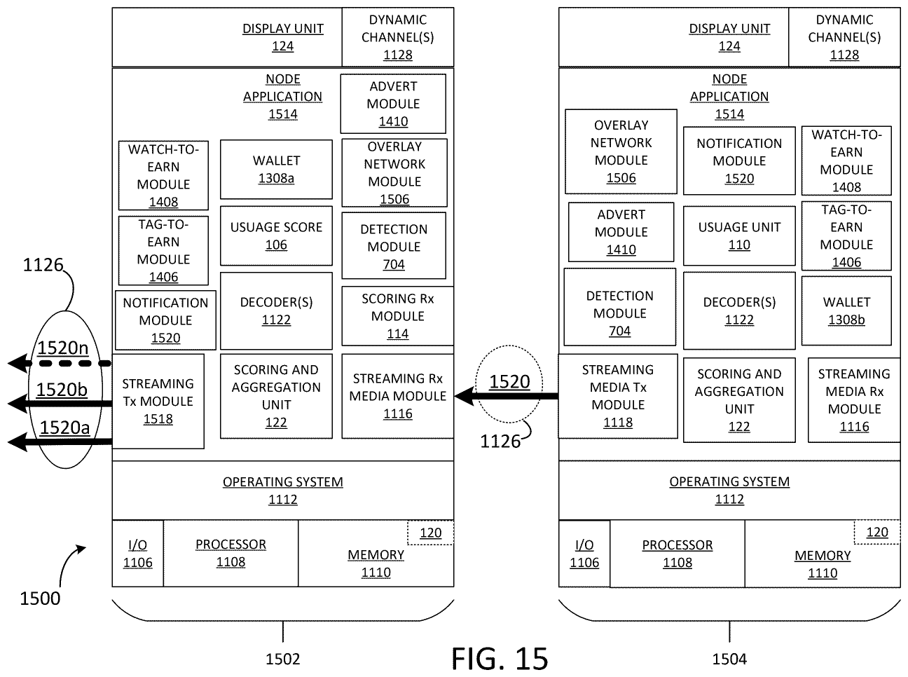

System 1500 of FIG. 15 includes nodes 1502 and 1504 with streaming module 1518 of node application 1514. In some embodiments, streaming module 1518 streams MPTS 1520 (and MPTS 1520a, 1520b, and 1520n), inclusive of metadata such as a usage score(s) for content objects that are detected or otherwise identified in one or more programs of MPTSs 1520, 1520a, 1520b, and 1520n, among other examples

Nodes 1502 and 1504 also include overlay network module 1506 for establishing and maintaining, for example, peer-to-peer overlay network connections with other nodes. Example topologies that module 1506 may utilize include partial and full-mesh arrangements. Partial-mesh topologies may be established according to a small-world paradigm, among other techniques.

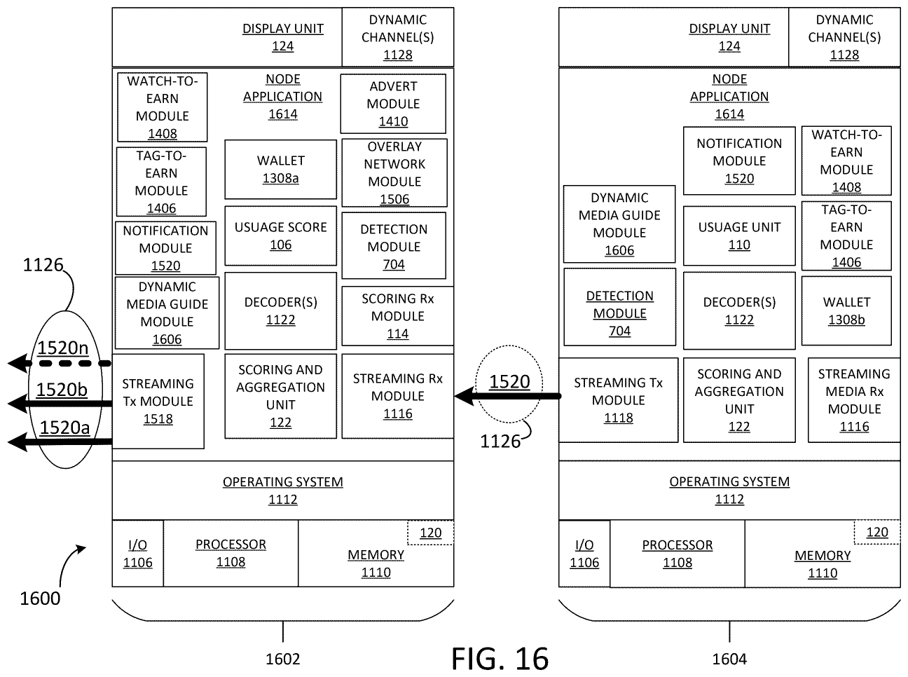

System 1600 of FIG. 16 includes nodes 1602 and 1604 with dynamic media guide module 1606 of application 1614. In some embodiments, said module 1606 dynamically displays one or more programs as explained in further detail below and with reference to FIG. 2. In some embodiments, module 1606 provides an array of programs, arranged by channel and relative usage, either directly measured by a node or derived from a social media feed, among other examples.

It is understood that any of the nodes 1102, 1104, 1202, 1204, 1302, 1304, 1402, 1404, 1502, 1504, 1602, and/or 1604 may include any of the modules and functions that are shown for one node, but not for another. For example, overlay network module may also be included in the other nodes besides 1602 and 1604 of FIG. 16. The particular groupings of modules, units, and functionalities for each node of FIGS. 11 to 16 are example groupings and not mutually exclusive ones.

Node applications 1114, 1214, 1314, 1414, 1514, 1614 may include any application that can run on user equipment such as a browser. In some embodiments, one or modules of said applications may be plug-ins running on a web browser application. In some embodiments, said applications may be a plug-in running on a web browser application (e.g., application 4414). In some embodiments, node applications are omitted and one or more of the modules may run on a user-viewer's user equipment as a plug-in and/or application that is communicatively coupled to a server.

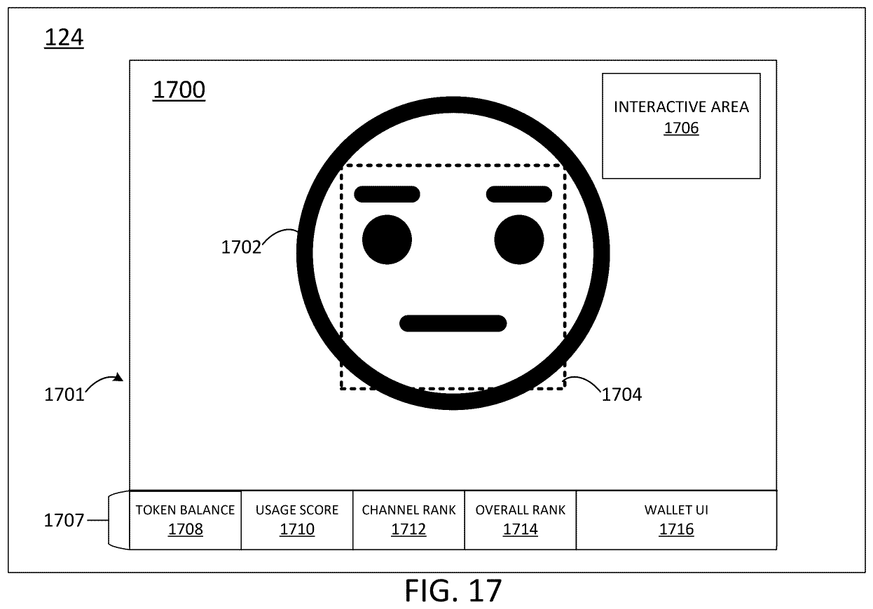

FIG. 17 shows display unit 124, which shows media guide 1701 with a main program 1700, which shows a person 1702 to be identified. Outlined area 1704 may outline at least a facial region of person 1702 for, among other possibilities, allowing a user to identify person 1702 or confirm the identity of person 1702 via an interaction with interactive area 1706. Banner 1707 shows a user's token balance 1708, which may be a total balance in a user's wallet and/or a session balance from one or more sessions. In some embodiments, user may claim their earnings periodically before transferring to a user's application wallet or hardware wallet, among other examples.

Usage score 1710 may show one or more scores or graphical indicators thereof for the main program 1700 and/or other programs being displayed on display unit 124. Channel rank 1712 may show a ranking of program 1700 within a channel that program 1700 is grouped in. Said grouping may be pre-packaged from a streaming device and/or thematically grouped by a node application, with or without user input or other assistance.

Overall rank 1714 may be a ranking of program 1700 that is relative to all programs being streamed by a node network or subnetwork thereof. Wallet UI 1716 may interact with a node application wallet or an external wallet to perform functions like connecting operably coupling with to the node application to receive, send, stake, and perform other wallet-related functions. In some embodiments, a user may be rewarded in a blockchain currency for “tagging” or identifying people such as media personalities and entering an identifying name, such as a real name or username of a node application or of another platform (e.g., Twitter®).

In some embodiments, a user may be rewarded with a blockchain currency for watching programs displayed on display unit 124 (e.g., watch-to-earn).

The graphic components of banner 1707 may be differently arranged across display unit 124. For example, wallet UI 1716 maybe detached from the presentation of main program 1700 such that it resides in a distinct area above, below, or to the side of program 1700. Banner 1707 may “disappear” after a decay duration and re-appear after a user interaction (e.g., a cursor being moved across or towards a lower portion of program 1700.

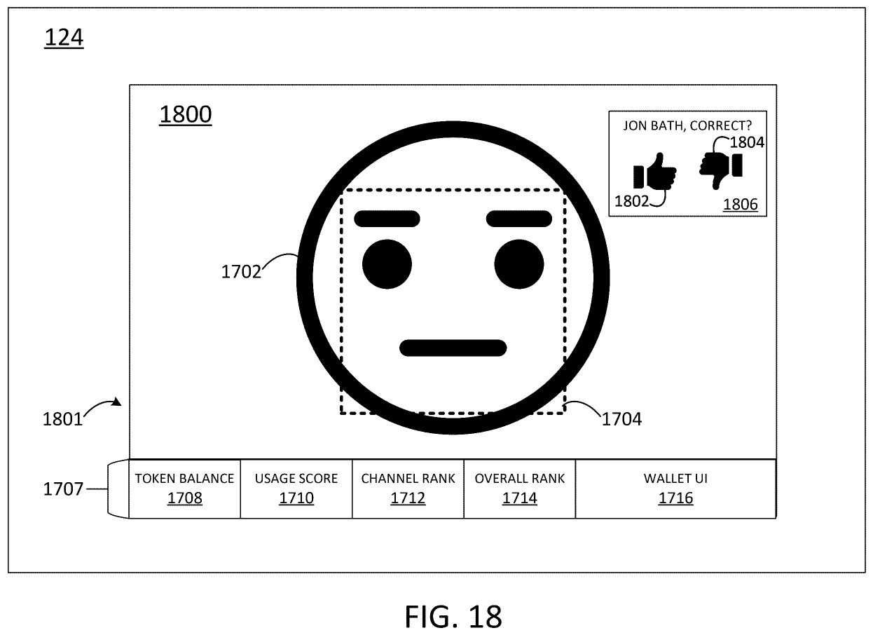

FIG. 18 shows media guide 1801 with main program 1800 and interactive area 1806 for a user to provide an objective determination as to whether person 1702, with outline 1704, is correctly identified as “Jon Bath”. Thumbs up icon 1802 indicates an affirmation and thumbs down icon 1804 indicates that person 1702 has been misidentified (e.g., a false positive). In response to a user selecting icon 1802 or 1804, said user's token balance 1708 may increase from a tag-to-earn reward. In some embodiments, identified facial descriptors (of a video stream) that triggered a false positive identification may be deemed, in response to a user-viewer's feedback, as a “rejected facial descriptor” and associated (e.g., via a cluster ID) with a data cluster representing confirmed, rejected and/or identified facial descriptors of a media personality or other individual.

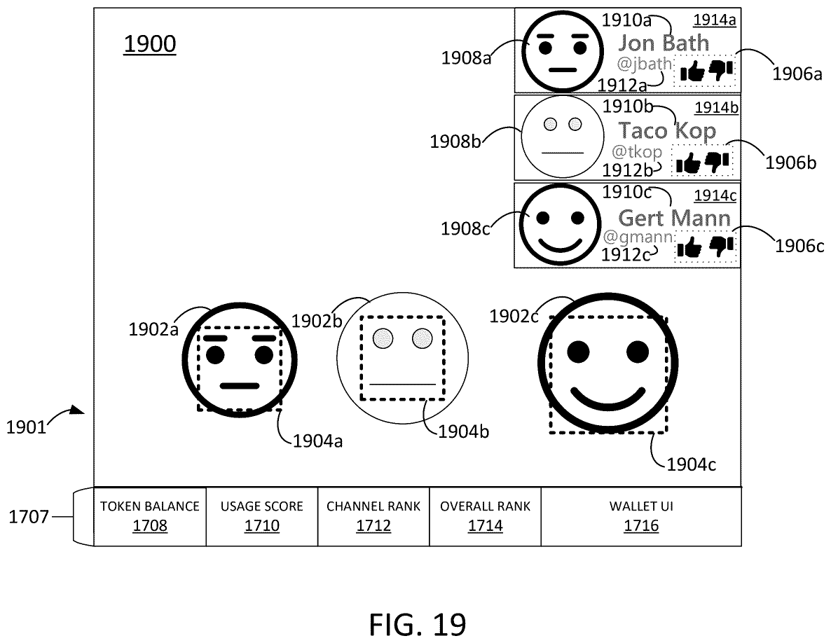

FIG. 19 shows media guide 1901 with a main program 1900 that shows people 1902a, 1902b, and 1902c with respective outlined areas 1904a, 1904b, and 1904c. Graphic IDs 1914a, 1914b, and 1914c respectively include interactive areas 1906a, 1906b, and 1906c; photo IDs 1908a, 1908b, and 1908c; identified name 1910a, 1910b, and 1910c; and username 1912a, 1912b, and 1912c.

Similar to FIG. 18, interactive areas 1906a, 1906b, and 1906c provide icons for a user to affirm or disaffirm the individual being of the identity shown in a respective graphic ID 1914a, 1914b, and 1914c. In some embodiments, interactive areas may include the entire graphic ID so that, for example, clickable links can be included with one or more of photo IDs 1908a, 1908b, and 1908c; identified name 1910a, 1910b, and 1910c; and username 1912a, 1912b, and 1912c. In some embodiments, a user may directly enter a name or username or correct a name or username displayed within a graphic ID.

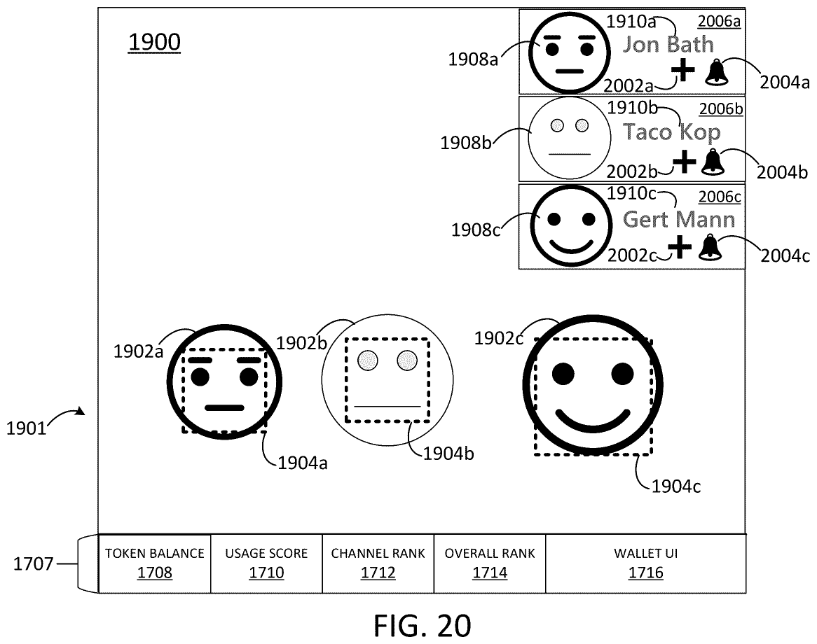

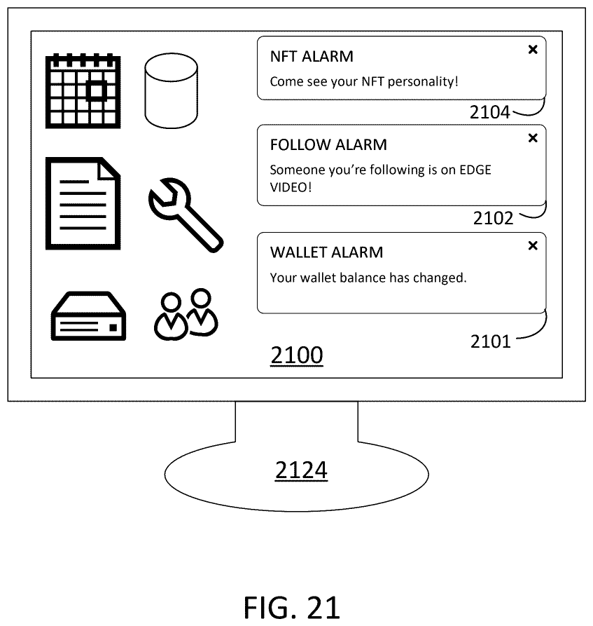

FIG. 20 shows interactive areas 2006a, 2006b, 2006c as an interactive graphic ID and further includes plus icon 2002a, 2002b, and 2002c, and bell icon 2004a, 2004b, and 2004c. The plus icons 2002a, 2002b, and 2002c may respectively allow for user interaction to “follow” or other related functionality the identified person. Additionally or alternatively, a user may interact with one or more of bell icons 2004a, 2004b, and 2004c to receive alerts, both within and “outside” of main program (e.g., as shown in FIG. 21) when the associated identified person is being shown on a program.

In some embodiments, said alerts may be time stamped and/or trigger the relevant program to be buffered by the node application in, for example, memory accessible by the node application. In some embodiments, the alert may be displayed for a predetermined amount of time, particularly as it relates to a buffering limit, which may be expressed in time, a memory threshold, among other possibilities. In some examples, the buffer may use “local” memory, but additionally or alternatively, buffering memory may be provided by other nodes connected to the node that displayed the notification (e.g., neighboring nodes).

Display 2124 of FIG. 21 shows desktop 2100 with overlayed notifications 2101, 2102, and 2104. A user may click on either notification 2102 or 2104 and, in response, launch or otherwise present a node application for playing a buffered program beginning at the timestamp associated with one of said notifications 2102 and 2104. Additionally or alternatively, notifications 2101, 2102, and 2104 may include audio notifications.

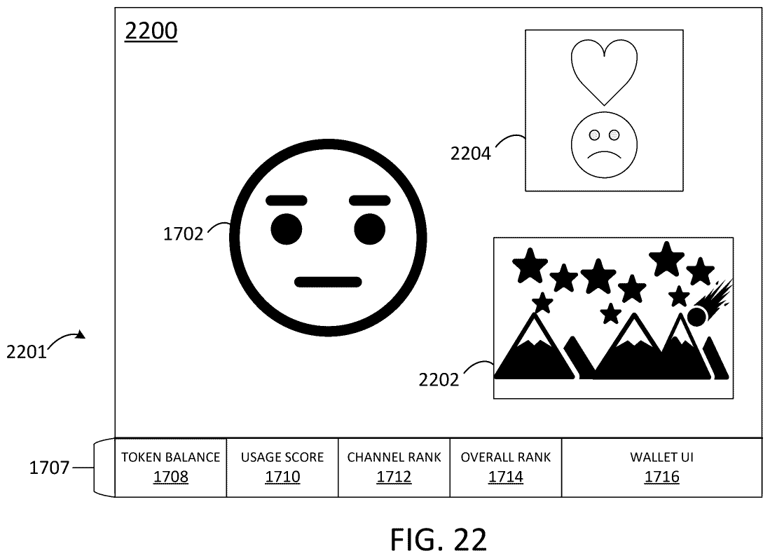

Media guide 2201 of FIG. 22 shows main program 2200 with dynamic channel 2202 and interactive area 2204 graphically overlayed said program 2200. Area 2204 may be a graphical presentation to provide subject and/or objective feedback from a user-viewer concerning, for example, main program 2200 or dynamic channel 2202. For example, area 2204 may allow a user to “like” various main program 2200 content for modifying a base usage score. A modified usage score is then used to determine, out of a plurality of streaming programs, which program has the highest usage score and thus is presented via dynamic channel 2202. In some embodiments, the usage score is periodically updated during program presentations, thus allowing for dynamic channel 2202 to “auto-surf” according to, for example, a customized usage score taking account a user-viewer's preferences and a base usage score derived from content object detection and/or other metadata (e.g., social media shares, likes, re-tweets, and the like).

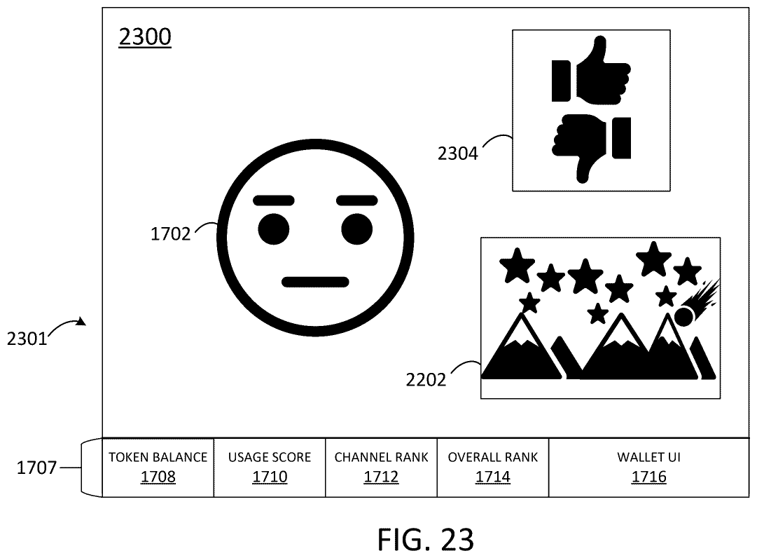

Media guide 2301 of FIG. 23 shows main program 2300 with interactive area 2304, which may provide subject or objecting feedback. Objective feedback may include confirmation or correction of facial identification information, voice identification information, and/or other content object identification information.

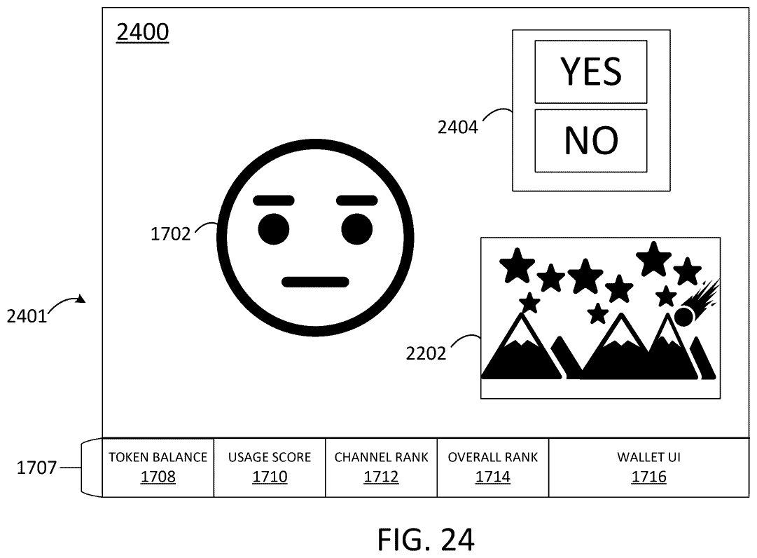

Media guide 2401 of FIG. 24 shows main program 2400 with interactive area 2404, which may provide subject or objecting feedback. Objective feedback may include confirmation or correction of facial identification information, voice identification information, and/or other content object identification information.

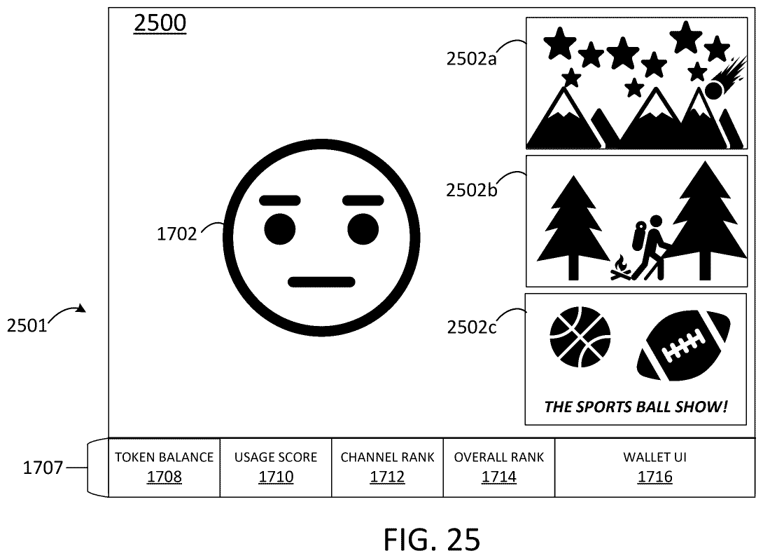

Media guide 2501 of FIG. 25 shows main program 2500 with dynamic channels 2502a, 2502b, and 2502c. In some embodiments, dynamic channels 2502a-c may be graphically overlayed on main program 2500, but in alternative embodiments, dynamic channels 2502a-c may reside outside of the presentation of main program 2500 (such as above, below, or besides main program 2500).

The dynamic channels 2502a, 2502b, and 2502c may move up or down depending on a respective usage score such that dynamic channel 2502a has the top usage score and channel 2502c has the lowest usage score of the three dynamic channels. Channel 2502c may be replaced with another program (and thus no longer shown as a dynamic channel) or move up the dynamic channel rankings to exchange positions with channel 2502a or 2502b.

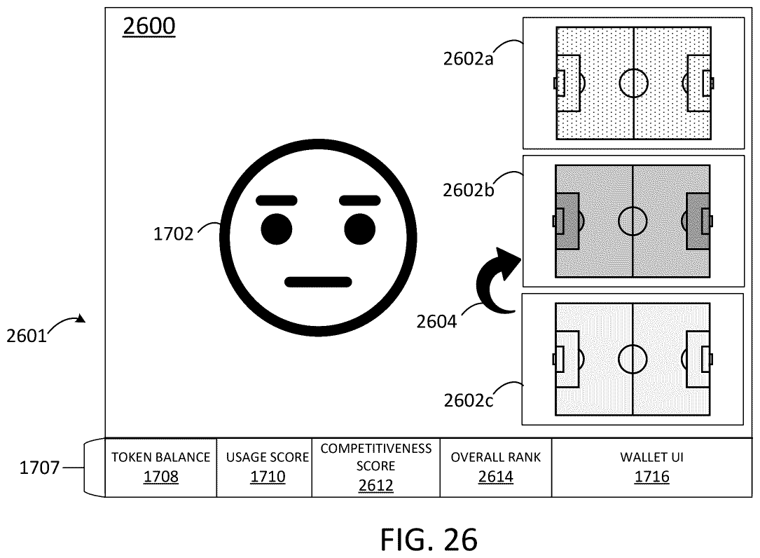

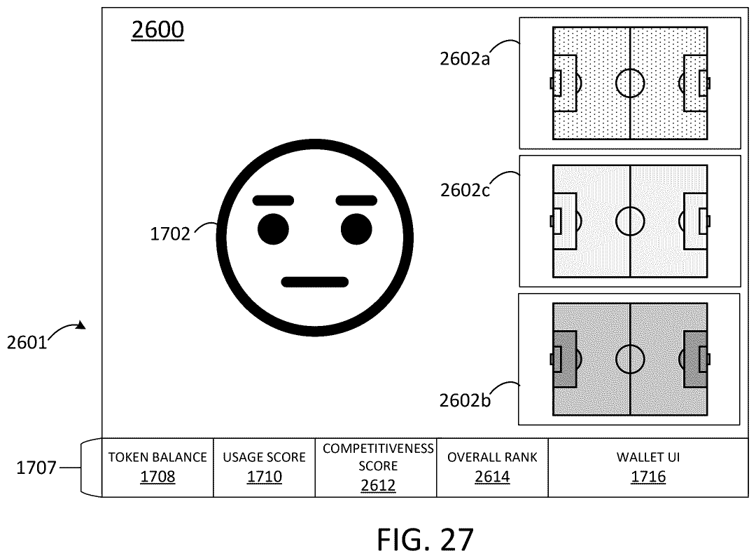

For example, as shown in FIGS. 26 and 27, media guide 2601 presents main program 2600 and animation 2604, which indicates that dynamic channel 2602c is swapping places with dynamic channel 2602b, leaving dynamic channel 2602a in the top spot. In some embodiments, at least one of a usage score and a competitiveness score 2612 is sued to rank dynamic channels 2602a, 2602b, and 2602c. In some embodiments a competitiveness score 2612 modifies a usage score. In some embodiments, the competitiveness score 2612 is periodically updated with, for example, a point differential between players or teams such that game programs with smaller point differentials are ranked as more competitive than other game programs and ranked as such. In some embodiments, a competitiveness score 2612 is weighted in relation to how many rounds or how much time is remaining in a game program. For example, a node application may detect, from video data, scores and remaining (or current) game time for modifying a competitiveness score weight for game programs that are near the end of a game and thus possibly achieving a higher overall rank 2614 than on a point-differential point basis alone.

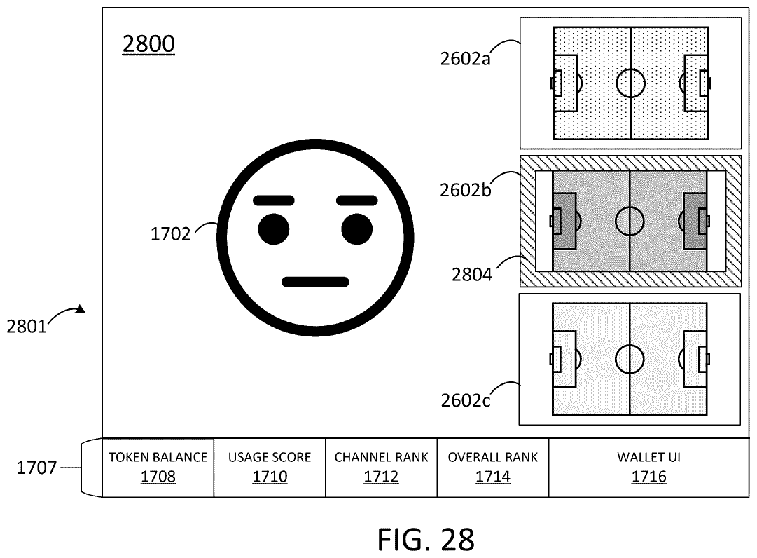

As shown in FIG. 28, media guide 2801 shows main program 2800 and a frame animation 2804 for highlighting dynamic channel 2602b. In some embodiments, animation 2804 may indicate a competitiveness score while the presented order reflects a usage score ordering. In some embodiments, animation 2804 indicates which of the dynamic channels 2602a-c has the relative highest score, which may be represented by meters 2908.

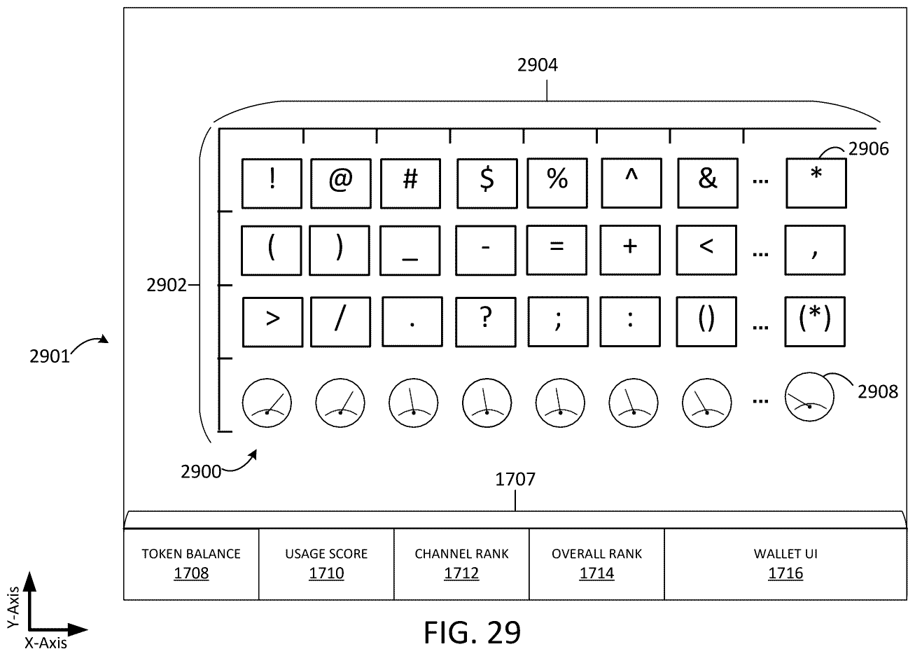

As shown in FIGS. 29 to 33, media guide 2901 shows an array 2900 of programs 2906 with accompanying meters 2908. In some embodiments, array 2900 shows a decoded sub-plurality and/or all of the programs of an MPTS to display a plurality of, for example, video streams.

Programs 2906 may be organized, along the x-axis, in channels such as channels 2910 and 2912. Programs 2906, within a given channel, may be ranked according to, for example, a respective program usage score along program ranking axis 2904. Channels may be ranked according to, for example, a respective channel usage score along channel ranking axis 2902.

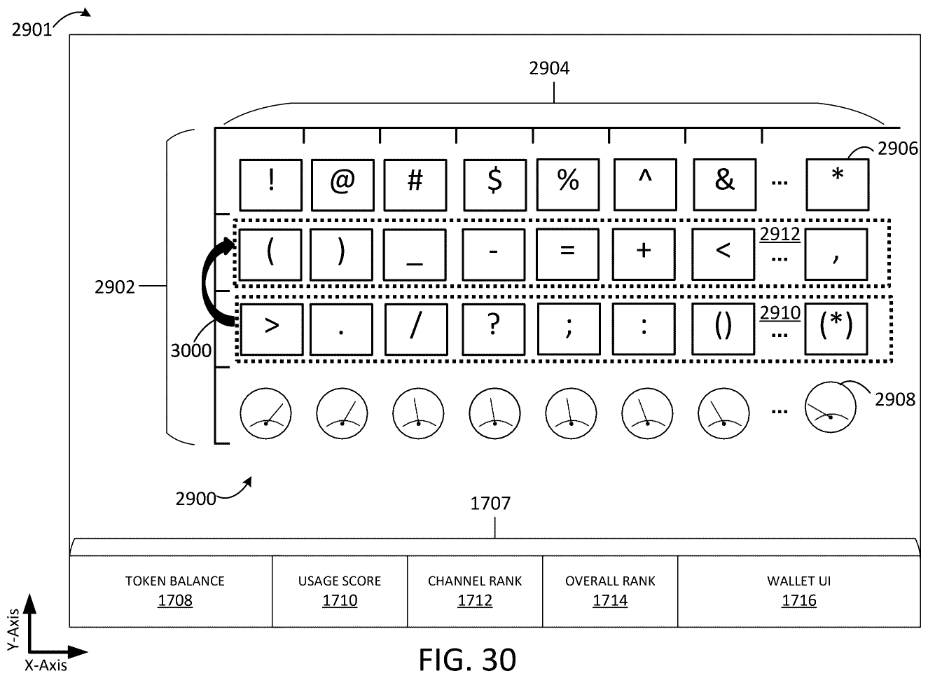

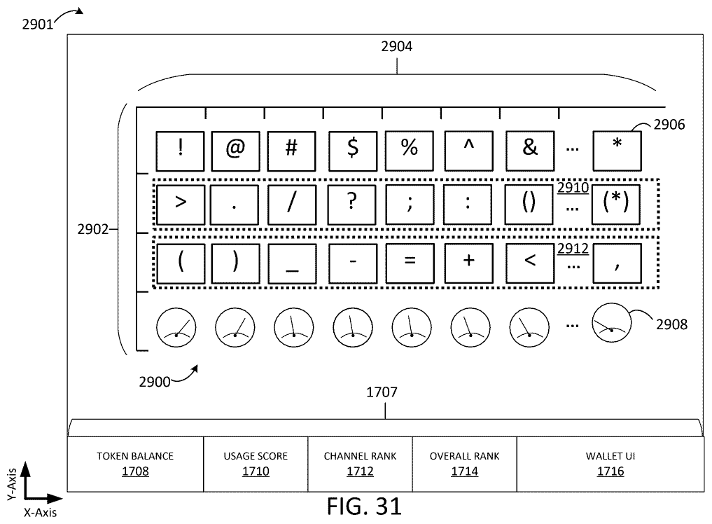

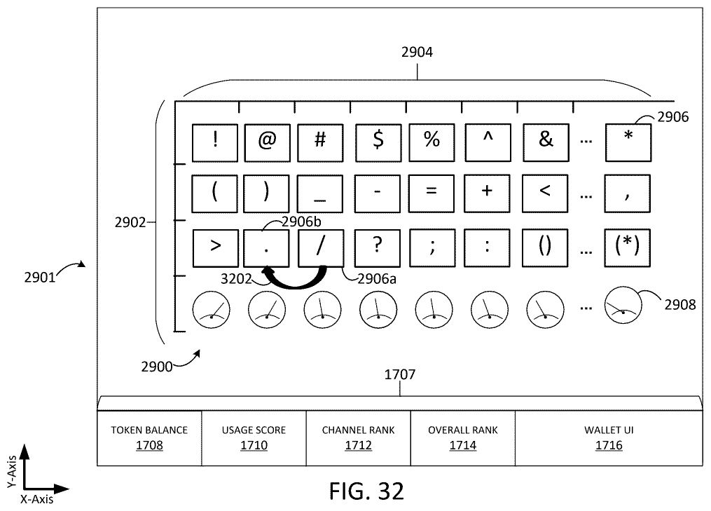

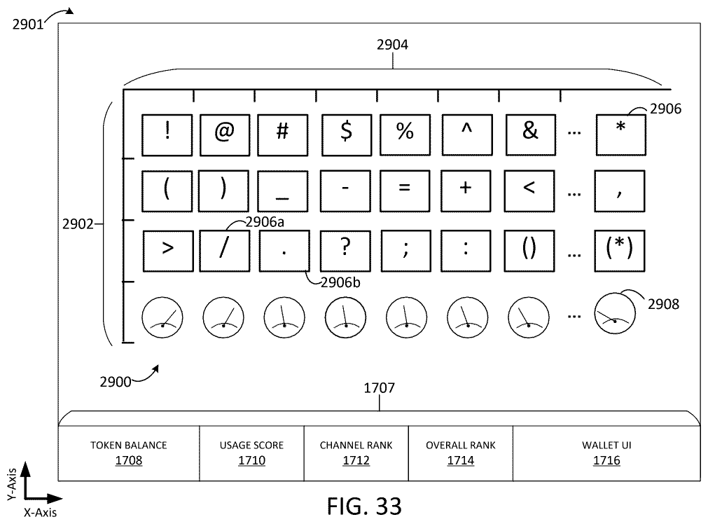

As shown in FIG. 30, animation 3000 shows channel 2910 moving up along the channel ranking axis 2902. As shown in FIG. 31, channel 2910 is now ranked higher than channel 2912. As shown in FIG. 32, program 2906a is moving left, along program ranking axis 2904, to indicate a higher usage score than program 2906b. Animation 3202 may highlight this change in program ranking. As shown in FIG. 33, program 2906a is now ranked higher than program 2906b along axis 2904.

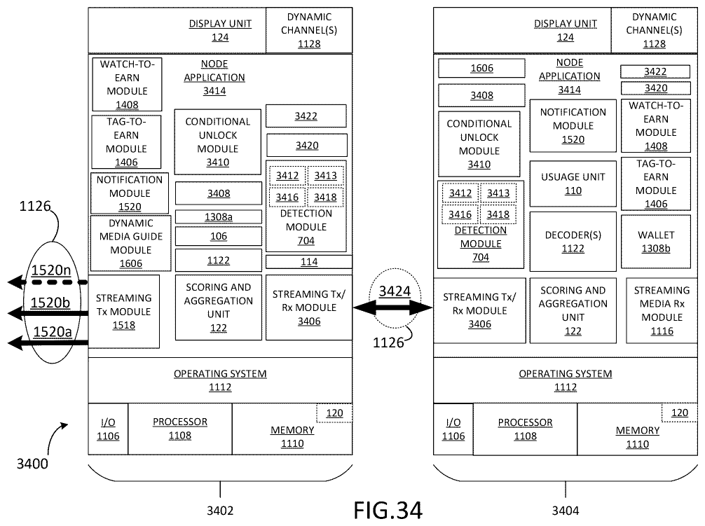

FIG. 34 shows a multimedia content management and packaging system 3400, which includes nodes 3402 and 3404 with node application 3414. Node application includes streaming Tx/Rx module 3406, buffer-to-earn module 3408, conditional unlock module 3410, and share-to-earn module 3422. Detection module 704 may include sports score and time detector 3412, multimedia NFT detector module 3413, song detector module 3416 (e.g., a Shazam® application or the like), and face detector module 3418. Competitiveness score module 3420 may modify, replace, or supplement a usage score in determining, for example, a video program ranking.

Multimedia NFT detector module 3413 (e.g., an NFT-based application) may detect an audio or visual content object within a program of MPTS 3424, particularly if said detected audio or visual content object is associated with an NFT or other unique digital asset that is associated with a wallet. In some embodiments, audio NFTs may represent an individual song or music group, with detections being detecting a particular song or song segment being played as main program content and/or background music of a main program. Visual NFTs may include personality NFTs that are linked to, for example, data clusters of facial detection parameters (e.g., grouped datasets of facial descriptors) for detecting individuals shown in a video program of MPTS 3424. In some embodiments, by tagging shown individuals or confirming detection of shown individuals, facial descriptor datasets and/or cluster values may be expanded and/or refined via user-viewer feedback and triggering rewards or other earnings for the tagging/confirming user-viewer.

In some embodiments, module 704 may apply one or more video content analysis algorithms to a plurality of video programs of MPTS 3424 being transmitted over network 1126 for detecting content objects. In some embodiments, buffer-to-earn module 3408 allows nodes to buffer programs on behalf of neighboring nodes and earn a blockchain currency. In some embodiments, conditional unlock module 3410 may unlock one or more features of dynamic media guide module 1606 depending on, for example, a condition of a digital wallet. In some embodiments, share-to-earn module 3422 tracks a user's shares of content objects and/or programs of the MPTS 3424 and rewards a user in a blockchain currency for said sharing.

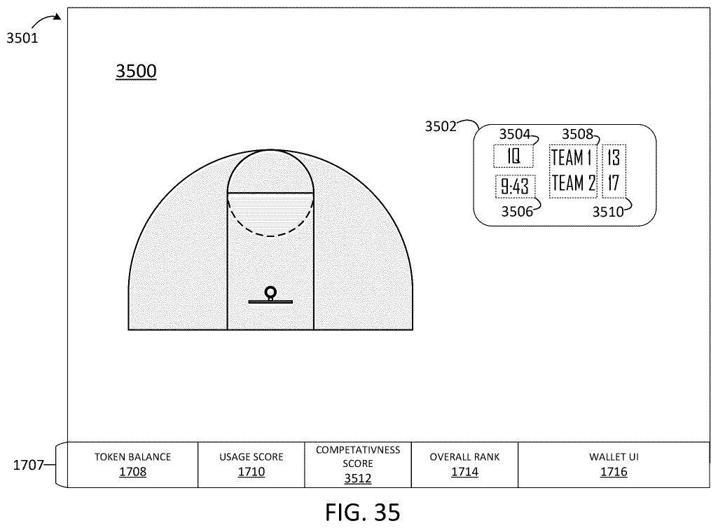

As an example of sports score and time detector 3412 in use, media guide 3501 of FIG. 35 shows sports video program 3500 with informational graphic 3502. In some embodiment, sports score and time detector 3412 can detect information, through image and/or video analysis, such game period information 3504, game time information 3506, team information 3508, and/or game score information 3510. In some embodiments, detector 3412 detects game time information, score information, and team information from a graphic of program 3500.

In some embodiments, a competitiveness score 3512 can be calculated from said information. For example, an embodiment competitiveness score 3512 may use, as a base score, a point differential from information 3510, such as 17−13=4 as the base score. In some embodiments, a base score may be modified by at least one of game period information 3504 and game time information 3506. In one example, a weight between 0 and 1 is provided in relation to how much time is remaining in a game, with, for example, the weight approaching 0 as a game nears the end of regulation (e.g., countdown to 0, last inning, nearing overage time).

In some embodiments, the competitiveness score 3512 is determined by applying a “game time remaining” weight to the point-differential base score. Various sports programs can be ranked strictly by competitiveness score or in combination with usage score 1710. In some embodiments, an overall rank 1714 may be calculated by the usage score being modified by an inverse of competitiveness score 3512 (e.g., a multiplicative inverse): a usage score of “10” being multiplied by “1/0.1” or “10”, which may be the inverse of a “0.1” competitiveness score 3512.

In some embodiments, a reduction in a competitiveness score 3512 represents an increase in competitiveness. Said ranking may be displayed by showing the ranked sports program video in a ranked order as described above. Although the data for competitiveness score 3512 has been described as being extracted via analysis of a video signal, team, score, and game time information can also be obtained via metadata.

Media guide 3601 shows wallet interface 1716a which shows audio NFT 3602, facial recognition NFT 3604, functional NFT 3606, and claim button 3608. Interface 1716a may further shows blockchain currency data associated with the wallet address, including a wallet balance, a staked balance, NFTs, rewards received via NFTs, and session balances from watch-to-earn, tag-to-earn, and share-to-earn. NFTs 3602, 3604, and 3606 may be owned by a wallet and/or the NFTs 3602, 3604, and 3606 may be staked via a staking contract for earning blockchain currency.

Audio NFT 3602 may be an NFT that earns, for a wallet, a blockchain currency (e.g., EAT) when associated audio content is detected in a program. For example, audio NFT 3602 may be associated with a particular song or ensemble such that NFT 3602 earns EAT in response to detecting said song or a song from said ensemble in a program.

Facial recognition NFT 3604 earns, for an associated wallet address, a blockchain currency when an associated face is detected in a video program of, for example, a MPTS. NFT 3604 may represent facial recognition data of a media personality or the like to allow viewers, among others, to earn currency based on said media personality appearing in an MPTS.

Functional NFT 3606 may represent a particular media guide functionality. For example, NFT 3606 may allow for advertisement free displaying of programs of an MPTS and/or displaying one or more active channels. Other functional NFTs 3606 may include a rewards multiplier, decrease of claim fees, NFT rewards multiplier, transmit new programing to the network (e.g., an additional program to the MPTS), among other possibilities.

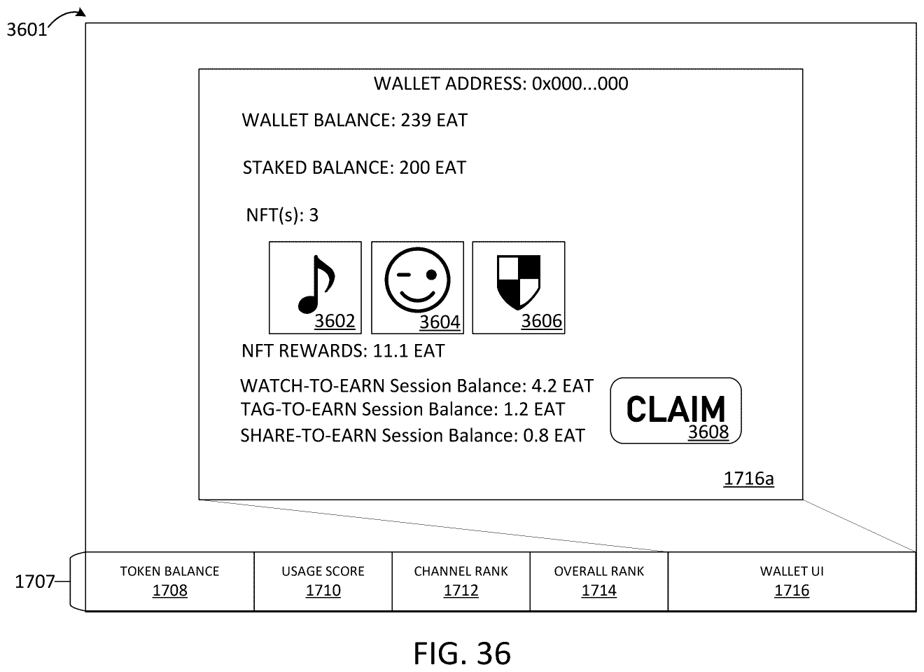

Conditional unlock module 3410 of FIG. 34 may utilize one or more of the wallet data points shown in FIG. 36 to unlock one or more functionalities of a media guide. Claim button 3608 may be a UI element for a user to transfer session balances to a wallet. In some embodiments, claiming may occur without a user manually claiming.

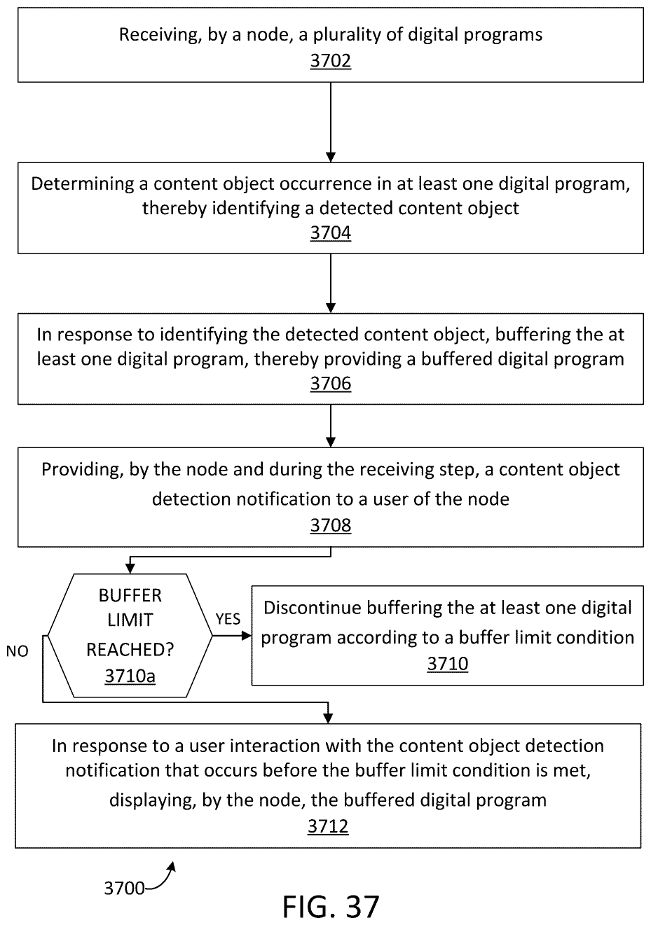

FIG. 37 shows method 3700 for displaying a plurality of programs. At step 3702, a node receives a plurality of digital programs. In some embodiments, the plurality may be a MPTS (e.g., a plurality of video programs) received from another node via an application layer defined overlay network.

Step 3704 includes determining a content object occurrence in at least one digital program, thereby identifying a detected content object. In some embodiments, step 3704 may utilize facial recognition techniques to detect a particular individual (e.g., an individual that a user-view has “followed” and/or asked for notifications for when said individual appears in a video program as shown in, for example, FIG. 20) and said detection may be verified, for example, via further subsequent detections in determining a content object occurrence.

Step 3706 includes in response to identifying the detected content object, buffering the at least one digital program, thereby providing a buffered digital program. The buffered digital program may be of a MPTS and would generally be “missed” unless the user-viewer was watching the program at a particular instance in time (e.g., a live peercast or other livecast or live streamed content).

Step 3708 includes providing, by the node and during the receiving step 3702, a content object detection notification to a user of the node. One example of said notification can be found in FIG. 21 with notifications 2102 and 2104. In some embodiments, step 3708 provides a timestamped notification associated with a time of the buffered program. In some embodiments, said time is approximately (or is) the time that the content object detection step 3704 occurs.

Step 3710a includes determining if a buffer limit has been reached. Step 3710 includes discontinuing buffering the at least one digital program according to a buffer limit condition. The buffer limit condition may be, for example, temporal (e.g., a time limit) or a particular amount of buffered data (e.g., 1 GB). In some examples, neighboring nodes may “buffer-to-earn” to extend a buffer limit of a buffering node. In some examples, a user may be given an option to pay, in a blockchain currency, to access the surplus buffered program material provided by neighboring nodes after the local, user node reached a buffer limit.

In response to a user interaction with the content object detection notification that occurs before the buffer limit condition is met, step 3712 includes displaying the buffered digital program.

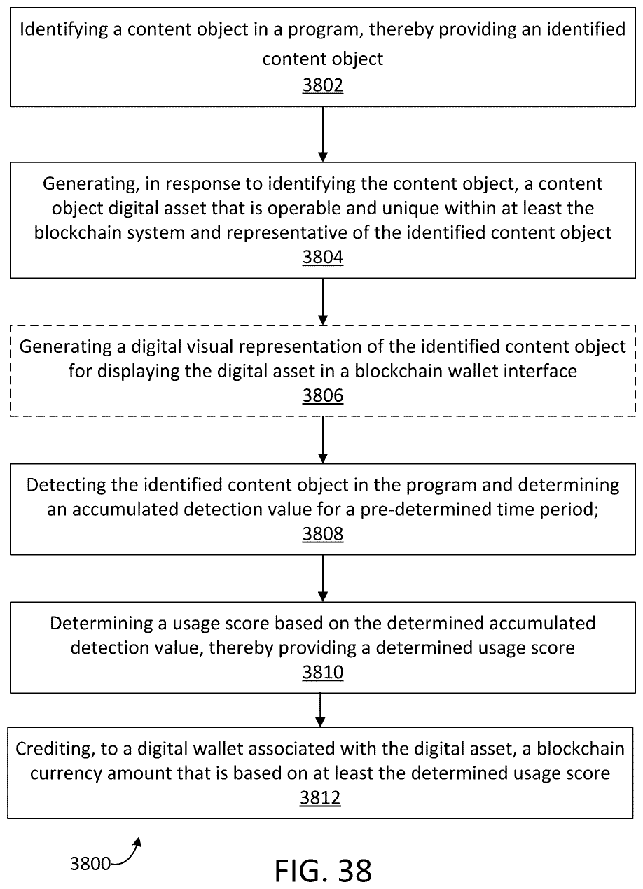

FIG. 38 shows method 3800 for a multimedia blockchain system. Step 3802 includes identifying a content object in at least one of a digital audio program, a digital video program, and a digital multimedia program, the content object being identified by analyzing at least one of content object voice data, content object image data, content object facial parameter data, content object digital video data, and content object digital audio data, thereby providing an identified content object. In some embodiments, step 3802 may utilize video content analysis (e.g., facial recognition techniques) for identifying a content object.

In some embodiments, content object data comprises or represents data clusters of one or more descriptors of content objects, which may be updated and further populated from multimedia program data. For example, said data clusters may populate content data storage unit 120 for identifying one or more facial features. As a consequence of a user-viewer tagging to earn, for example, datasets and/or data clusters may be expanded upon or otherwise updated based on a user providing input that an identified content object is correct or by manually tagging a content object by typing a name or entering an other identifier.

Step 3804 includes generating, in response to identifying the content object, a content object digital asset that is operable and unique within at least the blockchain system and representative of the identified content object. In some embodiments, step 3804 may be done automatically. Alternatively, a user may manually input an identified content object (e.g., a picture, a song, a video clip) into an NFT generator (e.g., an image generation engine comprising one or more image processors) for creating the content object digital asset (e.g., a unique image generated by an imputed image of a detected content object).

In some embodiments, the content object digital asset includes an NFT with metadata. In some embodiments, the NFT metadata may comprise unique identification data, unique class identification data, and/or image data such as generative image data based on an image of the identified content object. In some embodiments, the NFT metadata includes identification information that ties the identified content object to the NFT (e.g., a content object ID). In some embodiments, metadata includes data fields for controlling functionalities such as allowing ad-free viewing and/or earning currency based on one or more detections of the identified content object in a streamed video.

Optional step 3806 includes generating a digital visual representation of the identified content object for displaying the digital asset in a blockchain wallet interface. In some embodiments, the generating step 3806 includes receiving the content object itself (e.g., a picture of a media personality) and/or descriptor data of the content object (e.g., facial recognition data) as a basis for generating, via algorithms, image engines, or other process, the visual representation. In some embodiments, an image engine generates unique digital visual representations for each NFT based on an image input (e.g., a digital image depicting an identified content object).

Step 3808 includes detecting the identified content object in the at least one digital audio program, digital video program, and digital multimedia program and determining an accumulated detection value for the identified content object that represents a number of detections during a pre-determined time period. In some embodiments, the digital asset represents a facial recognition by video content analysis and step 3808 includes detecting, by facial recognition, the identified content object in the plurality of digital video programs, thereby identifying human individuals as the identified detected content objects.

Step 3810 includes determining a usage score based on the determined accumulated detection value, thereby providing a determined usage score. Step 3812 includes crediting, to a digital wallet associated with the digital asset, a blockchain currency amount that is based on at least the determined usage score. In some embodiments, the content object digital asset is a non-fungible token.

In some embodiments, the crediting step 3812 includes transferring, via a blockchain transaction, a blockchain currency (e.g., a cryptocurrency) to the digital wallet. In some embodiments, the crediting step 3812 may include a re-basing of the currency, reflections, and/or other techniques that increase the numerical number (quantity) of a cryptocurrency balance of a digital wallet. In some embodiments, step 3812 accumulates, via a smart contract, a claimable amount that only the digital wallet can claim. In response to a wallet owner claiming an accumulated balance (e.g., a user viewer interaction with claim button 3608 of FIG. 36), said balance is then credited to the digital wallet address.

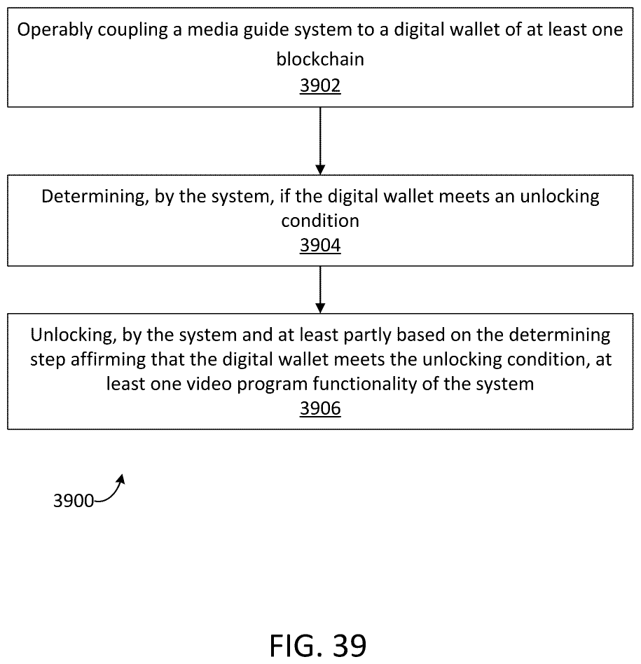

FIG. 39 shows method 3900 of operation of a media guide system. Step 3902 includes operably coupling the system to a digital wallet of at least one blockchain. Operable coupling examples include a wallet or user-viewer providing a wallet address to the media guide system (e.g., an application running on a user equipment and/or a plugin of said application) and/or performing a signature via a digital wallet.

Step 3904 includes determining, by the system, if the digital wallet meets an unlocking condition. In some embodiments, step 3904 may be performed by conditional unlock module 3410. Unlocking conditions may be the presence of a type or number of NFTs, a type or balance of a blockchain currency of a wallet, a combination of NFT and currency requirements, a staked or unstaked condition of an NFT or currency, the amount of staked NFT and/or currency among other examples.

Step 3906 includes unlocking, by the system and at least partly based on the determining step affirming that the digital wallet meets the unlocking condition, at least one video program functionality of the system. Unlocked functionalities may be basic playback functionality, access to one or more programs, advertisement free playback by a player, allowing previously blocked programs of a MPTS to be decoded on a node associated with the wallet, display of active channel(s), and/or the use of any functionality such that a viewer/user cannot view any program of an MPTS or other audio or video stream without at least a minimum balance of a relevant blockchain currency, among other examples.

For example, the ability to encode and/or transmit program data as a “first” or “server” source of program data to share with the network as an “added” program to the MPTS (and not merely forward along a received MPTS) may require one or more functional NFTs and/or minimum balances on an associated wallet.

In some embodiments, an unlocking condition may be establishing an operable coupling with a wallet and media guide system (e.g., successfully performing step 3902). For example, watch-to-earn and tag-to-earn applications may require a connected wallet for modules 1406 and 1408 to be operable by a user-viewer. In some embodiments, earning rates are adjusted depending on the one or more states of a media guide player and/or a user device that is running the media guide player application. For example, muting a main presenting program (of an MPTS) may lower the watch-to-earn rate. Allowing access to a user device camera may raise a watch-to-earn rate for verifying that a user is actually viewing and/or listening to a program.

In some embodiments, earning rates for watch-to-earn and tag-to-earn may vary by program. For example, advertising may pay higher rates than main programing and even variation among programs, when in a program a user starts viewing, and/or under what conditions (e.g., number of node viewers; competitiveness score).

In some embodiments, allotments for watch-to-earn tokens or other blockchain currency may be provided on a program and/or time basis (hourly, every half hour). That is, a fixed pool of a blockchain currency is allotted to be shared amongst the viewer-users that are watching (watch-to-earn), tagging (tag-to-earn), and/or buffering (buffer-to-earn).

In some embodiments, watch-to-earn rates may be contingent upon one or more settings of a node application (e.g., node application 3414) and/or a node (e.g., node 3402). For example, muting a program may reduce a watch-to-earn rate. In some embodiments, “muting” may be detected with “muting” and/or lowering a program's volume below a threshold.

In some embodiments, allowing access to a camera or microphone of a node for verification by the node application regarding a user-viewer being actively engaged with program content. In some embodiments, a camera may be a broadband imaging camera and/or a narrowband (e.g., infrared) camera for monitoring if a user-viewer is near a display. In some embodiments, a microphone may be detecting if multiple programs are being played at once and/or a minimum playback volume is being met for determining a watch-to-earn rate for a node.

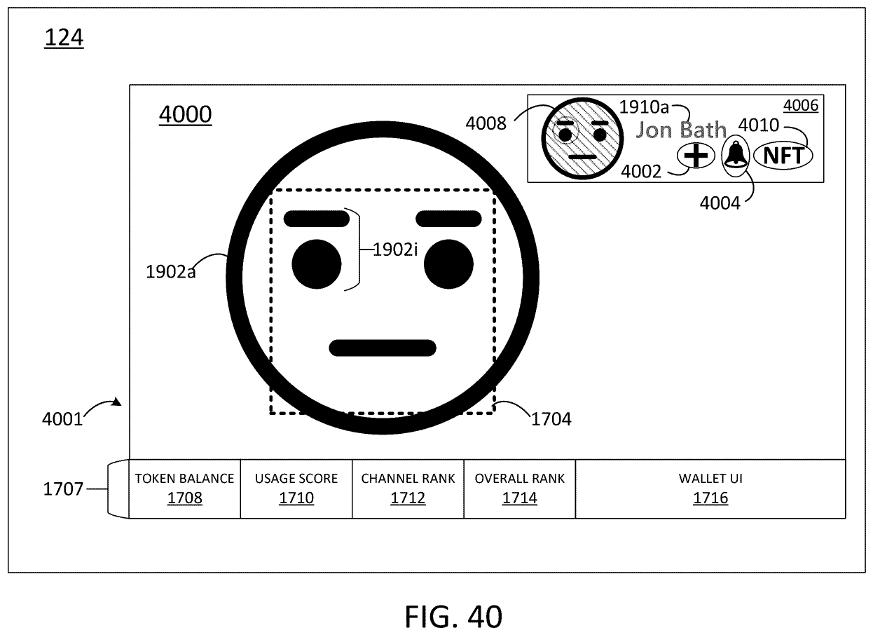

FIG. 40 shows media guide 4001, which shows main program 4000 with an overlayed graphic ID 4006, which shows NFT image 4008, plus icon 4002, bell icon 4004, and NFT icon 4010. NFT image 4008 is an image associated with a detected content object of main program 4000. In FIG. 40, the detected content object is person 1902a, “Jon Bath”. In some embodiments, NFT image 4008 may represent the image data stored on a distributed ledger according to a token standard (e.g., ERC-721 or ERC-1155). Additionally or alternatively, NFT image and/or video data may be stored “off-chain” in servers and/or nodes. In some embodiments, NFT metadata that is stored “on-chain” includes hash value data for image, audio, and/or multimedia data that is stored in off-chain storage.

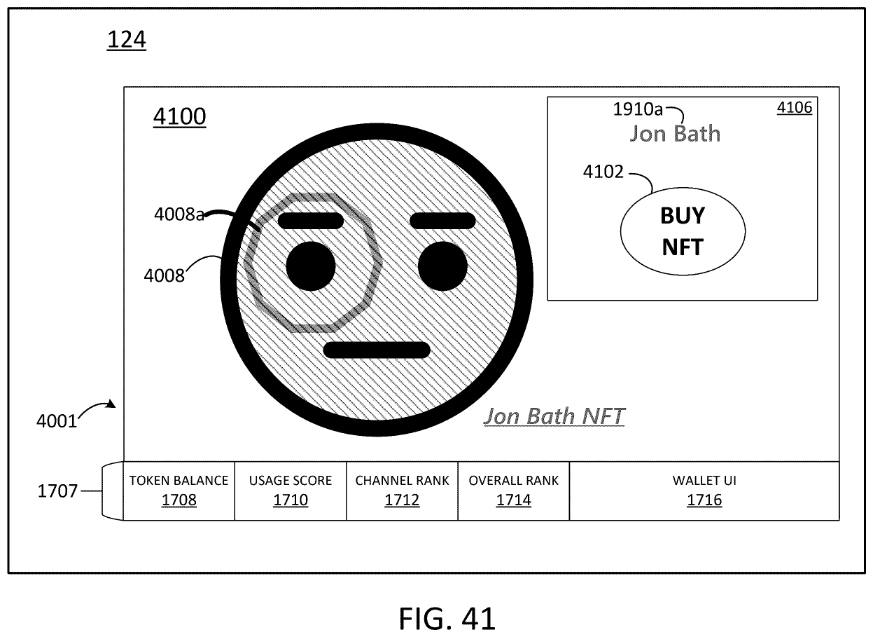

However NFT image 4008 is stored, guide 4001 presents a user-viewer the NFT image 4008 associated with detected person 1902a. As shown in FIG. 41, marketplace presentation 4100 shows NFT image 4008 with an NFT graphic 4008a, shown as a dodecagon that surrounds an eye feature 1902i. In some embodiments, NFT graphic 4008a may be based on VCA techniques including edge detection and facial recognition and generate parameter data (e.g., detected edges and/or facial features) that is visually highlighted in a content object image by an imagine engine utilizing, for example, image processing techniques such as filters and applying other image transform functions to the content object image for generating an NFT image. In this example, NFT graphic 4008a may represent an eye or facial detection data and may be generated based on at least said data.

In some embodiments, NFT image 4008 may generally show a previously identified personality with one or more NFT graphics 4008a. In some embodiments, the generated image of NFT image 4008 is unique due to the combination of the underlying content object image data and the NFT graphic(s) 4008a.

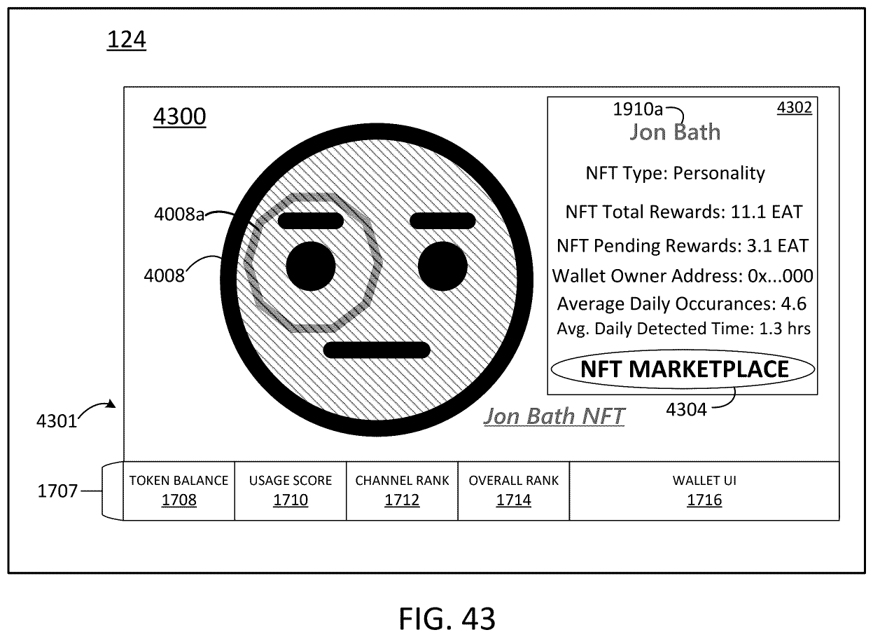

Returning to FIG. 40, NFT icon 4010 may include an active link to, for example, an NFT marketplace (e.g., marketplace presentation 4100) and/or other NFT presentations such as a data presentation (e.g., data presentation 4300 of FIG. 43). Presentations 4100 and 4300 may be presented within a media guide or as an external presentation (e.g., as a separate tab within a web browser (e.g., Firefox, Chrome, Brave, Edge)).

Returning to FIG. 41, interactive area 4106 may display identified name 1910a and a purchase icon 4102, which would initiate a purchase or bid, for example, for the NFT represented by NFT image 4008.

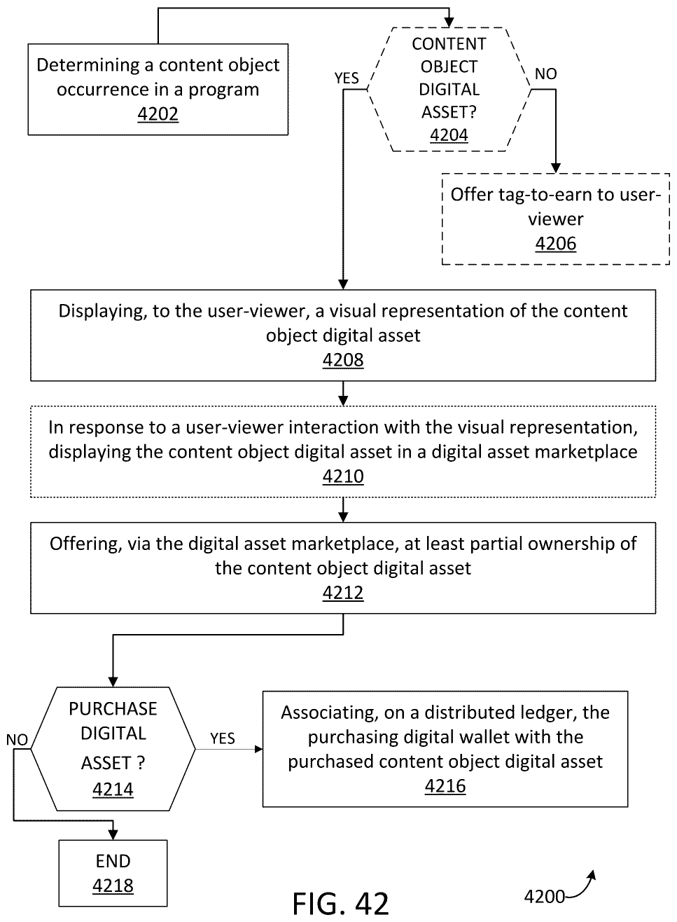

FIG. 42 shows method 4200 for a multimedia distributed ledger system. At step 4202, a content object occurrence is determined in a program. In some embodiments, a content object occurrence is determined by one or more content object detections. In some embodiments, an “occurrence” may be determined based on a plurality of content objection detections within a time subperiod. In some embodiments, a recent detection list is populated, refreshed, and checked to determine if a threshold number of detections for a particular content object is reflected in the recent detection list and thereby determining the content object occurrence. In some embodiments, each further detection added to the recent detection list that is above a threshold number may be determined as an occurrence.

One inventive feature is providing accurate and timely content object occurrence notifications to a user-viewer across, for example, multiple video program streams based on a plurality of content object detections for each respective stream.

At step 4204, method 4200 determines if the content object is associated with a content object digital asset. If not, method 4200 may offer tag-to-earn to a user-viewer at step 4206. In some embodiments, in response to a user-viewer tagging a content object (e.g., a media personality; famous animal; song title and performer), an NFT may be generated that is associated with the tagged content object. In some embodiments, a user-viewer is provided with one or more social media accounts via, for example, social media API 4424, for tagging an individual.

At step 4208, a visual representation of the content object digital asset is displayed to a user-viewer. Displaying may include graphic ID overlays onto a video stream. In some embodiments, a further displaying step 4210 may include displaying, in response to a user-viewer interaction with the visual representation of step 4208, the content object digital asset in a digital asset marketplace (e.g., OpenSea, Unifty, Rarible). Step 4212 may include offering, via the digital asset marketplace, at least partial ownership of the content object digital asset. Ownership may be wholly transferred into a single “owner” wallet or shared among multiple wallets. Shared ownership may include, for example, proportionate shares in accumulated cryptocurrency generated by and in relation to a number of determined content object detections over a given time period.

Depending on step 4214, method 4200 may, at step 4216, associate, on a distributed digital ledger, a digital wallet with the purchased content object digital asset. In some embodiments, a smart contract or interface thereof facilitates said association. At step 4218, method 4200 may end.

FIG. 43 shows media guide 4301 with NFT presentation 4300, which may include data card graphic 4302, which shows identified name 1910a, NFT Type, NFT Total Rewards, NFT Pending Rewards, Wallet Owner Address, Average Daily Occurrences, Average Daily Detected Time. Data card graphic 4302 may further provide NFT icon 4304 for an NFT marketplace URL or the like.

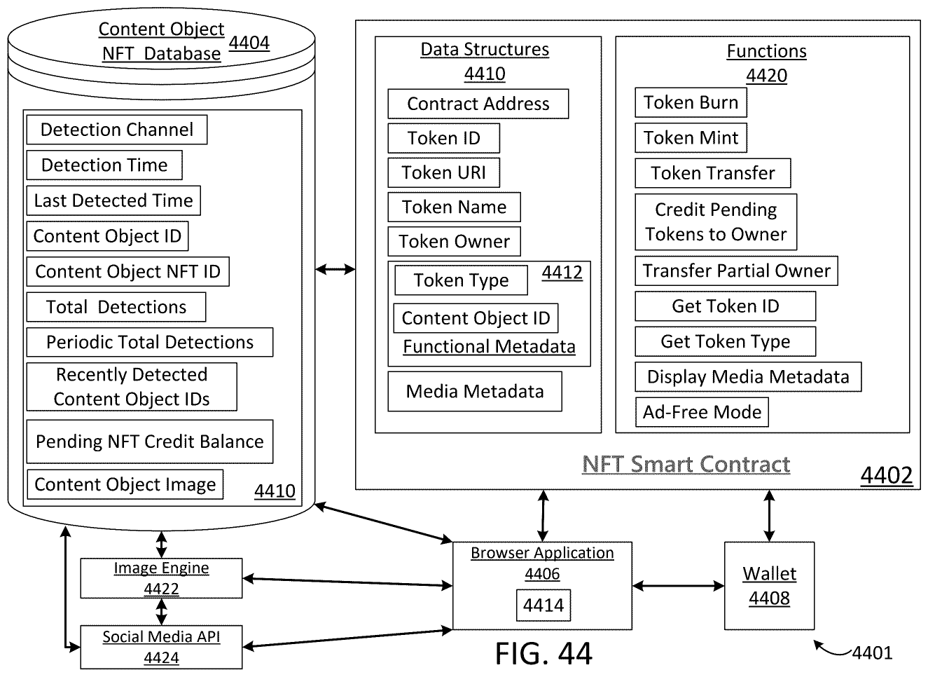

FIG. 44 shows multimedia distributed ledger system 4401, which may include NFT smart contract 4402, content object NFT database 4404, browser application 4406, wallet 4408, image engine 4422, and social media API 4424. Browser application 4406 may include application 4414 and/or one or more modules thereof (e.g., modules implemented as a plug-in). In some embodiments, application 4414 may receive a video stream and/or other media stream from a content delivery network (CDN), which may be a server, in addition or alternatively to receiving a MPTS from an overlay network. In some embodiments, application 4414 may be a node application.

Contract 4402 may have fields for or otherwise process data structures 4410 such as a smart contract address, a token ID, a token URI, which is generally a reference to associated NFT data (e.g., image or video data associated with the token ID), a token name, a token owner (e.g., a wallet address), functional metadata 4412 such as token type (e.g., ad-blocker, content object, personality, transmission allowance) and content object ID, and media metadata (e.g., an image) that may be stored on-chain.

In some embodiments, an NFT is uniquely identified by the combination of a contract address and token ID. In some embodiments, functional metadata 4412 may enable, disable, or otherwise modify one or more functionalities of application 4414, including functionalities related to the playback of video content and/or monetization thereof.

Contract 4420 may include functions such as token burn (e.g., “destroy” an NFT by sending it to a wallet address that is generally inaccessible (e.g., 0x . . . 0000 and 0x . . . dead)), token mint (e.g., create an NFT), token transfer between wallets, credit pending tokens to an NFT owner's wallet, get the token ID, get the token type, display the media metadata, and/or toggle an ad-free mode setting.

Content object NFT database 4404 may have data structures 4410 (e.g., database field formats) or otherwise process and/or store data related to detections of associated content objects in a program presentation such as an detection channel, detection time, last detection time, ID information of a detected content object (e.g., a content object ID associated with one or more VCA descriptors), a content object NFT ID, recently detected content object IDs, pending NFT credit balance, and/or a content object image (e.g., an image of a content object (e.g., a facial image) or a reference thereto (e.g., a URL to a content object image)).

In some embodiments, total detections may reflect a historical accumulated number of detections. In some embodiments, periodic total detections reflect a number of detections over an hourly, daily, or other time period (e.g., 1 to 24 hours) that is refreshed after said time period. In some embodiments, fungible digital assets and/or NFTs may be earned (e.g., increase a credit balance) based on the periodic total detections of a content object that is associated with an NFT.

In some embodiments, content object IDs of recent detections may be periodically updated in real or near-real time in database 4404 to reflect a raw number of content object detections. In some embodiments, recently detected content object IDs is a list with a fixed number of entries (e.g., 3 to 15 content object IDs). In some embodiments, an occurrence is at least partially determined if a content object ID is entered multiple times (e.g., a content ID appearing two or more times in a fixed data structure (e.g., a fixed array or buffer) may result in a determined occurrence).

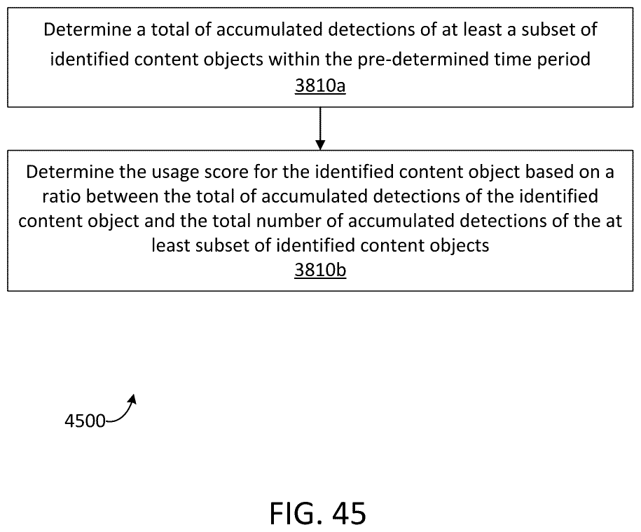

FIG. 45 shows method 4500 for determining a relative usage score. Step 3810a includes determining a total of accumulated detections of at least a subset of identified content objects. In some embodiments, the subset may be restricted to identified content objects that are associated with an NFT. In some embodiments, the subset may be restricted by requiring a minimum number of detections of a content object. In some embodiments, the pre-determined time period is 24 hours.

Step 3810b includes determining the usage score for the identified content object based on a ratio between the cumulative detections of the identified content object and, for example, the sum of cumulative detections of the at least subset of identified content objects. For example, a given identified content object may have been detected 10 times over a time period and the at least subset has a cumulative detection sum of 100 over the same time period. In such cases, in some embodiments, an associated wallet and/or NFT is credited, directly to a wallet or as a pending credit to be claimed, one-tenth of the daily rewards pool, typically comprising a pool of one or more digital assets (e.g., a pool of one or more cryptocurrencies, NFTs, and the like).

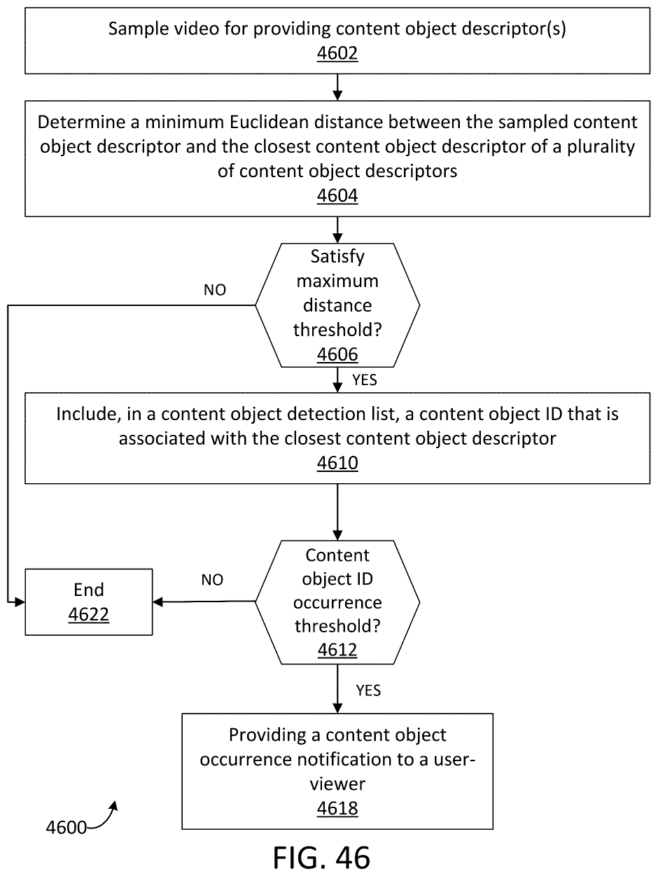

FIG. 46 shows method 4600 for determining an occurrence of a pre-identified content object in a digital video. Step 4602 includes sampling a video stream for content object descriptors. In some embodiments, sampling rates may be at least one frame per second. In some embodiments, content object descriptors may include facial descriptors. In some embodiments, content object descriptors may include a plurality of descriptors such as those related to facial detection and character recognition of on-screen text and/or closed captions data (e.g., subtitles). In some embodiments, a face detection model samples facial descriptors for each detected face. In some embodiments, the face detection model generates vector values as the facial descriptors.

Step 4604 includes determining a minimum Euclidean distance between the sampled content object descriptor and the closest content object descriptor of a plurality of content object descriptors. In some embodiments, the plurality of content object descriptors may be clustered facial descriptors of previously identified individuals. In some embodiments, step 4604 includes calculating a squared Euclidean distance between the sampled content object descriptor and the closest descriptor of a plurality of descriptors.

Step 4606 includes applying at least one threshold to the determined minimum Euclidean distance of step 4604. Step 4606 may include a maximum threshold such that distance values determined by step 4604 that are below (or, in some embodiments, below or equal to) the maximum threshold value are processed as a positive identification of a pre-identified content object. If a determined distance value is above (or, in some embodiments, above or equal to) the maximum threshold value, method 4600 may end 4622, at least with respect to further steps related to those particular content object descriptor samples. In some embodiment, step 4602 is continuously occurring on a video stream independently of any end step 4622 that is reached in example embodiments, thereby continuously providing, in real-time or near real-time, content object descriptor samples of a video.

Step 4610 includes adding, to a content object detection list, a content object ID that is associated with the closest content object descriptor. In some embodiments, a content object ID is associated with a cluster of detected features for identifying a particular content object. Step 4612 includes determining if a content object ID has been detected at least a minimum number of times to meet an occurrence threshold. If not, method 4600 may end 4622.

In some embodiments, if a content object ID occurs at least two (or more) times on the list, an occurrence of the content object ID has been determined, and step 4618 includes providing a content object occurrence notification to a user viewer. In some embodiments, a recent detection list of content object IDs with a fixed maximum number of entries (e.g., 10 to 20 content object IDs) is updated in real time or near-real time. In some embodiments, a content object ID must appear at least three times on a recent detection list before a content object occurrence (vs. a mere detection) has been determined.

In some embodiments, the recent detection list is updated based on a content object sampling rate (e.g., newly detected content object IDs are provided every second or a period thereof (e.g., 2 to 5 seconds)). In some embodiments, a recent detection list provides a list of content IDs in an order related to their relative detection times (e.g., a list of 10 content object IDs are the last 10 content objects that were detected).

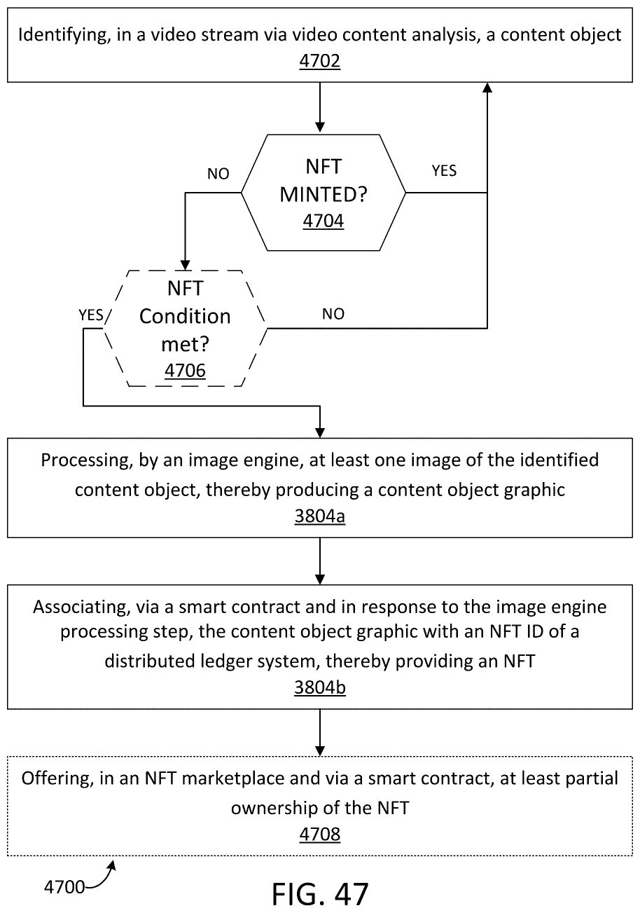

FIG. 47 shows method 4700 for generating content object NFTs. Step 4702 includes identifying, in a video stream and utilizing video content analysis (VCA), a content object. Step 4704 includes determining if an NFT associated with the identified content object has already been created or “minted”. If so, method 4700 may return to step 4702. In some embodiments, step 4702 is continuously being performed regardless of the determination made by step 4704 (e.g., steps 4702 and 4704 may be performed in parallel). If not, step 4706 may check if a content object has met a particular condition such as being identified a minimum number of times, identify confirmation by one or more user-viewers, minimum number or data size of content object descriptors, among other examples. If the condition is not met, method 4700 may return to step 4702.

At step 3804a, an image engine (e.g., image engine 4422) processes at least one image of the identified content object, thereby producing a content object graphic. Step 3804b includes utilizing a smart contract to associate the content object graphic with an NFT ID of a distributed ledger system. In some embodiments, the NFT ID is a smart contract address and a token ID. Step 4708 may include offering at least partial ownership of the newly created NFT in an NFT marketplace.

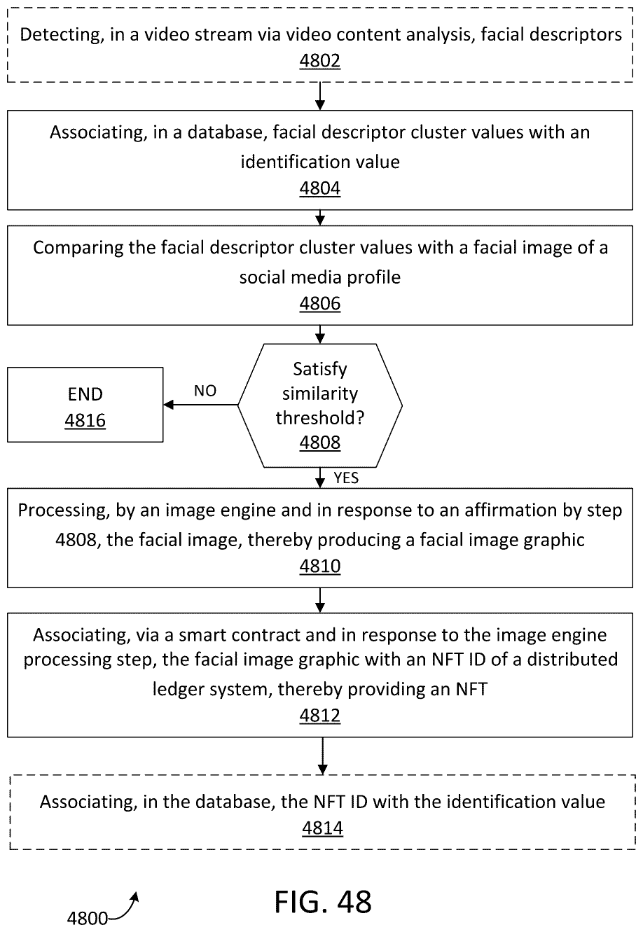

FIG. 48 shows method 4800 for generating an NFT. Step 4802 includes detecting, by video content analysis of a video stream, facial descriptors. Step 4804 includes associating, in a database, the facial descriptor cluster values with an identification value. In some embodiments, the identification value may represent a particular individual. Step 4806 includes comparing the detected facial descriptors with a facial image of a social media profile. In some embodiments, the profile may be of the particular individual associated with the identification value. Step 4808 includes determining if the results of the comparison step of 4806 satisfies a similarity threshold such as minimum distance between a facial descriptor of the facial image and a facial descriptor cluster value. If not, method 4800 may reach an end step 4816 with respect to a particular facial image. In some embodiments, method 4800 may select further facial images for step 4806.

If the similarity threshold is satisfied, step 4810 my process, in response to step 4808, the facial image utilizing one or more transforms and/or style transfers (e.g., a neural style transfer), thereby producing a facial image graphic. An example method is provided in FIG. 51. Step 4812 includes associating, via a smart contract and in response to the image engine processing step 4810, the facial image graphic with an NFT ID of a distributed ledger system (e.g., a blockchain system), thereby providing an NFT. Optional step 4814 includes associating, in a database (e.g., an NFT database), the NFT ID with the identification value. Thus, in some embodiments, the NFT minted by step 4812 is associated with an individual that is represented by the identification value.

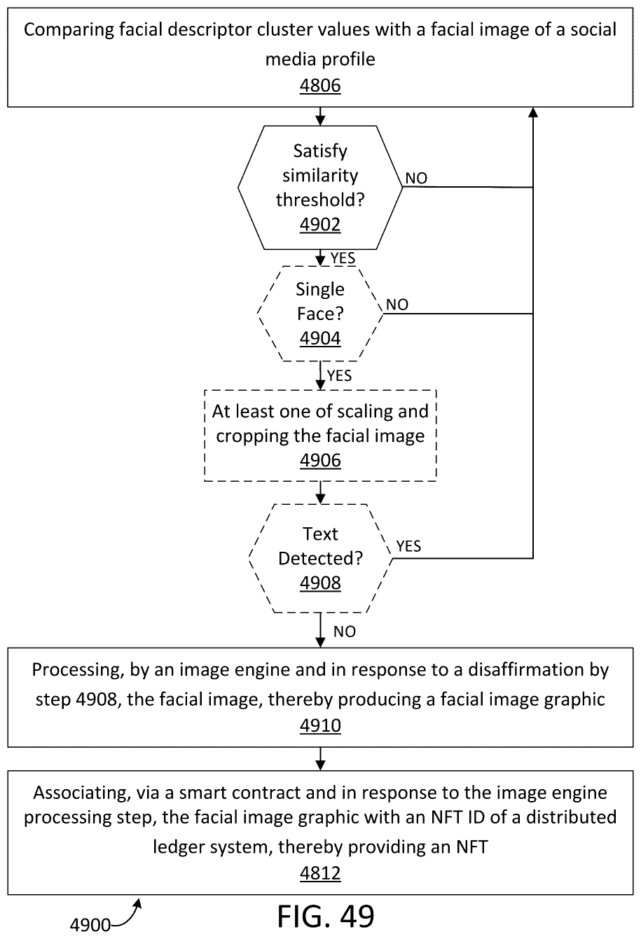

FIG. 49 shows method 4900 for generating an NFT. Step 4902 includes determining if the results of the comparison step of 4806 satisfy a similarity threshold such as minimum distance between a facial descriptor of the facial image and a facial descriptor cluster value. If not, method 4900 may select a further facial image for step 4806. Step 4904 may determine if only a single face is shown in the facial image. If not, method 4900 may return to step 4806 for a further facial image. If so, step 4906 may scale and/or crop the facial image. These steps may provide relatively uniform facial images. Step 4908 may apply text recognition to determine if the facial image includes text. In some embodiments, method 4900 returns to step 4806 for comparing a further facial image with one or more facial descriptor cluster values.

Step 4910 includes processing, in response to not detecting text, the facial image, thereby producing a facial image graphic. Method 4900 may then advance to step 4812.

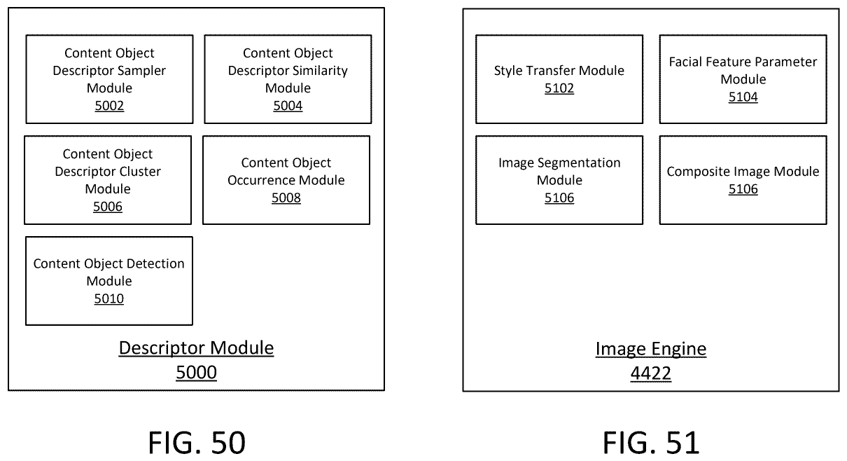

FIG. 50 shows descriptor module 5000 including content object descriptor sampler module 5002, similarity module 5004, cluster module 5006, occurrence module 5008, and detection module 5010. In some embodiments, sampler module 5002 may sample one or more descriptors at a given frame rate or sampling period (e.g., every second). In some embodiments, similarity module 5004 may calculate similarity scores between, for example, sampled content object descriptors and content object cluster values (e.g., cluster radius, cluster center/average (mean and/or median), a descriptor closest to a cluster average, a descriptor farthest away (e.g., a Euclidian distance) from the cluster average).

Content object descriptor cluster module 5006 may calculate and/or cause to store a plurality of content object cluster values. In some embodiments, a cluster value may be a descriptor of a cluster, such as descriptors that are closest and/or farthest away from a cluster center. In some embodiments, a cluster value may be characteristics of a cluster such as an average or center of a cluster and/or a cluster radius.

Content object occurrence module 5008 determines if a content object has been detected a sufficient number of times and/or meets other occurrence thresholds (e.g., multiple facial detection plus on-screen character recognition of the media-exposed personality's name that confirms the facial detections). Content object detection module 5010 detects content objects within a program presentation. In some embodiments, module 5010 includes a face detection module that provides facial descriptors for sampler module 5002.

FIG. 51 shows image engine 4422, which includes style transfer module 5102, facial feature parameter module 5104, image segmentation module 5106, and composite image module 5106. In some embodiments, module 5102 transfers a style from a source image to an NFT image. In some embodiments, module 5102 applies neural style transfer techniques.

Facial feature parameter module 5104 obtains, for example, facial key points from image data. In some embodiments, the facial key points serve as a basis for image segmentation module 5106 to segment an image. In some embodiments, a different style transfer is applied for each image segment. Composite image module 5106 may receive a plurality of stylized images and generate a composite image of said stylized images. In some embodiments, the composite image is stylized differently in each image segment of the composite image.

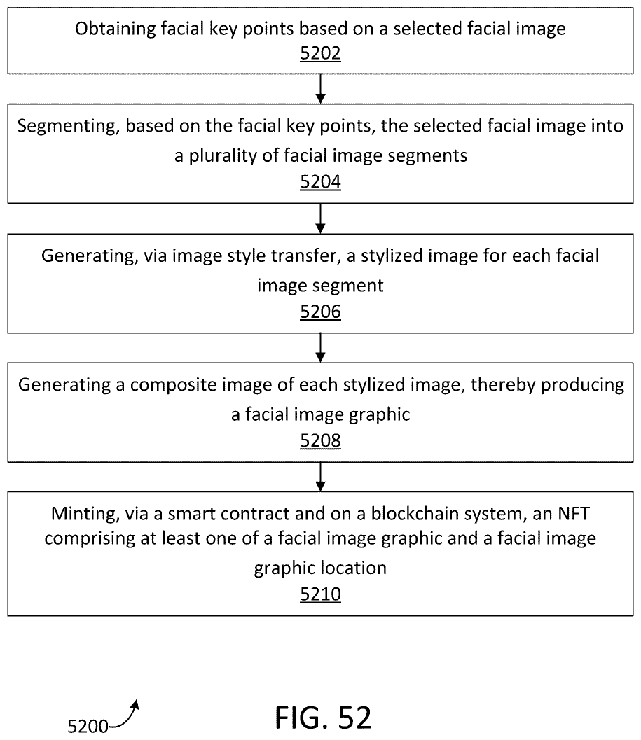

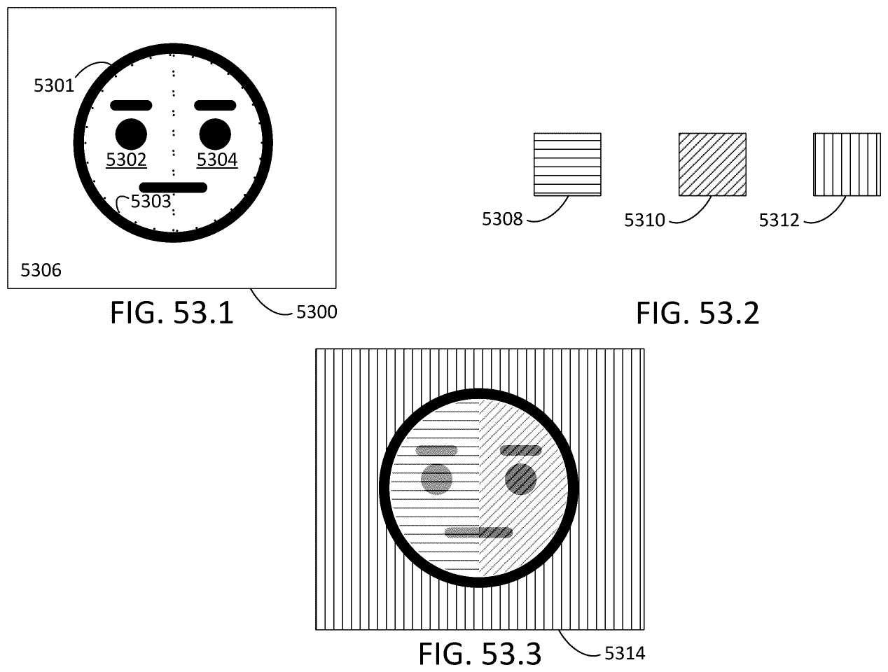

FIG. 52 shows a method 5200 for generating an NFT. FIGS. 53.1, 53.2, and 53.3 show example images 5300, 5308, 5310, 5312, and 5314 that may be processed and/or generated by method 5200. Step 5202 includes obtaining facial key points based on a selected facial image. Step 5204 includes segmenting, based on the facial key points, the selected facial image into a plurality of facial image segments (e.g., performing image segmentation). For example, selected image 5300 of FIG. 53.1 depicts face 5301 with key points 5303 outlining a face or head area and dividing face 5301 into a left facial section 5302, a right facial section 5304. In some embodiments, background section 5306 may be the area outside of outermost key points. Selected image 5300 has been segmented into three sections although fewer or more segments are possible. In some embodiments, image segments are distinct, possibly non-overlapping areas of an image.

Step 5206 includes generating, via image style transfer, a stylized image for each facial image segment. In some embodiments, the image style transfer step 5206 includes a neural style transfer using a respective source style image for each image segment. For example, FIG. 53.2 shows a respective style source image 5308, 5310, and 5312 for left facial section 5302, right facial section 5304, and background section 5306.

Step 5208 includes generating a composite image of each stylized image, thereby producing a facial image graphic, with an example composite image 5314 shown in FIG. 53.3. Step 5210 includes minting, via a smart contract and on a blockchain system, an NFT comprising at least one of a facial image graphic and a facial image graphic location. In some embodiments, NFT metadata may store the facial image graphic on-chain. Alternatively or additionally, NFT metadata may store an address (URL, URI) to where, off-chain, the facial image graphic is stored.

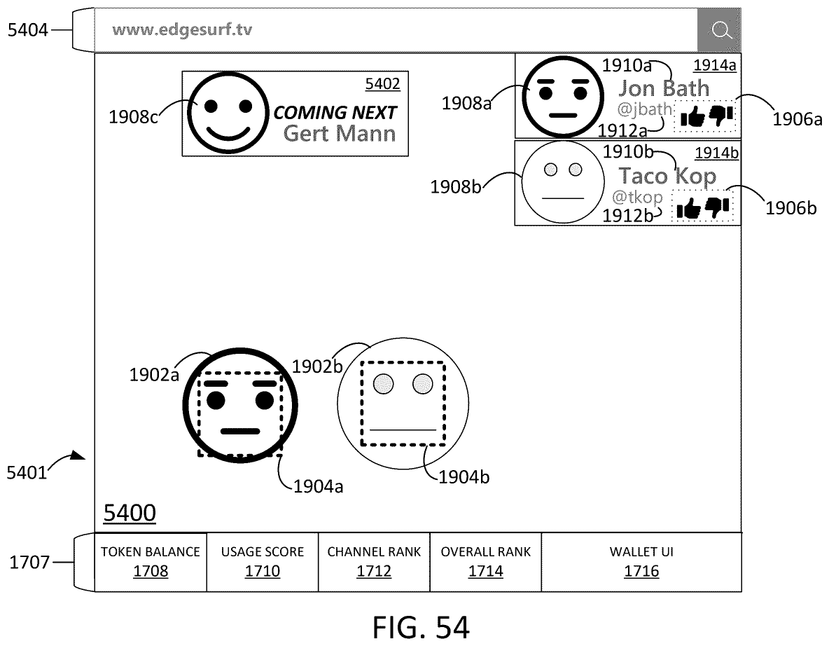

FIG. 54 shows media guide 5401 with main program 5400, coming next notification 5402, and address bar 5404. Graphic IDs 1914a and 1914b respectively identify people 1902a and 1902b. Notification 5402, in some embodiments, is shown based on a facial detection or occurrence by an upstream node and/or server, which may be receiving a stream slightly ahead of an overlay network node. In some embodiments, an upstream server may transmit graphic IDs, “coming next”, and other identifications to one or more nodes of an overlay network.

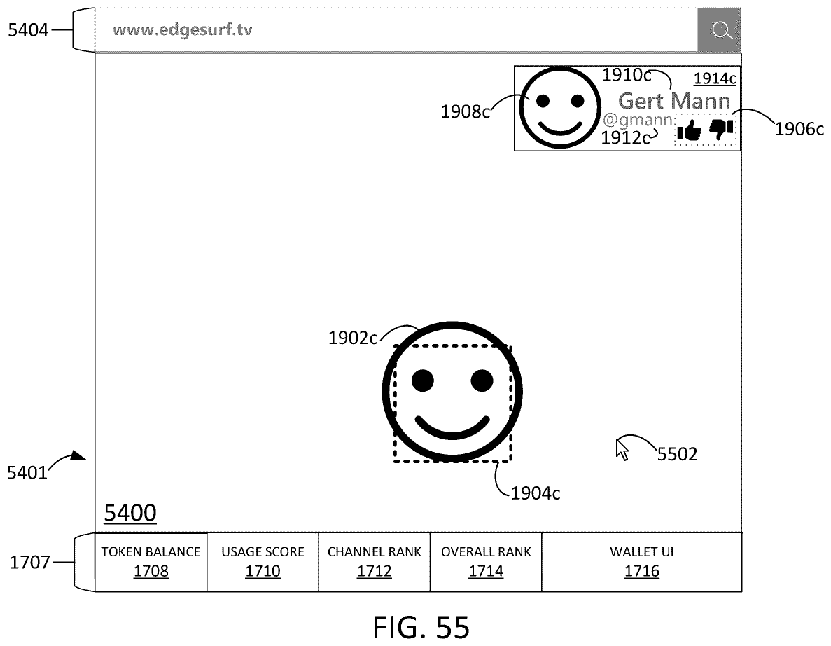

FIG. 55 shows main program 5400 advanced to showing only Gert Mann 1902c with accompanying graphic ID 1914c. For example, the main program 5400 of FIG. 54 may be a previous scene or camera that switches, in a few seconds or fewer, to showing Gert Mann 1902c. Media guide 5401 is thus capable of providing, in real time, interactive icons and information related to currently displayed media personalities and soon-to-be-displayed media personalities.

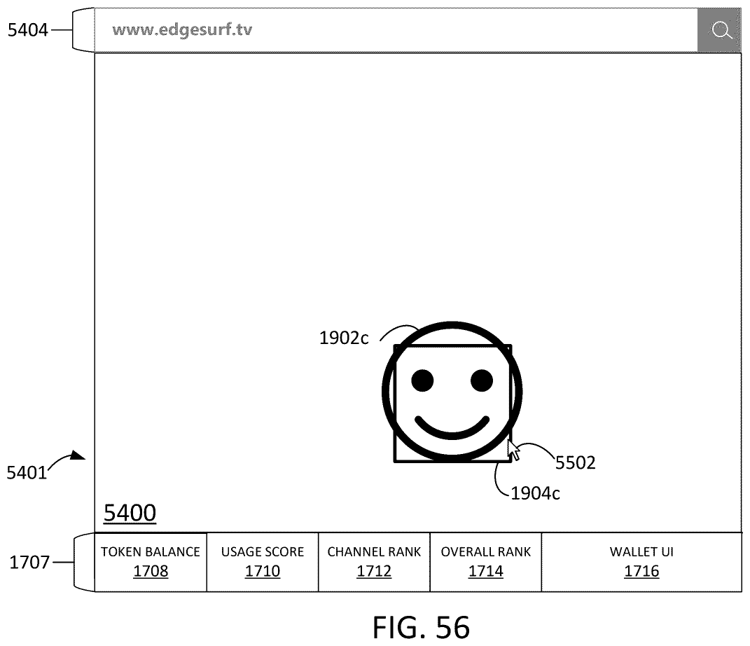

Media Guide 5401 may interact with cursor 5502. For example, frame 1904c may be clickable by bringing cursor 5502 close to or within frame 1904c, as shown by FIG. 56 with frame 1904c graphically changing from a dashed lined to a solid line. In some embodiments, a frame may change colors or other graphic change to indicate to a user-viewer that said frame is interactable with mouse clicks or similar inputs. If cursor 5502 is outside this interactive area of frame 1904c, as show in FIG. 55, a mouse click will not trigger an interaction with frame 1904c.

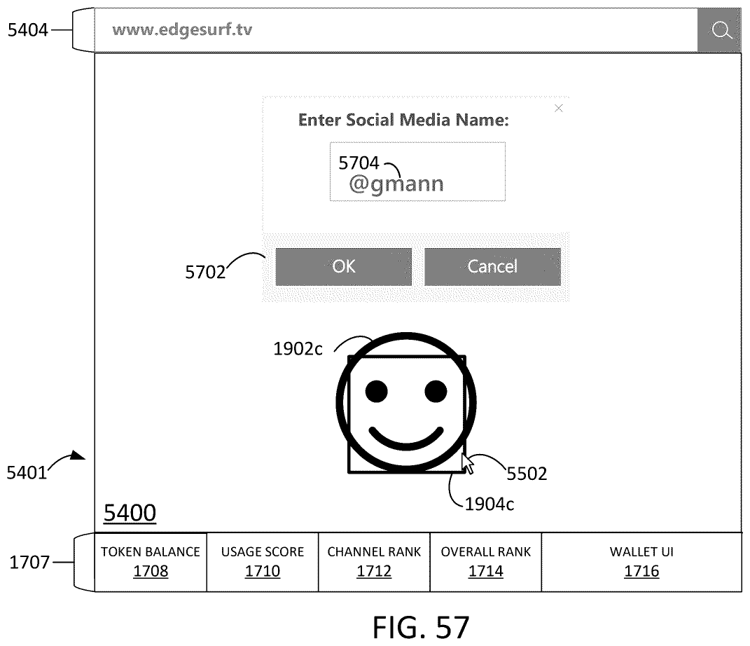

As shown in FIG. 57, one interactive response is providing text entry box 5702 (e.g., a pop-up window). Box 5702 accepts a real name and/or a social media handle or username 5704 text for mapping a social media profile to facial detections (or confirmation of previous manual and/or algorithmic mappings).

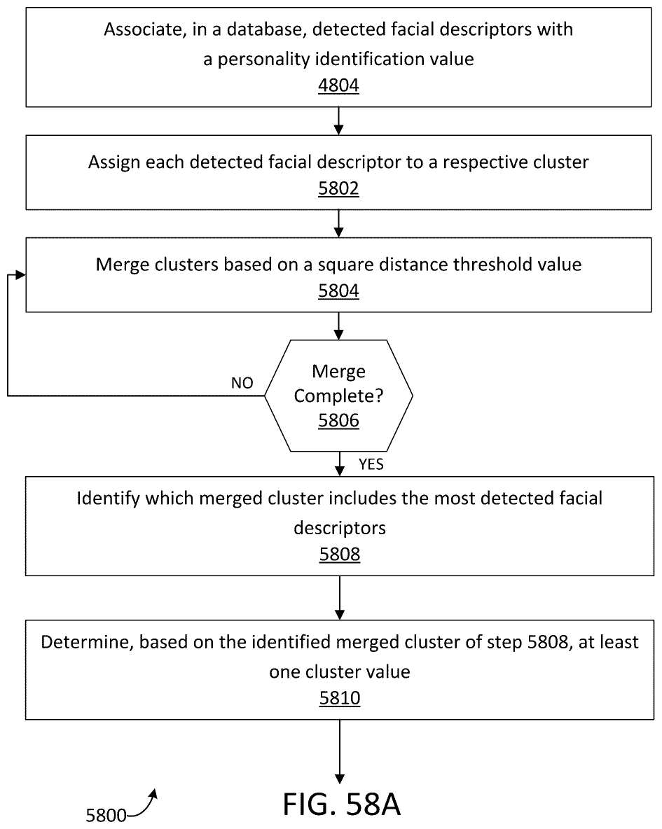

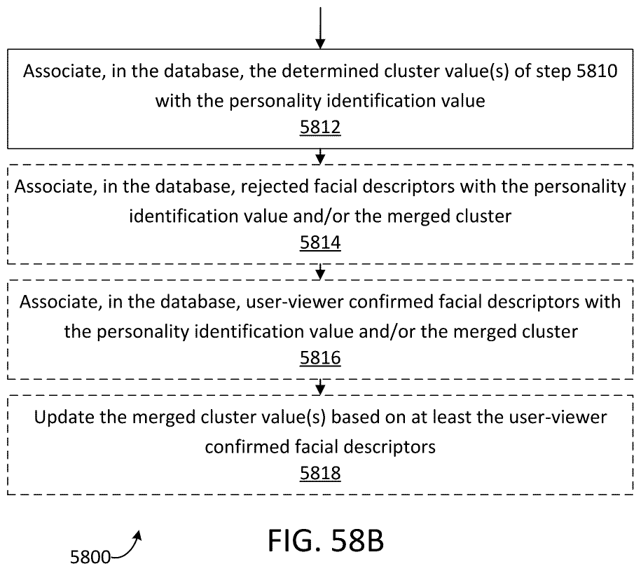

FIGS. 58A and 58B show a method 5800 for determining facial descriptor cluster values. After step 4804, step 5802 includes assigning each detected facial descriptor to a respective cluster. Step 5804 includes merging the clusters based on a square (Euclidean) distance threshold value. For example, clusters with a distance value that is equal and/or under a square distance of 0.44 are merged. Step 5806 determines if the merge is complete (e.g., all “mergeable” clusters have been merged). If so, step 5808 includes identifying which of the merged clusters includes the most facial descriptors. In some embodiments, step 5808 establishes the cluster and data derived therefrom for a personality identification value.

Step 5810 includes determining based on the identified cluster of step 5808, at least one cluster value. Example cluster values may include an average of all facial descriptors (e.g., a cluster center), a facial descriptor closest to the average, a facial descriptor farthest from the average, and a distance of the farthest facial descriptor from the average (e.g., a cluster radius). Cluster values may be facial descriptors, distance values derived from facial descriptors, and/or average values derived from clustered facial descriptors.

Step 5812 includes associating, in the database, the determined cluster values with the personality identification value. The cluster values of step 5812 may server as a basis for determining facial identification and/or occurrences in a video stream. Optional step 5814 may include associating, in the database, rejected facial descriptors with the personality identification value. In some embodiments, a user-viewer provides feedback on a false identification of a personality. The facial descriptors that trigger the false identification may be utilized in further detection and/or occurrence processes (e.g., in method 5900). Optional step 5816 may include associating, in the database, user-viewer confirmed facial descriptors with at least one of the personality identification value and the merged cluster. For example, the user-viewer confirmed facial descriptors may be added to a dataset that is tied to a personality identification value. Optional step 5818 may include updating the merged cluster value(s) based on at least the user-viewer confirmed facial descriptors. For example, step 5818 may include re-calculating or otherwise updating a cluster center or average, a facial descriptor closest to the average, a facial descriptor farthest from the average, and/or a cluster radius at least partly based on the user-viewer confirmed facial descriptors for a particular personality.

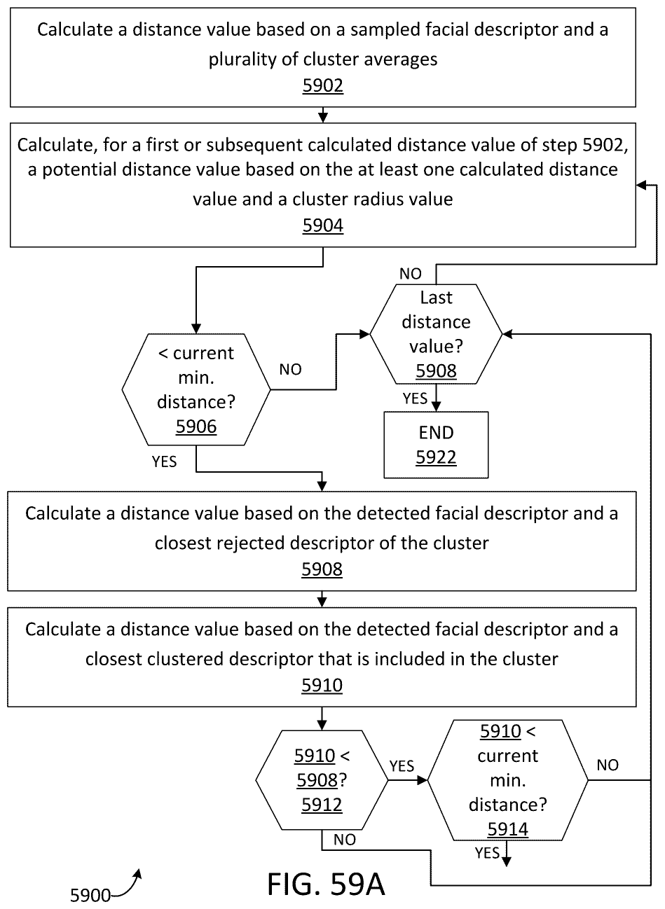

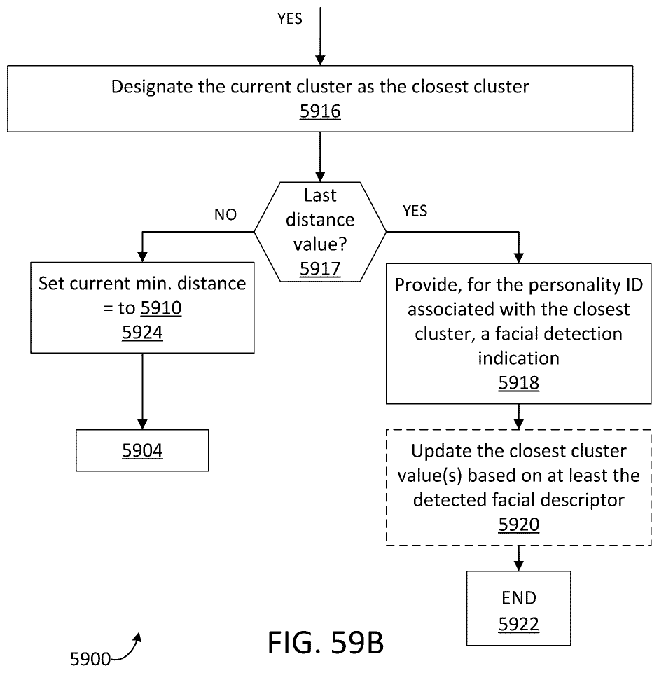

FIGS. 59A and 59B show method 5900 for facial recognition. Step 5902 includes calculating a distance value based on a sampled facial descriptor and a plurality of cluster averages. In some embodiments, each cluster average may be representative of an individual. Step 5904 includes calculating a potential distance value based on at least the calculated distance value and a cluster radius value. In some embodiments, the cluster radius value is subtracted from the calculated distance value. Step 5906 determines if the potential distance value is below a current minimum distance, which may be initially set to a large value. If below, step 5908 includes calculating a distance value based on the detected facial descriptor and a closest rejected descriptor of the cluster. Step 5910 includes calculating a distance value based on the detected facial descriptor and a closest clustered descriptor, with respect to the detected facial descriptor, of the cluster. Step 5912 determines if the determined distance value of 5910 is less than the determined distance value of 5908. If not, method 5900 may return to step 5908.

If so, step 5914 determines if the determined distance value is less than the current minimum distance. If not, method 5900 may return to step 5908. If so, method 5900 may progress to step 5916, which designates the current cluster as the closest cluster. If there are further distance values to calculate or otherwise process at step 5917, step 5924 may set the current minimum distance equal to the distance value that was calculated by step 5910 and method 5900 may return to step 5904.

If not, method 5900 may progress to step 5918, which includes providing, for the personality ID associated with the closest cluster, a facial detection indication. Said indication may include adding a personality ID to a recent detection list of a video program/stream. Said indication my include updating a daily counter, which accumulates the number of discrete detections over a given time period. Said indication may include providing a notice to a user-viewer of detecting a face, in a video stream, that is associated with a personality ID.

Optional step 5920 includes updating at least one closest cluster value based on at least the detected facial descriptor. In some embodiments, step 5920 may include re-calculating or otherwise updating a cluster center or average, a facial descriptor closest to the average, a facial descriptor farthest from the average, and/or a cluster radius. In some embodiments, step 5920 may include adding the detected facial descriptor to the dataset of a particular cluster (e.g., a clustered dataset). Additionally or alternatively, cluster values are updated based on user-viewer confirmations (e.g., step 5818). Method 5900 may then end at step 5922.

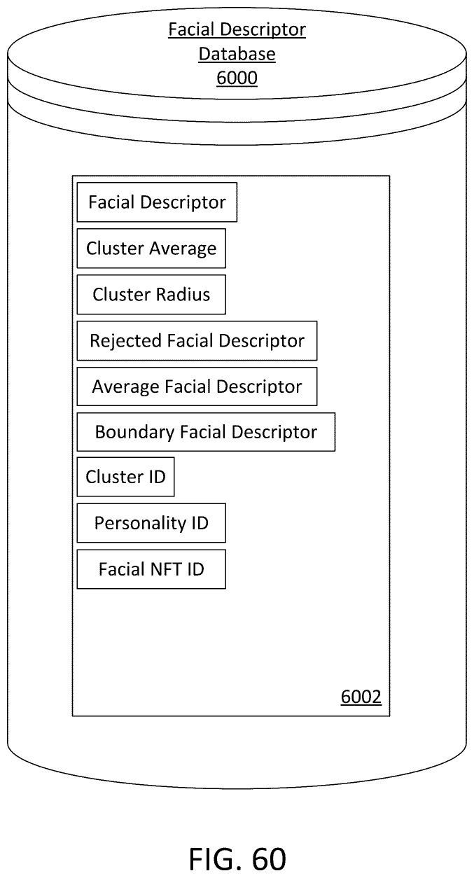

FIG. 60 shows facial descriptor database 6000, which may have data structures 6002 (e.g., database field formats) or otherwise process and/or store data related to facial descriptors and rejected facial descriptors. Facial descriptor data may include one or more of identified facial descriptors from a video stream. Facial descriptors may be pre-populated and/or updated with, for example, further sampled facial descriptors from subsequent video streams, with or without user-viewer input or feedback. Rejected facial descriptors may be expanded or otherwise updated via user feedback concerning one or more facial descriptors that triggered a false identification of a personality.

Data structures 6002 may further include a cluster average (and/or cluster center), a cluster radius, an average facial descriptor (e.g., a facial descriptor closest to the cluster center), a boundary facial descriptor (e.g., a facial descriptor furthest away from the cluster center), a cluster ID, a personality ID, and/or a facial NFT ID.

It has been discovered that the present invention thus has numerous aspects. The present invention valuably supports and services the historical trend of reducing costs, simplifying systems, and increasing performance. These and other valuable aspects of the present invention consequently further the state of the technology to at least the next level.

Thus, it has been discovered that the multimedia content management and packaging system of the present invention furnishes important and heretofore unknown and unavailable solutions, capabilities, and functional aspects for processing image content. The resulting processes and configurations are straightforward, cost-effective, uncomplicated, highly versatile and effective, can be surprisingly and unobviously implemented by adapting known technologies, and are thus readily suited for efficiently and economically manufacturing devices fully compatible with conventional manufacturing processes and technologies. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the above description. Accordingly, it is intended to embrace all such alternatives, modifications, and variations that fall within the scope of the included claims. All matters set forth herein or shown in the accompanying drawings are to be interpreted in an illustrative and non-limiting sense. For example, distance calculations between, for example, facial descriptor vector values may be Euclidian distances, Manhattan distances, Average Distances (e.g., a modified Euclidean distance calculation), weighted Euclidian distances, Chord distances, and/or non-Euclidian distances, among other examples.

As another example, embodiments may include Video-on-demand streams provided by a commercial server to a user device (e.g., computer, smart phone, streaming device, gaming counsel) that is running a watch-to-earn application (e.g., a media player application) that is operably coupled to a digital wallet. Embodiment streams include audio streams, video streams, and interactive streams (e.g., video game streaming or “cloud gaming”), among other media streaming examples.

As another example, embodiments may implement one or more modules (e.g., watch-to-earn module 1408) as a browser plug-in, a standalone application, an embedded module in a video player, or an embedded module in a web page containing a video player, among other possible software architectures. In some embodiments, said one or more modules may be communicatively coupled to a server.

1. A method of operation of a multimedia content management and packaging system comprising:
detecting, by video content analysis, content objects of at least one video program, thereby identifying detected content objects;
displaying the at least one video program;
detecting, from an external media feed, media references to at least a sub-plurality of the detected content objects;
calculating, while the at least one video program is being displayed, a usage score for the at least sub-plurality of detected content objects based on at least the media references, the calculating step comprising utilizing a time decay factor for at least partially determining the usage score, thereby providing a calculated usage score; and
displaying, while the at least one video program is being displayed, a usage score graphic according to the calculated usage score.

2. The method of claim 1 wherein the external media feed includes a social media feed for detecting the media references on a social media site.

3. The method of claim 1 wherein the external media feed includes a usage feed for detecting the media references.

4. The method of claim 1 wherein the external media feed includes an external media feed for detecting the media references on a broadcast or digital media system.

5. The method of claim 1 with the calculating the usage score step comprising updating the usage score based on a quality score.

6. The method of claim 1 with the calculating the usage score step comprising modifying the usage score according to a competitiveness score.

7. The method of claim 1 with the detected content objects step comprising, detecting, by facial recognition, content objects in the at least one video program, thereby identifying human individuals as the identified detected content objects.

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. A method for displaying a plurality of programs, the method comprising:
receiving, by a node, a plurality of video programs;
transmitting, by the node and during the receiving step, the plurality of video programs on an application-layer defined overlay network;
displaying, by the node and during the receiving and transmitting steps, at least two distinct programs from the plurality of video programs, the displaying step comprising displaying a first video program;
detecting, by video content analysis, a content object in at least a second video program, thereby identifying a detected content object; and
the displaying step further comprises displaying, based on the detected content object, the second video program overlayed on or next to the first video program.

30. The method of claim 29 the detection step comprising detecting content objects in at least the second video program, thereby identifying detected content objects, and the displaying step comprising displaying, based on the detected content objects, the second video program overlayed on or next to the first video program.

31. The method of claim 29 further comprising receiving, by the node, node-specific subjective feedback for the detected content object of the first video program, the displaying step comprising displaying, based on the node-specific subjective feedback, the second video program overlayed on or next to the first video program.

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. A method for providing at least near real-time notifications for a plurality of digital programs, the method comprising:
receiving, by a server, the plurality of digital programs;
transmitting, by the server and during the receiving step, the plurality of digital programs to at least one node of an overlay application network;
detecting, by the server and during the receiving and transmitting steps, a content object in at least one digital program of the plurality of digital programs, thereby identifying a detected content object; and
least partially in response to identifying the detected content object, transmitting, by the server and via the overlay application network, a content object detection notification to the at least one node.

63. The method of claim 62 further comprising providing, by the at least one node and in response to receiving the content object detection notification, a content object detection notification to a user of the at least one node.

64. The method of claim 62 with the plurality of digital programs comprising a plurality of video programs.

65. The method of claim 62 with the detecting the content object step comprising, detecting, by facial recognition, content objects in at least one video program, thereby identifying human individuals as the identified detected content objects.

66. The method of claim 62 with the detection step comprising determining, by the server, a minimum Euclidean distance between a content object descriptor and a closest content object descriptor of a plurality of content object descriptors.

67. The method of claim 62 further comprising determining, by the server, a content object occurrence, the content object occurrence step comprising determining if the detected content object detection has been previously detected, the transmitting the content object detection notification step comprising transmitting, by the server and in response to a determined content object occurrence, a content object occurrence notification to the at least one node.

68. The method of claim 67 further comprising including, by the server and in a content object detection list, a content object ID in response to the detecting the content object step and the determining the content object occurrence step comprises determining if the content object ID is included at least twice in the content object detection list.

69. The method of claim 68 with the including step comprising including in the content object detection list with a predetermined maximum list size, the content object ID in response to the detecting the content object step.

70. The method of claim 68 with the including step comprising continuously including, in real or near-real time, the content object ID in the content object detection list in response to further detections of the content object in the at least one digital program.

71. The method of claim 63 with the providing step comprising providing, by the at least one node and in response to receiving the content object detection notification, the content object detection notification before the detected content object is presented, by the at least one node, in the at least one digital program.

72. (canceled)

73. (canceled)

74. (canceled)

75. (canceled)

76. (canceled)

77. (canceled)

78. (canceled)
